(19) United States
(12) Patent Application Publication
(10) Pub. No.: US 2009/0006184 A1
(43) Pub. Date: Jan. 1, 2009

(54) SYSTEMS AND METHODS FOR DEMAND AGGREGATION FOR PROPOSED FUTURE ITEMS

(76) Inventors: Andrew K. Leach, Hinsdale, IL (US); Richard M. Harmon, Lake Forest, IL (US); Charles H. Cella, Pembroke, MA (US)

Correspondence Address: STRATEGIC PATENTS P.C.., C/O PORTFOLIOIP, P.O. BOX 52050, MINNEAPOLIS, MN, 55402, US

(21) Appl. No.: 12/134,033

(22) Filed: Jun. 5, 2008

Related U.S. Application Data
(63) Continuation-in-part of application No. 11/849,905, filed on Sep. 4, 2007.
Application No. 11/849,905 is a continuation-in-part of application No. 11/849,910, filed on Sep. 4, 2007.
Application No. 11/849,910 is a continuation-in-part of application No. 11/849,903, filed on Sep. 4, 2007.
Application No. 11/849,903 is a continuation-in-part of application No. 11/849,897, filed on Sep. 4, 2007.
Application No. 11/849,897 is a continuation-in-part of application No. 11/380,186, filed on Apr. 25, 2006.
Application No. 11/380,186 is a continuation-in-part of application No. 11/609,653, filed on Dec. 12, 2006.
Application No. 11/609,653 is a continuation-in-part of application No. 11/380,187, filed on Apr. 25, 2006.

(51) Int. Cl. G06Q 30/00; G06Q 10/00

(52) U.S. Cl. 705/10

(57) ABSTRACT

Embodiments predict, measure, and/or guarantee demand for a contingent or hypothetical future item and, based upon that demand, determining whether or not to actually produce or select the future item. In particular, embodiments measure such demand via forward rights, votes, contingent event certificates, and associated marketplaces.

### CROSS-REFERENCE TO RELATED APPLICATIONS

This application is a continuation-in-part of the following U.S. patent applications, each of which is incorporated by reference in its entirety:

U.S. patent application Ser. No. 11/849,905 filed Sep. 4, 2007; U.S. patent application Ser. No. 11/849,910 filed Sep. 4, 2007; U.S. patent application Ser. No. 11/849,903 filed Sep. 4, 2007; U.S. patent application Ser. No. 11/849,897 filed Sep. 4, 2007; U.S. patent application Ser. No. 11/380,186 filed Apr. 25, 2006; U.S. patent application Ser. No. 11/609,653 filed Dec. 12, 2006; and U.S. patent application Ser. No. 11/380,187 filed Apr. 25, 2006.

This application is also related to the following U.S. patent applications each of which is incorporated by reference herein in its entirety:

U.S. patent application Ser. No. 10/179,634 (Electronic System and Method for Trading Seat Licenses, Event Tickets and Contingent Event Certificates), filed on Jun. 25, 2002 by Richard Harmon et al.;

U.S. patent application Ser. No. 10/386,741 (System and Method for Executing a Payment Transaction over a Computer Network), which is a continuation-in-part of application Ser. No. 10/179,634, filed on Mar. 12, 2003 by Harmon et al; and

U.S. patent application Ser. No. 09/586,723 (Contingency-based Options and Futures for Event Tickets and Related Goods and Services), filed on Jun. 5, 2000 by Cella et al.

### BACKGROUND

1. Field

This disclosure relates to market assessment for future item planning/creation and to generation and aggregation of demand for future items.

2. Background

Oftentimes a future item, such as a consumer product, a service, a book, a video, a concert, a live event, user-generated content, a collectable, a wine from a region, a vintage of wine, a wine from a winemaker, or the like, is scheduled or developed and the future items go on sale (such as at a sporting event, a book release, a world premiere of content, and the like). In some cases, demand for the future item is underestimated and the items sell out quickly on the primary market for items, in which case items may skyrocket in price on the secondary market for items, as demand outstrips supply. In such cases parties other than future item producers or product manufacturers may reap most of the rewards for high demand, such as by scalping items or engaging in similar practices. In other cases, demand for consumer products or live events is overestimated and item sales languish on the primary market, leading to low product sales for the items, or in the case of live events, low turnout for the event and, in some cases, financial losses for consumer products manufacturers and event producers.

A need exists for improved methods and systems for consumer products manufacturers, consumer services companies or providers, and event producers, to create new product and service offerings that take into account demand for those products, services, and events, prior to actual development and funding of these new offers to the public.

### SUMMARY

Disclosed herein are methods and systems for exchanging rights that are associated with future items, including future items that are determined and future items that are defined in terms of a future circumstance. The methods and systems provide for futures and options pricing, purchasing, and selling. The methods and systems provide for pricing, purchasing, and selling certificates, tickets, and other rights or evidence of rights to acquire services, goods, rights, and the like, any and all of which may be associated with a future item that is determined or that is defined in terms of a future circumstance. In some embodiments disclosed herein, such futures and options may be referred to as contingent access rights, which in turn may be evidenced by or embodied in a contingent event certificate. In certain preferred embodiments, a future item may be a product, while in other embodiments the future item may be a service. In other preferred embodiments a future item may be or may not be associated with an event, such as a live event, a product- or service-related event, a broadcast event, a webcast event, a holographic event, or the like. References to future items herein should be understood to include all types of goods, services, and events, except where context specifically limits to a specific type of future item.

Also provided herein are methods and systems for demand aggregation, including for future items, including items for which manufacture or delivery is contingent upon threshold demand. Such methods and systems may allow aggregation of demand based on demonstrated interest in a proposed future item, such as, without limitation, a new consumer product launch, a proposed new consumer service, or proposed new live events. Interest may be reflected in commitments in the form of forward rights, which may carry future obligations to purchase. Such rights or obligations may be contingent on a contingency, such as the aggregation of sufficient total demand or the occurrence of some other contingency, which may be any type of contingency described herein or in the documents incorporated herein by reference. In some embodiments, upon aggregation of sufficient demand, a future item such as a consumer product, a consumer service, or a live event may be produced or scheduled that satisfies the demand of a group of users, or even a single user.

In some embodiments, demand may be aggregated at least in part based on attributes of contingent event rights, wherein the demand is assessed, and possibly fulfilled, based on attributes of demand that are assessed based on a market for contingent event rights or other related rights. A contingent event right should be understood to encompass at least one of a right and a commitment (and in some embodiments, both) related to a future item, where the right or obligation is subject to a contingency. Many embodiments of contingent event certificates are disclosed herein and in the documents incorporated by reference herein. Embodiments include a wide range of future items (such as releases of products, creation of artistic works, sporting events, travel events, concerts, performances, publications of works, provision of services, authorship events and the like). Future items may encompass a wide range of results, occurrences, or outcomes. Embodiments also include a wide range of rights (such as rights to attend an event or performance, rights to attend coupled with commitments, rights to purchase tickets, options to purchase tickets, rights to purchase a work, rights to performance of a contractual obligation, rights to view or otherwise observe an event, rights to ownership, rights to profit, rights to discounts off of list price, rights to distribution, first rights to purchase, rights to market, rights to purchase, and the like). In some embodiments, rights may be evidenced by a certificate or other evidence of right, resulting in a contingent event certificate. Embodiments of contingent event rights also include a wide range of contingencies (such as the presence of a team or player in an event, the existence of an event, the publication of a work, the production of a performance, the provision of a service, the release of a product, the completion of an obligation, the occurrence of a random event, a weather-related contingency, acceptance levels with a social network, pre-sold commitment levels, pre-published forward sales, and many others). Contingencies may include a wide range of conditions or occurrences not yet established. More embodiments are disclosed below.

In some embodiments, a contingent event right may relate to an event such as a sporting event, where the contingency is, for example, the presence of a team in a particular game, such as the presence of the Bears in the NFC Championship game in professional football. In some embodiments, a contingent event right may relate to a plurality of spatiotemporally related events such as a sporting event and a concert event that are scheduled to occur sequentially or simultaneously at a venue, where the contingency is, for example, the presence of a team in a game and/or a performer in a concert where the game and the concert are spatiotemporally related, such as the presence of the Blackhawks in an National Hockey League Playoff game at the United Center in Chicago and/or the presence of The Black Keys in a concert at the United Center immediately following a Playoff game. In other embodiments, a contingency may be related to aggregation of demand, such as tapping a market for user-driven content creation. For example, the future item may be the publishing of a book, funding of a business plan, production of a television show, series, or miniseries, creation of a film, creation of music, creation of artworks, production of a video game, creation of a consumer product, creation of an electronic device, creation of a toy, provision of a service, or the like, where the future items are the outcomes of a process initially involving assessment of demand for the event, augmented by a marketplace for contingent rights. In such embodiments, methods and systems are provided that secure rights and obligations to things which may or may not be created, where the securing of rights and obligations affects the process of creation, such as by establishing a forward market demanding the creation or delivery of an item.

A facility for measuring and tracking the demand for future items, and for generating demand for future items, may be provided separately from, associated with, or provided within an exchange, such as an exchange for contingent event certificates or rights. References to contingent event certificates should be understood to include situations in which either a right, an obligation, or both is tracked by or associated with a certificate. The facility may provide for monitoring of demand by individual customers, members of a social network, such as an online social network, event performers, event providers, producers, consumer products companies, manufacturers, or the like. In some embodiments, such a user interface may be provided that relates to contingent event rights. In some embodiments, the user interface may be integrated with a user interface for a social network. In some embodiments, the user interface may include facilities for sporting events, future items, contingencies, and/or rights, such as by demand, type of event, type of contingency, age rating of video game, type of toy, type of product, type of consumer service, genre (music concerts, lectures, meet the celebrity, or the like), performers, locations (New York City, Boston, London, or the like), date, venue, and other like variables to be sorted. For example, the most in-demand toys may be displayed in a tag cloud where the toys in the greatest demand may be displayed in a larger font than those toys in lower demand. Demand may be a function of contingent event rights sold to users, the demand evidenced by a willingness to purchase contingent event rights. In some embodiments, a contingency may be the occurrence of an event having certain attributes. Security measures may also be taken to ensure the validity of each contingent event certificate, such as supplying digital tags to each contingent event certificate. In some embodiments, demand may only be measured for a defined amount of time so that a secondary market may be formed to trade forward rights and/or forward obligations to future items.

It will be appreciated that a future item may encompass, mean, and/or be associated with any and all of a product, service, offering, event, provision, content, occurrence, happening, proceeding, incident, affair, circumstance, occasion, phenomenon, function, gathering, launch, issuance, announcement, declaration, report, revelation, divulgence, disclosure, publication, broadcast, circulation, communication, dissemination, creation, production, generation, making, fabrication, construction, origination, development, formation, and the like.

Throughout this disclosure the term “event” may mean “event or future item,” as described previously and elsewhere. Moreover, events should be understood to encompass, as context permits, the union of all of the types of future items described or referenced herein and elsewhere. In some embodiments, without limitation, an event may be associated with a consumer product, a consumer service, a live event, and the like, such as creating a new TV show, movie, gaming system, or travel planning service.

In some embodiments, demand aggregation may include presenting an offer relating to at least one of a forward right and a forward obligation with respect to a future item; assessing a response to the offer; and determining whether the future item will be produced based on the assessed response. Some embodiments may further comprise, if the future item is to be produced, issuing a contingent event certificate to an offeree who has accepted the offer.

In some embodiments, the response to the offer may include purchasing a contingent event certificate; obtaining a contingent event certificate at no cost; earning points that may be exchanged for a contingent event certificate (wherein earning points may include one or more of obtaining a credit or charge card with a retailer, making purchases from a retailer, making purchases directly related to a future item, or serving on a consumer opinion panel); or an acceptance of the future item offer, wherein the acceptance imposes an obligation on the offeree with respect to the future item or provides the offeree with a forward right with respect to the future item.

In some embodiments, the contingent event certificate may or may not obligate the purchaser to purchase the future item if the future item is to be produced. In some embodiments, the capacity of an offeree to satisfy an obligation related to the future right may be assessed.

In some embodiments, the offeror may be obligated to provide the future item if response to the offer satisfies a threshold condition, wherein the offeror is not a producer or owner of the future item. In some embodiments, the offeror may have discretion as to whether to produce the future item, regardless of the response to the offer.

In some embodiments, the future item may be a consumer product, wherein the consumer product is at least one of an electronic device, a toy, a gaming system, a tool, an item of camping equipment, a household good, a grocery item, a clothing item, or a furniture item.

In some embodiments, the future item may be a consumer service, wherein the service is at least one of a social networking service, a job search service, a travel planning service, an accommodations service, a remote executive assistant service, a security service, a help desk service, or an insurance product.

In some embodiments, the future item may be the publication of a work, wherein the work is a copyrighted work, such as a book.

In some embodiments, the future item is at least one or more of a music concert, a presentation by a particular person, an opening of a hotel, a sporting event, content, an accommodation, an event, a sporting event, a music event, a theater event, a performance, a music release, a movie release, or user-generated new content of any kind delivered in any medium.

In some embodiments, the offeror may be at least one of a manufacturer, a distributor, a retailer, a producer, or a service provider, wherein the producer is a consumer of the future item.

In some embodiments, an offeree that accepts the offer may be entitled to receive a benefit with respect to the future item if the response exceeds a threshold condition, wherein the benefit is at least one of preferred access to the future item, first access to the future item, advance access to the future item, a right to purchase the future item, a right to purchase the future item at a discount, access to a secondary market for rights to the future item, a share of revenues attributable to the future item, a share of profits attributable to the future item, a right to receive an access right related to the future item (for example and without limitation a right to receive digital media), service such as an accommodations service, digital item, or physical good associated with a future item.

In some embodiments, offering is done at least in part via the Internet, e-mail, a marketplace, text message, a telephone call, an offline social network, online social network, or a user interface. The user interface may be organized according to an affinity of a user for a topic of interest related to the future item, such as a topic of interest related to an individual.

In some embodiments, the response relates to a preview of the future item, or may be a consensus of reviews of the future item exceeding a threshold value. In some embodiments, the offeree receives a right of preferred access to the future item. In some embodiments, the offeree receives an additional benefit, wherein the additional benefit is a right to access to a subsequent item or includes a right to receive a share of profits attributable to the future item.

In some embodiments, assessing may be done at least in part via the Internet, via a computer software program, or within a social network.

In some embodiments, determining may be done at least in part using an Internet website, a computer software program, or includes determining whether the assessed response exceeds a predefined threshold.

In some embodiments, the contingent event certificate may be priced according to a pricing method, wherein the pricing method is based on at least one of the marketplace, a Dutch auction, a power ranking, a fixed price, a variable price, or a historical price.

Methods and systems for future item planning may include offering a forward right on a contingent event rights exchange, assessing the demand for a future item based on the market for forward rights associated with the future item, and producing the future item based on the assessed demand.

In some embodiments, offering the future item includes offering a contingent event certificate, which may further comprise associating a contingency with the contingent event certificate.

In some embodiments, the future item may be a sporting event, wherein the sporting event may be at least one of a match between two teams, a match between two players, or a rematch. In the embodiments, the future item may be a performance, wherein the performance takes place at a designated time or place, is broadcast over the Internet or a cable television network, is spatiotemporally related to a specified place and time, is a musical performance, or is a theatrical performance. In some embodiments, the future item is publication of a copyrightable work. In some embodiments, the future item may be a consumer product. In some embodiments, the future item may be a service offering.

Methods and systems for determined rights may include offering a forward right for a future item, and obligating holders of the forward right to purchase the future item upon its availability. In some embodiments, the future item may be at least one of a consumer product, a consumer service, content, an accommodation, an event, a sporting event, a music event, a theater event, a performance, a music release, a movie release, or a publication. In some embodiments, the offeror may be at least one of a manufacturer, distributor, retailer, producer, or service provider. In some embodiments, the response to the offer comprises purchasing a contingent event certificate.

Some embodiments may be directed at overcoming the deficiencies of current advertising and compensation systems by providing user-driven advertising in association with future item creation. A user of a social networking site may transmit an advertisement or announcement to members of his social network. The advertisement or announcement may be selected by the user and associated with an endorsement by the user, who may have first-hand experience using the product or service being promoted. The user may receive a referral fee when a direct sale results from providing the advertisement or announcement and the endorsement to a member of his social network. Moreover, interest in a future item (e.g., a product, a service, an event, an item of content) may be gauged by recording forward rights, obligations, impressions, or some other measure associated with a user's viewing of the advertisement or announcement, acting in response to the advertisement or announcement, and the like. When such a measure exceeds a threshold, the future item may be created, commissioned, scheduled, or the like.

Provided herein may be methods and systems for user-driven advertising and future item creation. In some embodiments may involve methods and systems for offering a future item proposition, associating at least one advertisement module with the future item proposition, and receiving at least one impression related to the future item proposition and associated advertisement module.

In some embodiments, the counting of an impression occurs each time the contingent client proposition may be transmitted, viewed, forwarded, delivered, printed, or saved.

In some embodiments, the advertisement module may be selected from a pool of advertisement modules.

In some embodiments, listing an advertising module in the pool of advertisement modules may require a fee.

In some embodiments, the method may further comprise a user endorsement associated with the advertisement module.

In some embodiments, the method may further comprise creating the future item upon reaching a threshold number of impressions.

In some embodiments, the method may further comprise obtaining at least one of a forward right and a forward obligation for the future item. In a version of this variation, the method may further comprise creating the future item upon reaching a threshold number of forward rights. In some embodiments, the method may further comprise creating the future item upon reaching a combined threshold number of forward rights and impressions. The value of a forward right may be greater than an impression in calculating threshold numbers.

In some embodiments, the method may further comprise generating revenue based on the number of click-throughs.

In some embodiments, the method may further comprise generating revenue from a referral fee associated with the advertising module.

In some embodiments, the method may further comprise conducting a financial transaction in association with receiving the impression, wherein the financial transaction is associated with a referral fee.

Some embodiments further comprise conducting a financial transaction that is a function of the number of impressions that are received.

In one aspect, a method for issuing contingent event certificates that is disclosed herein includes receiving a proposal for a future item; receiving a plurality of indicia of demand for the future item, the plurality of indicia in response to the proposal; and issuing a plurality of contingent event certificates for the future item, wherein at least some of the plurality of contingent event certificates are issued to users who provided at least some of the plurality of indicia. The indicia of demand may be votes for the future item. The indicia of demand may be buy orders for the contingent event certificates. At least one of the contingent event certificates, when exercised, may obligate a producer to produce the future item. The future item may be an item selected from the group consisting of a consumer product, a consumer service, content, an accommodation, an event, a sporting event, a music event, a theater event, a performance, a music release, a movie release, user-generated new content, an opening of a hotel, a presentation by a particular person, and a publication. The method for issuing contingent event certificates may include providing a benefit to a user who created the proposal, the benefit provided when the indicia of demand satisfies a threshold condition. The benefit may be selected from the group consisting of preferred access to the future item, first access to the future item, advance access to the future item, access to a secondary market for rights to the future item, a right to purchase the future item, a right to purchase the future item at a discount, a share of revenues attributable to the future item, a share of profits attributable to the future item, and a right to receive an item related to the future item. Receiving may involve receiving data from a communications facility selected from the group consisting of an internetwork, a computer network port, a computer network socket, a UNIX socket, a primary storage device, a secondary storage device, shared memory, a telephone, an e-mail, a marketplace, a text message, an offline social network, an online social network, and a user interface. Issuing the plurality of contingent event certificates may involve selling the plurality of contingent event certificates. Selling may involve at least one of a marketplace, a Dutch auction, a power ranking, a fixed price, a variable price, and a historical price.

In one aspect, a computer program product that is disclosed herein includes code adapted to receive a proposal for a future item; code adapted to receive a plurality of indicia of demand for the future item; and code adapted to issue a plurality of contingent event certificates for the future item, wherein at least some of the plurality of contingent event certificates are issued to users who provided at least some of the plurality of indicia, and wherein the code is adapted to be processed by a computer. The indicia of demand may be votes for the future item. The indicia of demand may be buy orders for the contingent event certificates. At least one of the contingent event certificates, when exercised, may obligate a producer to produce the future item. The future item may be an item selected from the group consisting of a consumer product, a consumer service, content, an accommodation, an event, a sporting event, a music event, a theater event, a performance, a music release, a movie release, user-generated new content, an opening of a hotel, a presentation by a particular person, and a publication. The computer program product may include code adapted to provide a benefit to a user who created the proposal, the benefit provided when the indicia of demand satisfies a threshold condition. The benefit may be selected from the group consisting of a contingent event certificate for the future item, preferred access to the future item, first access to the future item, advance access to the future item, access to a secondary market for rights to the future item, a right to purchase the future item, a right to purchase the future item at a discount, a share of revenues attributable to the future item, a share of profits attributable to the future item, and a right to receive an item related to the future item. To receive may be to receive data from a communications facility selected from the group consisting of an internetwork, a computer network port, a computer network socket, a UNIX socket, a primary storage device, a secondary storage device, shared memory, a telephone, an e-mail, a marketplace, a text message, an offline social network, an online social network, and a user interface. The to issue the plurality of contingent event certificates may be to sell the plurality of contingent event certificates. To sell may invoke at least one of a marketplace, a Dutch auction, a power ranking, a fixed price, a variable price, and a historical price.

Those of ordinary skill in the art will understand from the following detailed description, associated drawings, and incorporated references that a variety of embodiments are possible. All such embodiments are within the scope of the present disclosure.

All documents mentioned herein are hereby incorporated in their entirety by reference.

### BRIEF DESCRIPTION OF THE FIGURES

In the accompanying drawings:

FIG. 1 depicts a logical flow diagram detailing steps in aggregating demand for a future item.

FIG. 2 depicts a demand aggregation platform.

FIG. 3 depicts a block diagram of an embodiment of a future item creation platform.

FIG. 4 depicts a logical flow diagram detailing steps in creating future items with associated advertisements.

FIG. 5 depicts an embodiment of a trading marketplace.

FIG. 5A depicts a trading marketplace for contingent event certificates.

FIG. 6 depicts a market platform for contingent event certificates or rights, along with associated participants.

FIG. 7 depicts a cartoon of a forward rights marketplace.

FIG. 8 is a flow chart of a method of trading PSLs, event tickets, and contingent event certificates.

FIG. 9 is a block diagram of a network-based exchange.

FIG. 10 is a screenshot of a home page for a demand aggregation interface.

FIG. 11 is a screenshot of a creation page for a demand aggregation interface.

FIG. 12 is a screenshot of a browsing window for a demand aggregation interface.

FIG. 13 is a screenshot of a set of search results for future items submitted for demand aggregation.

FIG. 14 is a screenshot of a future item submitted for demand aggregation.

FIG. 15 is a screenshot of a rules page for a demand aggregation interface.

FIG. 16 is a screenshot of a Frequently Asked Questions page of a demand aggregation interface.

FIG. 17 is a screenshot of a home page for a demand aggregation interface.

FIG. 18 is a screenshot of a selection page for a demand aggregation interface.

FIG. 19 is a screenshot of a purchase screen for a demand aggregation interface.

FIG. 20 is a screenshot of a bid to buy purchase confirmation screen for a demand aggregation interface.

FIG. 21 is a screenshot of a bid to buy purchase completion screen for a demand aggregation interface.

FIG. 22 depicts a flowchart of a method for issuing contingent event certificates.

### DETAILED DESCRIPTION

A contingent access right may include a right, such as an option, that is associated with a future item, where the right matures or expires depending upon a future circumstance. In some embodiments, the contingent access right may include a right only. In other embodiments, the contingent access right may include both a right and an obligation to conduct a transaction, perform an action, and so on. Thus, in the case that the option matures, the holder of the contingent access right may have both the right and obligation to do something. In other embodiments, the option may include a right but not an obligation to do something. Contingent access rights may be embodied as contingent event certificates. As may be described and/or appreciated, many embodiments of contingent event certificates are possible. All such embodiments are within the scope of the present disclosure. Some embodiments may take advantage of features and components of contingent event certificate methods and systems, an exemplary embodiment of which is disclosed in U.S. patent application Ser. No. 10/179,634, the entirety of which is incorporated by reference herein and should be understood to be encompassed in the present disclosure and where demand may be a contingent variable.

Throughout this disclosure the terms “contingent access right” and “contingent event certificate” may be used interchangeably to refer to a contingent access right and/or an embodiment thereof. Throughout this disclosure the phrase “for example” means “for example and without limitation.” Throughout this disclosure the phrase “in an example” means “in an example and without limitation.” Throughout this disclosure the phrase “in another example” means “in another example and without limitation.” Throughout this disclosure, the phrase “such as” means “such as and without limitation.” Generally, any and all examples may be provided for the purpose of illustration and not limitation.

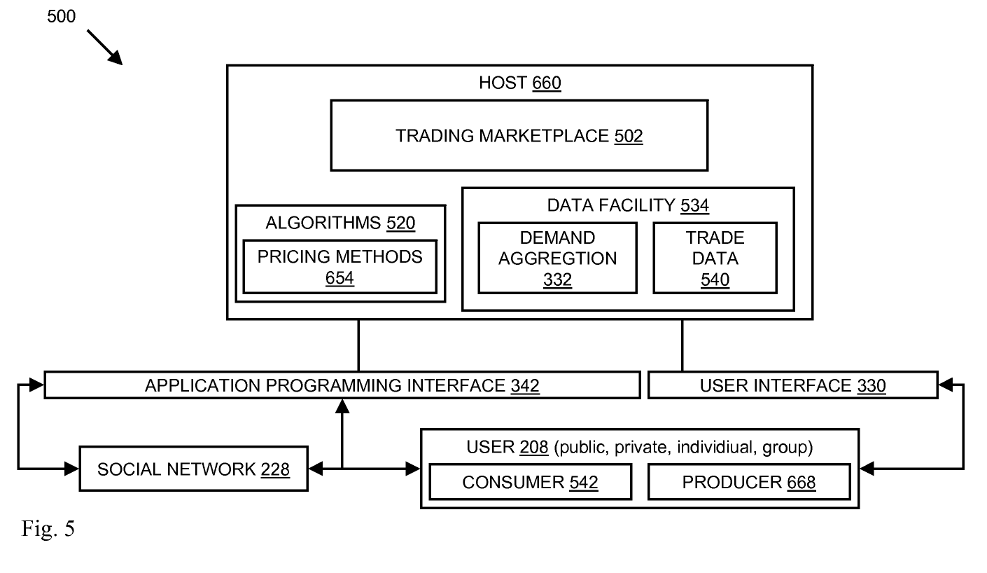

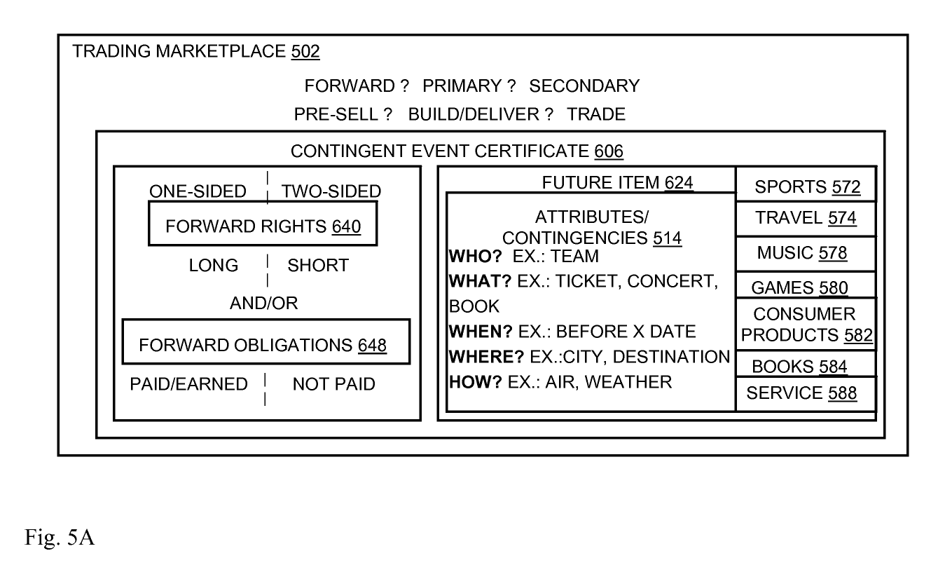

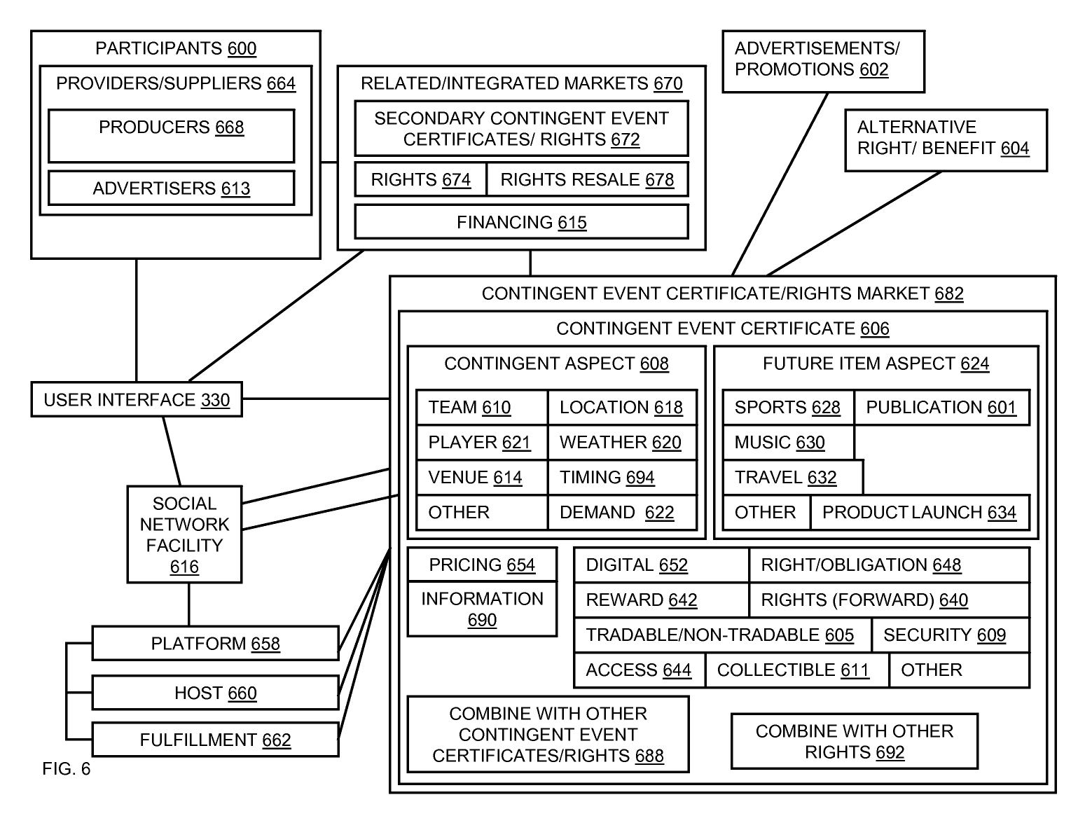

People often buy items, such as products, tickets, and the like, on a primary market and resell them on a secondary market. In some embodiments, the items may represent access rights or other rights with respect to a particular event, venue, activity, or the like. Where such rights are generally defined or determined at the time of issuance, such as without being subject to a contingency, they may be referred to herein as “defined rights” or “determined rights.” Contingent event certificates may include rights, evidence of rights, rights and obligations, or evidence of rights and obligations to acquire something. The rights may be associated with a future item, such as attending an event, buying tickets, purchasing a consumer good or service, or otherwise acquiring a benefit, wherein the rights may be contingent upon a future occurrence or determination, such as aggregation of sufficient demand for the future item, or the like (in some cases referred to herein as “forward rights”). Contingent event certificates and contingent rights are described in detail herein and in the documents appended or incorporated by reference hereto, which may be mentioned hereinafter with reference to FIGS. 5 and 6. Generally, contingent rights may be first sold in a pre-primary market and then traded or resold in a secondary market. As contingencies are resolved, contingent rights may convert, emerge, mature, vest, et cetera, into determined rights, which may be first sold on a primary market and then traded or resold in a secondary market.

Some embodiments may be associated with a rights marketplace, which may include one or more of a pre-primary market, a primary market, and a secondary market.

Some embodiments may facilitate allocating an access right to a potential or contingent product, service, or live event based at least in part on a credit amount obtained through consumer activities associated with a producer, service provider, or performer of the potential or contingent live event.

Elements, components, applications, features, systems, methods, aspects, et cetera, of embodiments may be described in detail herein and in documents incorporated by reference herein. These documents may include U.S. Patent Application Ser. No. 60/674,733, Methods and Apparatus to Predict Demand for a Product Service (Harmon 1); U.S. patent application Ser. No. 09/586,723, Contingency-based Options and Futures for Event Tickets and Related Goods and Services (Cella); U.S. Patent Application Ser. No. 60/674,866, Methods and Apparatus for Marketing Contingent Event Certificates (Harmon 2); U.S. Patent Application Ser. No. 60/749,933, Method and Apparatus for MP3/Live Event Integration (Harmon 3); U.S. patent application Ser. No. 10/179,634, Electronic System and Method for Trading Seat Licenses, Event Tickets and Contingent Event Certificates (Harmon 4); U.S. patent application Ser. No. 10/386,746, System and Method of Funding a Charity (Harmon 5); and U.S. patent application Ser. No. 10/386,741, System and Method for Executing a Payment Transaction Over a Computer Network (Harmon 6). The entire disclosure of each of the foregoing documents is hereby incorporated by reference. Excerpts from any and all of these documents may be provided below. These excerpts are provided for the purpose of illustration and not limitation. It will be appreciated that the aforementioned documents may provide support for any and all of the elements depicted in the figures and elsewhere, regardless of whether such support is explicit in the excerpts.

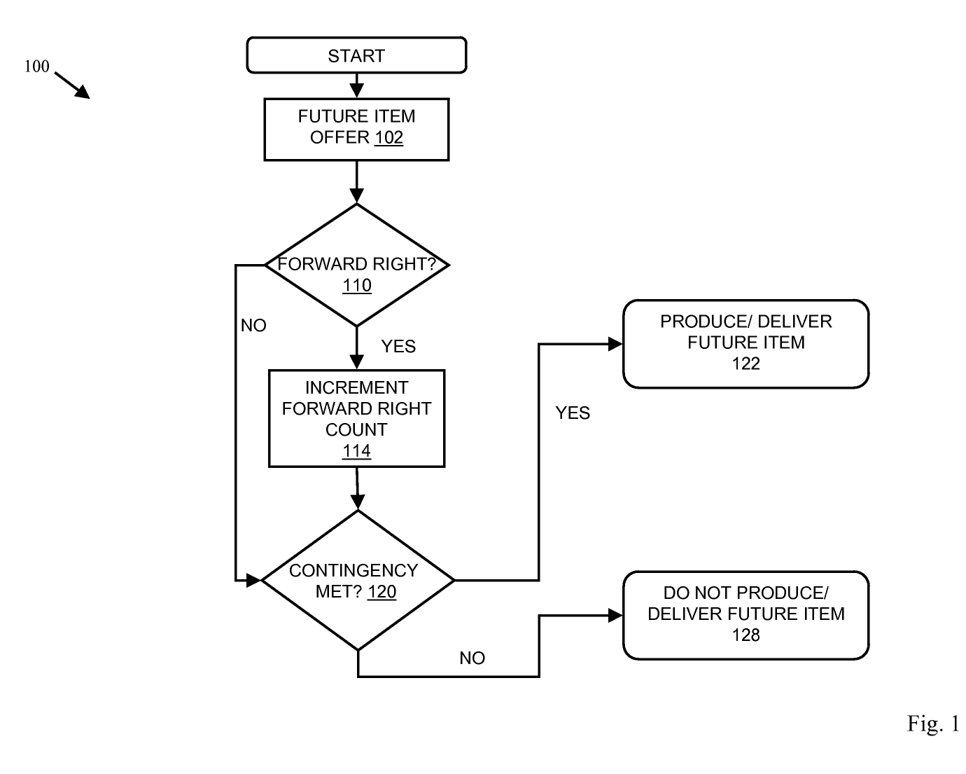

Referring to FIG. 1, a process 100 for demand aggregation may involve offering a future item for production or delivery, wherein the future item may be produced or delivered depending on the interest in the future item as gauged by forward rights obtained or forward obligations with respect to the future item.

A future item may be one or more of a consumer product, a consumer service, content, an accommodation, an event, a sporting event, a music event, a theater event, a performance, a music release, a movie release, user-generated new content, an opening of a hotel, a presentation by a particular person, a toy, a game, a consumer electronics item, a work of art, a publication, a book, a real estate offering or listing, and the like. A future item may be anything that may be commissioned, produced, designed, created, delivered, built, offered, sold, purchased, traded, exchanged, and the like.

As shown by element 102, a future item offer may be a communication delivered to audience members, such as and without limitation members of a social network, television viewers, visitors to a website, retail consumers, and the like, to propose production of a future item, delivery of a future item, creation of content, and the like, that may be produced by a user or content producer upon meeting a contingency. If a contingency, such as and without limitation sufficient demand for the future item, is not met, the future item may not be produced or delivered. However, an offeror may still choose to produce the future item even if the contingency of aggregating sufficient demand is not met. Other or additional contingencies and/or attributes may be associated with the future item. For example, an attribute or contingency of a future item may be that it is offered for a specific team. In another example, an attribute of a future item may be that it is offered for a specific kind of future item, such as an event ticket, a book, a digital download, and the like. In another example, a contingency or attribute of the future item may be its expiration after a certain date. In another example, a contingency or attribute may be a location associated with the future item. In another example, the contingency or attribute may be how a contingency may be resolved, such as due to an aspect of demand aggregation, the weather, a team standing, and the like.

Offerees may indicate an interest in the proposed future item. Interest in the proposed future item may be indicated by, for example and without limitation, obtaining a forward right, which should be understood to include a right, an obligation, or both. Forward rights and/or obligations may be embodied in an advance reservation, contingent event certificate, and the like. Forward rights and/or obligations may be obtained, for example and without limitation, by e-mail, telephone call, instant message, page, website submission, purchase, or the like.

As shown by element 110, a test may determine whether forward rights and/or obligations are obtained. If the test is affirmative, the forward right and/or obligation count may be incremented, as shown by element 114. Otherwise the forward right and/or obligation count may not be incremented, as shown by the arrow from element 110 to element 120.

Continuing on to a test at element 120, the production of the future item may be associated with a contingency, such as aggregating sufficient demand for the future item, as measured by reaching a threshold number of offerees indicating an interest in the future item. If a contingency is met, the test's result is affirmative, and the future item may be produced or delivered as shown by element 122. If a contingency is not met, the test's result is negative, and the future item may not be produced or delivered as shown by element 128. An offeror may still choose to produce the future item even if the contingency of aggregating sufficient demand is not met.

A forward right and/or obligation to the future item may provide a rights holder one or more of a right to a future item, a first right to a future item such as in an early product release, the ability to trade a forward right, a discount on a future item, a discount on a future item based on when the forward right was acquired, an obligation with respect to the future item, and the like. A forward right may be associated with a forward obligation to purchase the future item. A forward right and/or obligation may be free to obtain, but may commit a rights holder to purchasing the future item at the retail or agreed-upon price.

For the purpose of illustration and not limitation, an example application that provides demand aggregation for future items follows. In such an embodiment, a product package, such as a tent with an integrated cooler and barbecue, may be offered as a future item to shoppers at a camping goods retailer. The camping goods retailer may have a partnership with a camping goods manufacturer wherein if sufficient demand for the tent is aggregated by the retailer, the manufacturer will produce the tent. In some embodiments, the manufacturer may be obligated to produce the tent. If insufficient demand is aggregated, the tent may not be produced. The retailer may measure aggregation of demand by the number of forward rights (optionally including obligations, rights, or both) to the tent obtained by consumers. Forward rights and/or obligations may be obtained by purchase, earned with points accumulated in a loyalty program, an advance reservation, and the like.

In another example, a competition, such as the Ultimate Fighting Championship, may be announced between two participants. Forward rights and/or obligations to tickets to the match may be offered as a future item. The producers of the boxing match may gauge demand for the potential match-up by the number of forward rights and/or obligations sold, obtained, or earned based on the participants announced for the match. The producer of the match may reserve the right to modify the participants, such as if insufficient demand for the match is observed as measured by sales or procurement of forward rights and/or obligations. The producer of the match may also gauge potential pricing for face value tickets to the match based on the demand for the match. The forward rights and/or obligations offered (as shown by element 102) may be contingent upon the named participants appearing in the final match. If the two participants in the original forward rights and/or obligations offer do not end up in the match, the forward rights and/or obligations may not be applied to tickets to the current match. Alternatively, the producer may choose to honor the forward rights and/or obligations regardless of the contingency not being met. In an alternative embodiment, the producer may be obligated to honor the forward rights.

In another example, forward rights and/or obligations to a NASCAR Cup championship race may be offered at the beginning of the NASCAR season. Racers accumulate points throughout the season to qualify for the championship race. The forward rights and/or obligations offered at the beginning of the season may be contingent upon certain racers appearing in the championship race. If the racer specified in the forward rights and/or obligations contingency does not appear in the championship race, the forward rights and/or obligations may be forfeited. Alternatively, if sufficient demand for a particular racer is gauged by the number of forward rights and/or obligations purchased, earned, or obtained based on the racer's participation in the championship race, the race administrators may choose to waive the points accumulation requirement and allow the racer to participate in the championship race.

In another example, if a football player announced a desire to be drafted into a football league, forward rights and/or obligations to draft the player to a specific team may be offered. For example, a user may purchase a forward right and/or obligation to see the draftee play in their hometown league. If sufficient demand for a draft of the player to the hometown team is gauged by the number of forward rights and/or obligations sold, earned, or obtained, the player may be drafted.

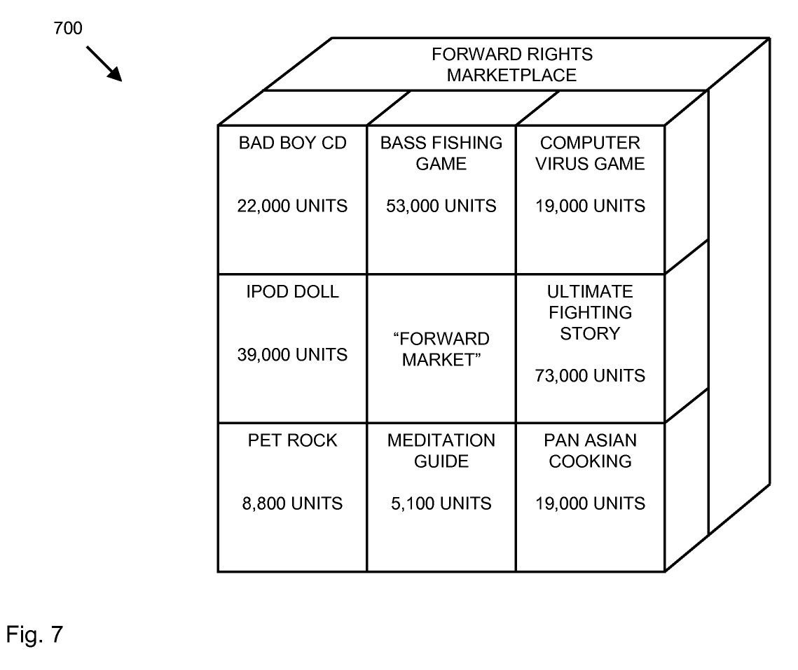

Referring to FIG. 7, a forward rights and/or obligations marketplace 700 may without limitation include any and all of the markets, marketplaces, and platforms described herein and elsewhere. The marketplace 700 may support forward markets and demand aggregation of forward rights and/or obligations for a variety of future items, such as and without limitation a Bad Boy CD, a bass fishing game, a computer virus game, an iPod doll, an Ultimate Fighting story, a pet rock, a meditation guide, a pan-Asian cooking guide, and so on.

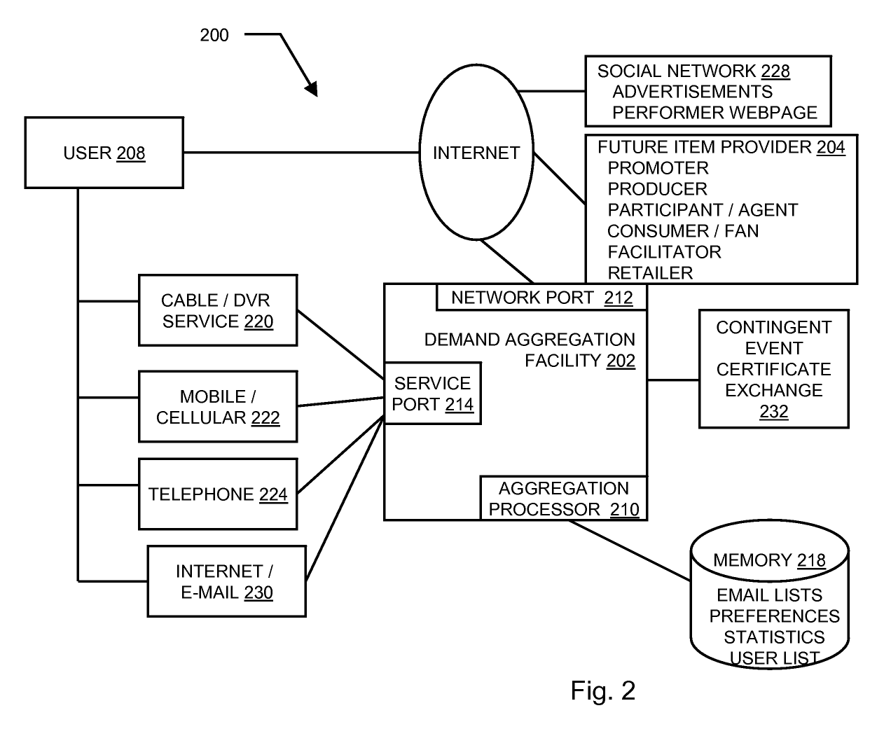

Referring to FIG. 2, elements of the process and steps described in FIG. 1 may be enabled by a demand aggregation platform 200. The demand aggregation platform 200 may include a demand aggregation facility 202, a future item provider 204, a user 208, an aggregation processor 210, a network port 212, a service port 214, a memory module 218, a cable/DVR service or provider 220, a mobile/cellular service provider 222, a telephone service provider 224, a social network 228, an Internet/e-mail service or provider 230, and a contingent event certificate exchange 232.

The demand aggregation facility 202 may facilitate a future item provider 204 who is managing planning, preparing, producing, promoting, et cetera, a future item, such as a product, service, or event. The demand aggregation facility 202 may allow a future item provider 204 to interact with other future item providers 204 and one or more users 208 to predict, generate, and/or guarantee the demand for a future item associated with the users 208.

Future item providers 204 might include a wide range of manufacturers, distributors, producers, and retailers who provide such items as video games, cell phones, consumer electronics, toys, books, movies, music, live events, and the like. Without limitation, examples of producers include performers, producers, directors, executive producers, television executives, production companies, film companies, record labels, studios, publishers, authors, performers, athletes, promoters, team owners, venue owners, tour promoters, concession operators, sponsors, advertisers, or the like.

Users 208 may also include consumers, such as sports fans, music fans, members of social networks, members of fan clubs and other affinity groups, fans of particular authors or genres of books, customers with loyalty to particular companies, brands, products or services, and the like. In some embodiments, from time to time, one or more of the future item providers 204 may encompass one or more of the users 208 and vice versa. Users may be future item consumers, producers, or the like.

The demand aggregation facility 202 may also facilitate accessing a contingent event certificate exchange 232 through which contingent event rights or certificates for a potential future item may be bought, sold, traded, and exchanged. By facilitating access to the contingent event certificate exchange 232 and aggregating demand associated with a future item, the demand aggregation facility 202 may provide a facility for predicting, measuring, and/or guaranteeing demand for a future item.

The contingent event certificate exchange 232 may include a computing facility providing a marketplace for contingent event certificates. It will be appreciated that a variety of embodiments of the contingent event certificate exchange 232 are possible.

The demand aggregation facility 202 may be an electronic facility that includes an aggregation processor 210, a network port 212, and a service port 214. The aggregation processor 210 may be a computer such as a server or personal computer. The aggregation processor 210 may process information related to contingent event demand, communicate to Internet clients through the network port 212, and handle servicing devices through the service port 214. The network port 212 may provide an interface to the Internet that facilitates users 208 and future item providers 204 accessing the demand aggregation facility 202. The aggregation processor 210 may include one or more memories 218 that may store software programs that the aggregation processor 210 executes to process information related to future item demand. The one or more memories may also store data related to future item demand that may be useful in predicting and/or guaranteeing demand for a future item.

The service port 214 may facilitate communication between the demand aggregation facility 202 and one or more of the services providers (220, 222, 224, 230). It will be appreciated that various protocols, physical networks, logical networks, applications, and the like may be suitably employed to enable these communications.

The service port 214 may facilitate communication between the demand aggregation facility 202 and a variety of online platform service providers such as cable/DVR service providers 220, DSL providers, Internet Service Providers (ISPs), mobile or cellular phone service providers 222, Internet/e-mail providers 230, and telephone service providers. These service providers, like other producers and providers described hereinabove and elsewhere, may facilitate promoting a future item. Through the service port 214, they may also facilitate a user 208 of one or more of the services providing input to the demand aggregation facility 202 regarding a future item and a contingent event certificate associated with a future item.

The network port 212 may, through an Internet connection, facilitate any number of users 208 and future item providers 204 interacting with the demand aggregation facility 202 for purposes of receiving information about future items and providing input to the demand aggregation facility 202 regarding future items and contingent event certificates associated with a future item.

A user 208 may use a computer or other network client device to interact with the demand aggregation facility 202. The user 208 or future item provider 204 may access the demand aggregation facility 202 through the Internet through a web browser communicating with a public URL of the demand aggregation facility 202. The user 208 or future item provider 204 may also interact with the demand aggregation facility 202 through email, messaging (e.g., instant messaging), and RSS feeds for example.

The demand aggregation facility 202 may provide an interface, such as a web site or web page, that may include screens that a user 208 or future item provider 204 may use to request a future item that might be produced in response to obtaining, from users 208, future item-related commitments (such as and without limitation pre-orders for the future item or future item-related items). The screen may include data entry fields in which a user 208 or future item provider 204 may input information related to a request for a future item. The information may include retailer, performer or performers, type of the future item, location or locale of the future item, timing of the future item, estimated date of delivery for a product, preliminary design prototypes to be shared with those users 208 who own the forward rights and/or obligations, product input sections for users 208 who might influence the ultimate design of the product, and other aspects. The information may be processed by the aggregation processor 210 to define a forward market 2802 for the future item. The aggregation processor 210 may record in memory 218 details about the forward market 2802 that it may later use in predicting and/or guaranteeing the demand for the future item associated with the forward market 2802. The details may include the future item request information input by the user 208 or future item provider 204, registration information provided by the user 208 or future item provider 204, the date and time of the request, and the like.

Referring now to FIG. 28 of Harmon 4, the forward market 2802 data may be provided to the contingent event certificate exchange 232 for purposes of establishing a contingent event certificate market for the forward market 2802. The contingent event certificate exchange 232 may provide contingent event certificate information to the demand aggregation facility 202 for promoting and aggregating demand information about the forward market 2802. The information may facilitate the aggregation processor 210 associating a future item of a forward market 2802 with a contingent event certificate market. In some embodiments, the forward market 2802 is the contingent event certificate market.

The demand aggregation facility 202 may promote a forward market 2802 such that users 208 may receive promotional information about the forward market 2802. The demand aggregation facility 202 may provide promotional information through the service port 214 that facilitates reaching a user 208 of one or more of the services connected through the service port 214. Users 208 may also respond to the promotional material through the service port 214. The communication between the service port 214 and the service providers (220, 222, 224, 230) may allow a user 208 to accept the promotional offer and perform a transaction associated with the forward event 2802 or future item, such as purchasing a contingent event certificate through the contingent event certificate exchange 232.

The aggregation processor may access one or more lists of users who may have an interest in a forward market 2802. The list may include contact information for the users such as an e-mail address, an instant message user name, a cell phone number, and a telephone number. The list may be derived from a variety of sources including purchasing the list from a user list provider. The list may include previous users of the demand aggregation facility 202 or the contingent event certificate exchange 232. The demand aggregation facility 202 may contact one or more of these users to provide promotional information about the forward market 2802.

In an example, the demand aggregation facility 202 may make automated promotional telephone calls through the telephone service provider 224 via the service port 214. The promotional call may include voice and/or audio content that the user 208 may receive directly by answering a telephone that is operatively coupled to the telephone service provider 224, or by later retrieving a voice mail message of the call. The promotional call may include information about the forward market 2802 and the contingent event certificate market. The user may respond to the promotional call in a variety of ways including making a telephone call to the demand aggregation facility 202 for automated processing. In an example, a promotional call from the demand aggregation facility 202 may include one or more phone numbers that the user 208 may call to reply to the promotion. At least one of the phone numbers may permit the user 208 to purchase a contingent event certificate for the forward market 2802. A call to the purchase phone number may charge the cost of the contingent event certificate to the user's phone bill. The purchase phone number may be managed by the contingent event certificate exchange 232.

In another example, the demand aggregation facility 202 may send a text message to the list of users 208 through the mobile/cellular service provider 222 that may include reply information as well as contingent event certificate market-related information.

A user 208 of a cable/DVR service 220 may receive a promotional message such as an advertisement from the demand aggregation facility 202. The user 208 may select to reply to the promotion through the cable/DVR service 220 provider pay-per-view transaction service to purchase a contingent event certificate for the forward market 2802. The cost of the contingent event certificate would be charged to the user's cable/DVR service account. The demand aggregation facility 202 may facilitate communicating the user's reply to the contingent event certificate exchange 232 and may facilitate communicating the contingent event certificate information to the user's cable/DVR service 220 such that the contingent event certificate information may be provided to the user 208 through the cable/DVR service provider 220 (e.g., through an e-mail to the user's account or by hard-copy monthly billing).

The demand aggregation facility 202 may promote the forward market 2802 through Internet/e-mail providers 230. The demand aggregation facility 202 may process the future item request information to generate a list of keywords appropriate for use in an Internet advertisement search engine campaign. The demand aggregation facility 202 may automatically generate an Adword campaign with search engines such as Google and Yahoo Search that would provide sponsored results promoting the forward market 2802. The demand aggregation facility 202 may process the future item request information to generate an e-mail to be sent to a mailing list promoting the forward market 2802.

An advertisement or promotion may include any and all forms of advertisement or promotion 202 including, without limitation, a referral, a billboard, an animated billboard, a balloon sign, a directional sign, a signboard, a sky sign, a banner, a graphic, a text advertisement, a page sponsorship, a section sponsorship, an article, a paid feature article, a printed advertisement, a digital advertisement, an audio advertisement, a video advertisement, a live promotion at an event, an outdoor advertisement, a text message, an e-mail, an e-mail newsletter, a webpage, a widget on a webpage, a banner advertisement, a promotional web link, and so on.

In one preferred embodiment, users 208 may access the contingent event certificate exchange 232 directly as herein described. As users make purchases of contingent event certificates for the forward market 2802 through the contingent event certificate exchange 232, the contingent event certificate exchange 232 may send purchase information to the demand aggregation facility 202 for processing. The information may include contingent event certificate purchase quantity, cost, purchaser contact information, method of payment, and the like. The information may be provided with each transaction or may be accumulated and sent periodically, such as once per day.

The aggregation processor 210 may receive this purchase information and generate a prediction and/or guarantee of demand (or, where the contingent right includes a commitment to exercise the right if the future item is produced, a measurement of actual demand) for the forward market 2802. The prediction, measurement, and/or guarantee of demand may be as simple as a count of contingent event certificate sales. However, it may include additional analysis such as average contingent event certificate price, contingent event certificate sales rate, contingent event certificate resale information, and the like.

A user 208 or a future item provider 204 may access the forward market 2802 prediction and/or guarantee information through the network port 212 of the demand aggregation facility 202 using a web browser. The demand aggregation facility 202 may provide the forward market 2802 prediction and/or guarantee information through e-mail, messaging, RSS feed, and the like to the user 208 or future item provider 204 by accessing contact information they may have provided when they requested the event. In particular, the future item provider 204 may decide, based on either a prediction and/or guarantee of demand or based on actual demand, whether in fact to produce or offer the future item. Thus, the exchange of contingent event rights enables the prospective generation of demand for future items, by obtaining commitments from users 208 that trigger the actual production of the future item.

A user 208 or future item provider 204 may also interact with the demand aggregation facility 202 through a social network 228 associated with the demand aggregation facility 202. The social network 228 may be integrated with the demand aggregation facility 202, such as with a common user interface, or it may be linked to the demand aggregation facility 202, such as from a common social networking Internet site. The social network 228 may include a wide range of features, including news and features associated with a topic of interest (such as to a group with an affinity for a particular sports team, movie genre, actor, or the like), blogging tools (allowing users to publish content), communication tools (such as instant messaging, chat rooms and the like), and other features. The interface 228 may also allow for advertising, which may be targeted to users 208 based on the subject matter of the contingent events.

In some embodiments, the social network 228 may enable users to generate proposed contingent event certificates, such as by allowing users to complete a form (such as an XML, HTML, or RSS form) that includes necessary elements of a contingent event right, such as the details of the future item, the contingency, and the price. The social network 228 may allow users to generate and share proposed contingent event rights with other users 208 and with future item producers and providers 204. For example, a user 208 may generate a form that captures the proposition that the user 208 wishes to sell a product. The social network 228 may provide an interface whereby the user 208 can enter product information, such as summary information about the product, product prototype, pricing information and the like and generate referrals for the product. If sufficient demand is generated, such as by reaching a threshold number of pre-sold products, a producer may be obligated to produce the product. In another example, a user 208 might generate a form that captures the proposition that the user wishes to attend a Rolling Stones concert in Lincoln, Nebr. between October 7 and Oct. 20, 2007.

The social network 228 may provide an interface whereby the user 208 can enter event information, location information and date information, whereupon the proposed contingent event right is displayed for evaluation by other users 208 and producers 204. Other users 208 may, upon presentation of a proposed contingent event right and/or obligation, indicate interest in (or a commitment to purchase) the contingent event right and/or obligation in question, thereby allowing providers 204 to evaluate what contingent event rights to offer. A producer 204 may, for example, offer the contingent event right and/or obligation if the producer is capable of satisfying demand for the future item upon emergence of the contingency (such as, in this example, if the producer is a tour promoter for the Rolling Stones). Thus, the social network 228 may allow users 208 and providers 204 to generate a list of prospective contingent event rights and/or obligations, to comment on such rights and/or obligations, to propose modifications to such rights and/or obligations, to indicate demand for such rights and/or obligations, and ultimately, to offer such rights and/or obligations through the associated contingent event certificate exchange 232.

In other embodiments, users 208 of a third party social network may, in their social network web page or web pages, include links such as HTML links to a URL associated with the demand aggregation facility 202 that is related to a forward market 2802 for a future item. The URL may be provided when the future item is requested. The URL may direct a user 208 to a web page that may allow the user 208 to get more information about the future item or user-generated proposal for new content. The web page may provide prediction- and/or guarantee-related information, contingent event certificate exchange 232 access information (e.g., a link to the contingent event certificate exchange 232), and the like.

In embodiments, the demand aggregation facility 202 may be integrated within the contingent event certificate exchange 232. Also, users 208 may have an interface to the contingent event certificate exchange 232 through social networks such as MySpace, Friendster, Facebook, Gaia Online, orkut, Piczo, Yahoo! 360, and the like. For instance, the social network MySpace has online associations to independent music and party gatherings, retailers, manufacturers, distributors, and the like, and may provide an integrated interface to the contingent event certificate exchange 232. A MySpace member may request a future item, such as a new music concert with a targeted artist and targeted venue or a new Electronic Arts video game through the demand aggregation facility 202, and monitor the aggregation of demand for the future item. This aggregation of demand may generate interest from the targeted artist or video game producer who then may set a demand threshold for enabling the future item to be produced. Alternatively or additionally, the artist or video game producer may set the demand threshold in advance of the aggregation.

The demand aggregation process may encompass a dynamic interaction between user demand for a future item and the future item provider's 204 required demand threshold to enable the future item to be produced. A social network member may establish a forward market 2802 for a future item that is not yet available. Members of the social network may then purchase contingent event certificates for the forward market 2802 and thereby aggregate demand for it.

As herein described, the demand aggregation facility 202 may communicate aggregated demand data to a future item provider 204. A future item provider 204 may in turn set a demand threshold for the future item to be produced, such as Bob Dylan requiring a demand of 20,000 contingent event certificates for a concert at Red Rocks, Colo., or the physicist Stephen Hawking requiring a demand of 2,000 contingent event certificates for a lecture at Albert Hall, London, or a 1970's punk rock star requiring 200 contingent event certificates to come to a large party to meet the guests, or a social network user requiring 1,000 contingent event certificates for creation of a new game that revolves around the infection of computer viruses within a community, or Nintendo requiring 250,000 contingent event certificates to produce the next generation of a gaming system, or Electronic Arts requiring 25,000 contingent event certificates to produce a sequel to an existing game, or the like. It will be appreciated that demand aggregation may encompass, without limitation, demand-based production or a process of taking something from an idea state to a reality state (or not doing so, in the case of insufficient demand).

In some embodiments, once a contingent event certificate is purchased, it may not be sold until the minimum demand threshold is reached or until a marketplace for a given item is closed. The selling and trading of contingent event certificates may be facilitated within the contingent event certificate exchange 232 or within a secondary marketplace for contingent event or forward rights and/or obligations. Contingent event or forward rights and/or obligations may be bought and sold within the controlled environment of a contingent event certificate exchange 232. If the demand threshold for a future item is met, then the future item may be produced, and purchasers of contingent event certificates may be obligated to purchase the future item or access to the future item, such as a ticket, at the retail or agreed-upon price. If the demand threshold is not met, the holders of the contingent event certificates may, or in some embodiments may not, receive refunds for the cost of their contingent event certificates. In some embodiments, contingent event certificate holders may pay nothing for the contingent event certificate, but will assume the obligation to purchase if the contingency, such as demand level, is met. The process of aggregation of demand may drive a future item, such as an idea for a book, from being contemplated to being produced, offered, scheduled, or populated, such as publication of the book, and finally fixed for sale or, in the example of the book, shipped to contingent event certificate holders. Once the future item is fixed, contingent event certificate holders may be able to purchase the actual future item. If demand does not reach demand threshold, the future item may not be produced. And during the process of demand aggregation, a secondary marketplace may allow contingent event certificate holders to financially profit from the selling of contingent event certificates. For example, a forward market may be closed after a certain period of time or after a threshold of demand has aggregated, so that trading of forward rights and/or obligations on a secondary marketplace may begin.

Future item providers 204 may register through an interface of the demand aggregation facility 202 to facilitate the availability of future items. Future item providers 204 may include manufacturers, distributors, retailers, performers, musicians, celebrities, lecturers, sports figures, entertainers, game developers, artists, individuals, amateurs, or the like, or may include other individuals or entities that facilitate production of a future item, such as described herein. A future item provider 204 may specify conditions under which the future item will be produced, such as if a certain minimum amount of money is guaranteed; if the event is in a certain location, date, venue; if there is a guaranteed number of performances per year; or the like. A future item producer or provider 204 may contractually bind themselves to these specified conditions thereby enabling the demand aggregation facility 202 to generate a forward market 2802. The future item producer or provider 204 may monitor the demand aggregation for the future item using the demand aggregation facility 202 web pages. Of course, the future item producer or provider 204 may choose to accept conditions outside the initially specified conditions if a prediction and/or guarantee of demand indicates acceptance may be beneficial for the future item producer or provider 204. For example, if a product manufacturer had originally specified only certain features of a new tent, but the demand aggregation facility 202 predicts and/or guarantees a good demand for the tent, they may choose to add additional features to the tent. In another example, if an event performer had originally specified New York City as the only performance location, but the demand aggregation facility 202 predicts and/or guarantees a good demand for them to perform in a different city, they may accept the new location and agree to perform there.

In some embodiments, future item providers 204 may bid for the right to issue contingent event rights for a particular future item. Thus, the demand aggregation facility 202 may include a bidding interface that allows providers 204 to bid. The bidding interface may, for example, award a right to issue contingent event rights for a particular future item to the bidder offering the most favorable price, the most desired future item, or the like. For example, if a proposed contingent event includes a contingent accommodation event (such as providing a room for two in Boston if Paul McCartney plays a concert there in the first week in December), then different accommodations providers may bid for the right to offer the contingent accommodations.

In some embodiments, multiple providers 204 may be allowed to offer the same contingent event right, in which case a user may be offered a choice of provider 204 (such as a particular hotel, restaurant, or the like associated with attendance of a contingent event). Alternatively or additionally, the user 208 may issue contingent event or forward rights and/or obligations and, upon selling an adequate number of them, tell a provider 204 to produce the future item or have a plurality of providers 204 bid on the rights to produce the future item. For example and without limitation, a user 208 may publish an outline for a book that he proposes to write. In response to this outline, perhaps 200,000 or more forward rights and/or obligations may be sold that obligate the holder of the right to purchase a copy of the book if and when it is published. Armed with this aggregation of forward rights and/or obligations, the user 208 may put the right to publish the book up for bid. A plurality of providers 204 may then bid on the publication rights to the book, knowing that each contingent event right represents a guaranteed order for a copy of the book. The plurality of providers 204 may also bid to get access to a social network and/or the contingent event certificate marketplace. Many other such examples will be appreciated, and all such examples are within the scope of the present disclosure.

Thus, the demand aggregation facility 202 described herein helps support the creation of user-driven content, (products, services, inventions, businesses, books, movies, et cetera) through the power of an organized social network. It is an approach of future item creation (including content future items, such as publications of works) from the bottom up. Thus, rather than having products imposed on them by producers, users 208 can ask for the products they want, and if demand is sufficient, can encourage the generation of non-standard future items. For example, if a small number of users 208 are willing to pay a large amount for a Star Wars collectible figurine, these economics would allow a provider 204 to produce this figurine without risk while satisfying the users 208. Thus, by operating as and in association with a demand aggregation facility 202, a contingent event certificate exchange 232 offers users opportunities to purchase rights (i.e., contingent rights) for things not yet known or created. A contingent event right is thus the key to supporting the creation of a future item, such as associated with a social network of users who share common desires for particular future items.

In one embodiment, a demand aggregation facility 202 may track “hot markets.” The facility 202 can, for example, have “ramp up monitors” or other metrics that monitor aggregation of demand for future items, such as showing providers 204 and users 208 of the social network interface 228 or other interface of the demand aggregation facility 202 the “uptake” of various creative initiatives. Producers could evaluate demand for consumer products, consumer services, books, live music events, music CDs, video games, sports matches, and the like to see what future items are getting the most traction. An interface can show periodic totals for demand, such as daily and weekly totals (for a book 1,950 copies daily, 14,600 weekly), and can show future projections based on the uptake numbers to date as well as the “speed of uptake” as a variable. In this way, hot uptake markets could prosper. The demand aggregation facility 202 can include a “ticker” of sorts for tracking popularity of particular contingent rights.

Thus, in contrast to a market where production currently requires investment in advance of sale of rights and/or obligations, a contingent event rights marketplace allows investment to follow the aggregation of demand that justifies the investment. The rights and/or obligations are established in advance (in a forward market), rather than having the market react, unpredictably, to an item that has already taken shape, perhaps the wrong shape, at the expense of the provider.

In various embodiments described herein, any attribute with respect to which a contingent event certificate may be issued may be an attribute about which demand can be assessed or aggregated. For example, a contingency may include the presence of a team or player in a particular round or game of a sporting season or event, the occurrence of a live performance by a particular performer or group in a particular venue on a particular date or during a range of dates, the issuance of a work by an author or performer having certain characteristics (theme, character, plot, location, time period, occurrence in a series of related works, or inclusion of particular works in a collection of works, et cetera), the production of a television show or movie with certain desired characteristics (theme, stars, director, position in a series, et cetera), the publication of a book, the supply of a product, service, or technology having certain desired attributes, or other type of contingency.

Future item planning, preparation, production, and promotion often take on financial risks associated with the financial success of the future item. A demand aggregation platform 200 may facilitate managing financial and business risks associated with producing consumer products and services and other contemplated future items and events by providing an opportunity to assess the interest in the contemplated future items and events.

In one example of a contingent rights exchange 232, an author of a fiction novel may write a summary premise and distribute it to a social network 228 via the social network interface. Initially, the author may not know if the book will gain enough traction to get published or not (it is contingent). In order to “measure” the commitment, the author may sell forward rights on a contingent basis. In effect, the author is asking the social network: “If my book gets written/published, will you commit to purchase it?” Thus, the forward right and/or obligation may include a right and obligation to purchase if these contingent variables are met; in this case, for example, a book passing a particular mark in “pre-sales.” With a retail price of $19.50, and with 200,000 forward commitments, the author has secured $3,900,000 in advance revenue. The instrument is contingent in that the author might only get 20,000 “commitments,” in which case the novel will not be published.

In some embodiments, a forward right and/or obligation may be evidenced by a certificate or other document evidencing ownership.

In some embodiments, a framework with limited user/producer configuration abilities may be provided. In the book example, consumers 208 could be rewarded if demand exceeds various thresholds, such as by reduced cost, or even free goods, such as offered to the earliest purchasers of contingent event rights. Algorithms may be provided to allocate benefits to users 208 who help generate demand. In a sense, as more people join in, more benefits can be allocated. For example, as demand increases, a provider 204 can lower the cost to initial consumers 208 who initiated demand, and, as demand increases even further, such initial consumers 208 might be provided a free event, or even a share of the profits (effectively rendering some consumers 208 co-producers for the event). The producer may always be the author (i.e., the one who originated the concept), but a certain number of users 208 may become “co-producers” as momentum builds. The financial incentive for such projects may be critical, in that it drives a “get in early” mentality among users.

In addition to the rules definition (the certificate component), the contingent rights market might include various features such as levels of “producer,” such as assistant producer, senior producer, executive producer, co-producer, and founding producer. Each level would have predefined “payouts,” and providers 204 would have an incentive to encourage members of a social network to increase both the provider's and the network's level of attainments.

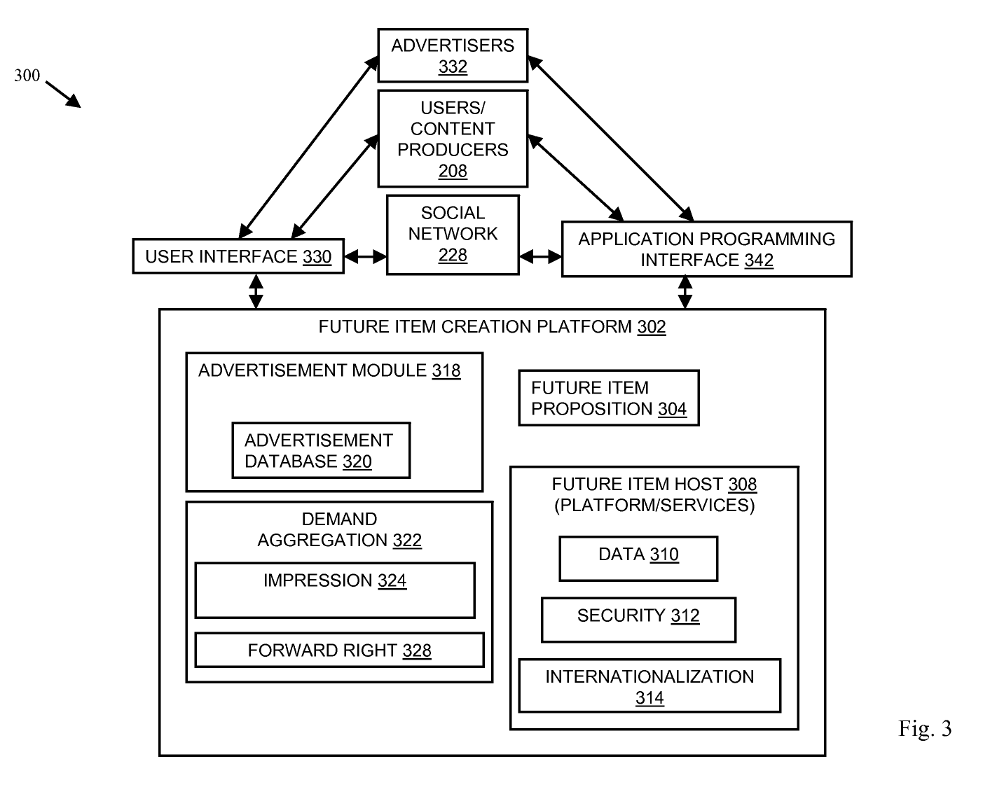

Referring now to FIG. 3, an embodiment 300 of a future item creation platform 302 includes an advertisement module 318, demand aggregation 322, a future item proposition 304, and a future item host 308. The advertisement module 318 includes an advertisement database 320. Demand aggregation 322 includes an impression 324 and a forward right and/or obligation 328. The future item host 308 includes data 310, security 312, and internationalization 314.

The future item creation platform 302 may include and/or provide a user interface 330 and an application programming interface 342. Advertisers 332 and users/content producers 208 may interact with the future item creation platform 302 via the user interface 330 and/or the application programming interface 342. A variety of embodiments and applications of the user interface 330 and the application programming interface 342 will be appreciated.

The forward right and/or obligation 328 may include a right and/or obligation to perform an action. The action may include purchasing something and/or selling something. In some embodiments, sales of forward rights and/or obligations 328 may provide indications of demand for purchasing and/or selling something. It will be understood that a variety of forward rights and/or obligations 328 are possible.

The future item creation platform 302 may enable user-driven advertising and contingent content, user-driven future item creation, and the like. In some embodiments, a user 208 may propose creation of a future item, such as contingent content, or user-generated new content, to consumers or producers, where each proposition may be accompanied by an advertisement 318 of his choice, which may be accompanied by an endorsement of the advertised future item. The future item may be produced depending on the interest in the project as gauged by forward rights obtained and/or impressions. In other words, users 208 who propose future items may include advertising associated with their proposals, and either get paid directly based on views, clicks, or impressions in response to the advertisement 318, or use the associated advertisement 318 as a means to reduce their threshold for demand aggregation. For example, a user 208 may propose a new cookbook. In the proposal being distributed around a social network 228, the user 208 may insert an advertisement 318 selected from an advertisement database 320. Since the proposal and associated advertisement 318 is going out to the social network 228, which may include friends and fellow cooks, the user 208 may pick an advertisement 318 for a new cooking accessory and associate a comment with the advertisement, such as “I have used this new hand mixer and found it very useful . . . you guys will love it too!!” An advantage of associating an advertisement with the book proposal may be that if the book portion of the market requires 40,000 contingent event certificates commitments, utilizing an advertisement with the proposal may reduce the requirement to 35,000 contingent event certificate commitments.

It will be understood that a variety of embodiments of the future item creation platform 302 are possible.

Embodiments may include a system for future item proposition 304, comprising a future item creation platform 302, a user interface 330, users/content producers 208, a social network 228, and advertisers 332. In some embodiments, the social network may be substituted for any suitable audience.

The future item host 308 may provide software-based services for users of the future item creation platform 302 that may provide personalized access capabilities, which may be adapted for participants such as and without limitation users/content producers 208, advertisers 332, or the like.

Security 312 may include physical security, data security, and the like. Security 312 may be directed at protecting the integrity and/or privacy of the data 310. Security 312 may help ensure that the future item host 308 is configured, altered, used, or otherwise accessed only by authorized personnel or applications. It will be understood that a variety of embodiments of security 312 are possible.

Internationalization 314 may provide alternate presentations, features, or the like that are suitable for a particular region, culture, country, market, language, time zone, any and all combinations of the foregoing, and so on. It will be understood that a variety of embodiments and applications of internationalization 314 are possible.

Users 208 may have customized access to host services of the future item creation platform 302 through a web portal, where access may be dependent upon the type of user, such as a username/password customer interface for a forward right and/or obligation 328, a secure access for users, customer service access for advertisers 332, or the like.

The host 308 may include a server or computing facility providing access to data storage for users 208 of the future item creation platform 302. The data 310 may without limitation include user information, billing information, content information, contingent conditions, or the like. The host 308 server may also provide facilities for providing confirmed forward rights and/or obligations to users, system security, internationalization and technological interface to users, or the like.

The future item creation platform 302 may facilitate a future item creation proposition. A future item proposition 304 may be a communication delivered to audience members, such as and without limitation members of a social network, to propose creation of content that may be produced by a user or content producer 208 upon meeting a contingency. If a contingency, such as and without limitation, sufficient demand aggregation 322, is not met, the future item may not be created. Future items may be a consumer product, a service offering, a literary publication, music, fashion, art, events, or any and all other kinds of content or future items.

The future item creation platform 302 may facilitate associating an advertisement 318 with the future item proposition 304. An advertiser 332 may utilize the future item creation platform 302 to populate an advertisement database 320. A user 208 may use the user interface 330 to the future item creation platform 302 to select an advertisement 318 from the advertisement database 320 and, optionally, add commentary, reviews, editorials, and the like to the advertisement 318 and associate the advertisement 318 with the future item proposition 304.

It will be understood that a variety of advertisers 332 are possible. Without limitation, these include individuals, businesses, advertising agencies, and so on.

In some embodiments, users 208 (including without limitation content producers) may associate themselves with the future item creation platform 302. The users 208 may submit proposed content for development, the content being developed if and when a prescribed threshold of demand is met. The demand threshold may be met when an appropriate number of users 208 have committed themselves to purchase the content if and when the content is produced. The future item creation platform 302 may trigger, direct, or carry out billing of users 208 and delivery of content in connection with the demand threshold being met. For example and without limitation, when the demand threshold is met, the future item creation platform 302 may submit a plurality of credit card charges to a payment gateway, the charges being against the credit cards of a plurality of users 208 who are committed to purchasing the content. In connection with these charges, the future item creation platform 302 may transmit a plurality of e-mail messages, one or more to each of the users 208, the messages containing the content or enabling the users 208 to receive the content. An owner or operator of the future item creation platform 302 may collect a fee in association with the charges and delivery of content. The fee may be charged to the producer of the content, to the users 208 who purchase the content, to a promoter of the content, any and all combinations of the foregoing, and so on. A variety of such examples will be understood.

Throughout this disclosure and elsewhere, the impression 324 may be any and all instances when an advertisement is viewed, heard, experienced, or the like. A variety of embodiments of the impression 324 will be appreciated.

A user interface 330 to the future item creation platform 302 may be associated with a social network facility 616. The social network facility 616 may provide social networking functions so as to enable a social network 228.

In some embodiments, the future item creation platform 302 may have an interface with a social network facility. (The social network facility may be described hereinafter with reference to FIG. 6 as the social network facility 616.) This interface may be programmatic or comprise an operative coupling between the social network facility 616 and the platform 302. Alternatively, the interface may result from social interactions within the social network 228. The interface between the future item creation platform 302 and the social network facility 616 may enable initiation of a future item creation proposition 304, association of an advertisement 318, sending future item propositions 304 to a members of a social network, monitoring of the demand aggregation 322 within a social network 228, monitoring of revenue generation within a social network 228, or the like. The interface may be implemented as an information exchange between servers of the social network facility 616 and the future item creation platform's 302 host 308 servers. In some embodiments, according to any and all protocols for information exchange between networks, computers, and the like.

The user interface 330 may provide information that is sorted by demand, genre (such as music, lectures, fashion, art, or the like), location, performers, language, date, and so on. Since demand is a function of forward rights and/or obligations 328, security measures may also be taken to ensure the validity of each forward right and/or obligation, such as supplying digital tags to each confirmed forward right and/or obligation. An individual or a group may initiate future item creation through the user interface 330 between a social network 228 and the future item creation platform 302. For instance, a social network 228 may have online associations to independent music and party gatherings, and may provide users 208 with access to these in an interface that also includes access to features or functions of the future item creation platform 302. In some embodiments, a user of a social network 228 may initiate a future item creation proposition 304 for a new music album and then may monitor the demand aggregation 322 for the album. This demand aggregation 322 may generate interest from a music studio that then may set a demand threshold for enabling the album to proceed to production. It will be understood that any and all like examples are within the scope of the present disclosure.

The demand aggregation process may be a dynamic interaction between demand aggregation 322 for proposed content and a content producer's 208 required demand threshold to enable the content to be generated. A social network member may generate a future item proposition 304 and members of the social network may then make forward rights and/or obligations 328 for the future item and thereby instantiate or affect demand aggregation 322 for the future item. Demand aggregation 322 for the future item, in the form of impressions 324 and forward rights and/or obligations, may be communicated to users. A user 208 may in turn set a demand threshold for the future item to be produced or generated, such as and without limitation by requiring a demand of 10,000 forward rights and/or obligations for a book written by a new writer.

A facility for measuring and tracking the demand aggregation 322 for future items may be provided within the future item creation platform 302. The facility may provide for monitoring of demand aggregation 322. Demand may be indicated by one or more actions of individual customers, members of a social network, content producers 208, or the like. In some embodiments, a user 208 may use the user interface 330 to receive an alert if the threshold for demand aggregation 322 is exceeded.

A future item may be contingent content that is produced or generated by a user upon meeting a contingency. For example and without limitation, a user may propose to write a fictional book based on a recent gubernatorial race. An element of the proposition may be that the user does not write the proposed book unless a contingency is met. The contingency may include a demonstration of interest in the proposed book by a threshold number of audience members. A user may propose the future item to an audience. The audience may be, for example and without limitation, members of a social network. A user may propose the future item using electronic mail, a bulletin board posting, a web page, an instant message, a voicemail, a page, a telephone call, a letter, and the like. Many such future item propositions 304 will be appreciated and all such future item propositions 304 are within the scope of the present disclosure.

The user may associate an advertisement 318 with the future item proposition 304. The user may select the advertisement 318 from a advertisement database 320. Advertisers 332 may be charged a fee to include their advertisement 318 in the advertisement database 320. Alternatively, the advertisement 318 may be a link to a web page, an email, a brochure, an image, a video, or the like. The user may choose to not associate an advertisement 318 with the future item proposition 304. The advertisement 318 may or may not be related to the subject matter of the future item proposition 304. The user may provide an endorsement of the advertised goods or services in the associated advertisement 318. The endorsement may be a review, a comment, an editorial, or the like. In some embodiments, association of the advertisement with the proposal may serve to reduce the threshold for demand aggregation.

Input may be received when an audience member accesses the advertisement 318. Upon receiving the future item proposition 304 and its associated advertisement 318, the audience member may view, hear, or otherwise receive an “impression” of the content and/or the advertisement 318. In some embodiments, the audience member may perform additional actions that are associated with the future item proposition 304 and its associated advertisement 318, such as printing, emailing, saving, et cetera, and these actions, too, may be counted as impressions. Thus, the total number of impressions 324 may be equivalent to the total number of actions performed with the future item proposition 304 and advertisement 318. Alternatively, the total number of impressions 324 may include a count of only some actions made by audience members and/or only actions made by particular audience members. An audience member may “click-through” an advertisement 318. A click-through may be the process of clicking through an advertisement 318 to reach the advertiser's destination. In addition to or instead of a click-through, an audience member may choose to type a company's URL directly into the browser bar, or type the company's name into a search engine box.

Audience members may indicate an interest in the proposed future item. Interest in the proposed future item may be indicated by, for example and without limitation, obtaining forward rights and/or obligations 328 to the content. Forward rights and/or obligations 328 may be obtained, for example and without limitation, by e-mail, telephone call, instant message, page, website submission, or the like. If no forward rights and/or obligations 328 are received, the impression count may be incremented. If forward rights and/or obligations 328 are obtained, the forward right and/or obligation count and impression count may be incremented. In any case, additional input may be received and processed similarly. The creation of the future item may be contingent on reaching a threshold number of audience members indicating an interest in the future item. Alternatively, creation of the user content may be contingent on a threshold number of impressions 324 made by audience members. Alternatively, creation of the future item may be contingent on a threshold combination of the number of indications of interest and impressions. Impressions 324 may be valued less than an indication of interest in determining if a threshold has been reached. For example and without limitation, an impression 324 may be valued at one fourth of the value of a forward right and/or obligation 328. Advertising revenue may be collected or paid out if future item is created or even if a threshold is not reached.

Advertising revenue may be generated by each impression, a group of impressions, a click-through, a group of click-throughs, or some combination thereof. A click-through may generate more revenue than an impression. The value of an impression 324 may be a fraction of the value of a click-through in determining advertising revenue. The advertisement 318 may implement or be associated with referral fees. If an audience member ultimately purchases or uses the goods or services advertised in the advertisement 318, a referral fee may be paid to the user 208. If an advertisement 318 is forwarded to a member of a social network by an audience member and the social network user ultimately purchases or uses the goods or services advertised in the advertisement 318, a referral fee may be paid to the user and the audience member. The referral fee paid to an audience member may be less than the referral fee paid to a user.

For the purpose of illustration and not limitation, an example application provides user driven advertising and future item creation follows: A user 208 may make a proposal to write a fictional book based on a recent gubernatorial race to a social network consisting of 1,000,000 audience members. The user 208 may then associate an advertisement 318 related to an LCD high-definition television with the proposal. The user may also provide an endorsement of the television, such as and without limitation, “This is the best LCD high-definition television I have ever seen. I own one myself!” The proposal, advertisement, and endorsement may be sent by e-mail to the audience members. If all 1,000,000 of the audience members view the future item proposition 304 and the associated advertisement 318, then 1,000,000 impressions 324 may be counted. These impressions 324 may count towards reaching a threshold for future item creation. These impressions 324 may also be valued in order to generate advertising revenue. For example and without limitation, impressions 324 may be valued at $11.50 per 1,000 impressions. Thus, the impressions 324 may generate $11,500 in advertising revenue. If 50% of the audience members click-through the advertisement 318, then 500,000 click-throughs may be counted. These click-throughs may be valued in order to generate advertising revenue. For example and without limitation, click-throughs may be valued at $50.00 per 1,000 click-throughs. Thus, the click-throughs may generate an additional $25,000 in advertising revenue. If 10% of the audience members purchase the advertised television, the user may be eligible to receive referral fees. Referrals may be valued at $2.00 per referral. Thus, the referrals may generate $200,000 in referral fees. Advertising revenue and referral fees may be generated regardless of whether the user 208 creates or becomes obligated to produce the item.

Continuing with the illustrative example of the preceding paragraph, the user 208 may become obligated to create the content when a sufficient number of advance forward rights and/or obligations are received—say, a threshold of 10,000 advance forward rights and/or obligations 304. Thus, the user's proposed book may be referred to as “contingent content” to indicate that the user's commitment or obligation to creating the content may be contingent upon something. If 0.5% of audience members who viewed the future item proposition 304 and the associated advertisement 318 actually obtain a forward right and/or obligation 328 for content, then 5,000 forward rights and/or obligations for the book may be counted. In this example, the threshold is 10,000 forward rights and/or obligations 328; therefore, the user may not be obligated to create the content, and the content may not proceed to production. However, the user 208 may elect to create the content even though the threshold is not reached. This election may or may not obligate holders of the forward rights and/or obligations to purchase the book once it is published. Furthermore, in some embodiments, impressions 324 may be valued as equivalent to a fraction—say,— 1/100—of a forward right and/or obligation 328. In other words, embodiments may include the circumstance that there is some chance that an impression 324 that does not result in a forward right and/or obligation 328 will nevertheless lead to a book sale later, if and when the book becomes available for sale. In this case, the 1,000,000 impressions 324 may be valued as 10,000 additional forward rights and/or obligations 328 or forward rights equivalents. With 5,000 actual forward rights plus 10,000 forward rights and/or obligations equivalents, the threshold of 10,000 forward rights and/or obligations is exceeded and the user 208 may be committed or obligated to produce the future item.

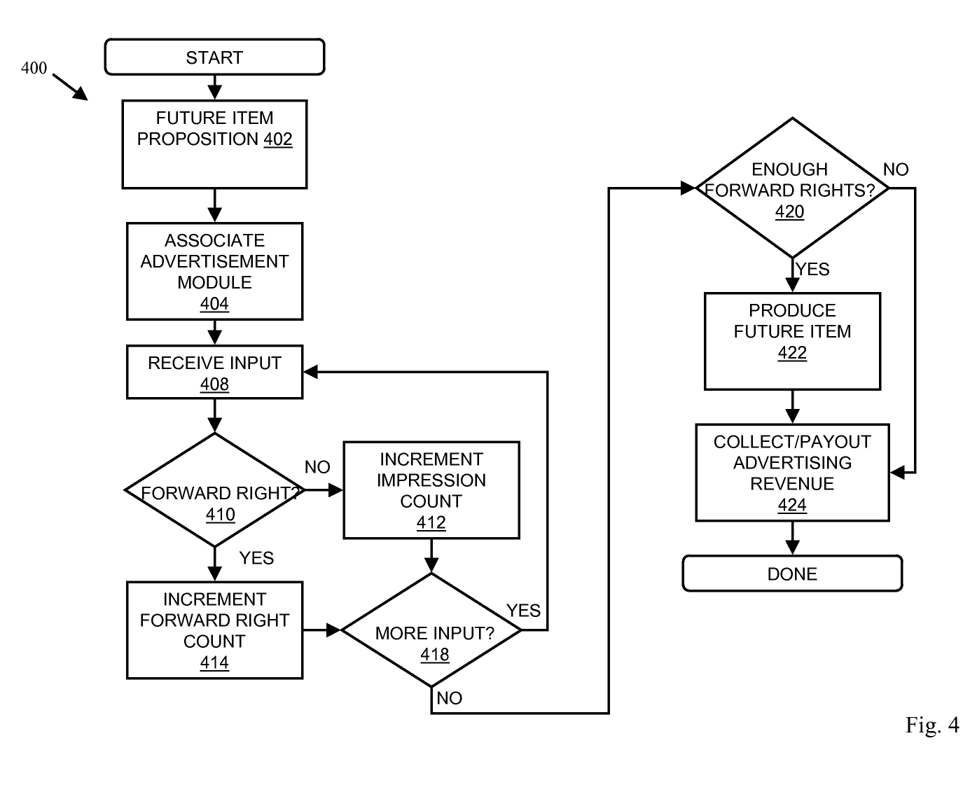

FIG. 4 may depict a process 400 for future item creation and user driven advertising. Starting at logical block 402, a future item proposition 304 may be made. Processing flow may continue to logical block 404, where an advertisement module 318 may be associated with the offer. Processing flow may continue to logical block 408, where an input may be received. As indicated by logical block 410, a test may determine whether or not forward rights and/or obligations 328 may be obtained. If the test result is negative, then forward rights and/or obligations have not been obtained, and therefore the input is counted as an impression 324 and the impression count is incremented, as shown by logical block 412. Processing flow may continue to logical block 418, where a test may determine if there is additional input. If the test at logical block 410 is positive, processing flow may continue to logical block 414b where the forward rights and/or obligations 328 count may be incremented. Processing flow then continues to logical block 418. If there is additional input, processing flow returns to logical block 408. If there is no additional input, processing flow continues to logical block 420, where a test may determine if enough forward rights and/or obligations 328 have been counted. If enough forward rights have been obtained, the future item may be produced 422. Processing flow may continue to logical block 424, where advertising revenue is collected or paid out. If enough forward rights and/or obligations 328 have not been obtained, processing flow may continue to logical block 424. In any case, logical flow may terminate upon reaching logical block 424.

Referring now to FIG. 5, an embodiment 500 of a trading marketplace 502 may include a host 660, the trading marketplace 502, algorithms 520 including pricing methods 654, a data facility 534 including the demand aggregation 332 and trade data 540, the application programming interface 342, the user interface 332, a social network 228, and the user 208.

Without limitation, the user 208 may include a consumer 542 and a producer 668.

The trading marketplace 502 may be hosted on the host 660. The host 660 may include algorithms 520 such as for pricing methods 654 and staging methods 524, interfaces such as a consumer user interface 330 and a producer user interface 330, and a data facility 534 such as for demand aggregation 322 and trade data 540.

The trade data 540 may, without limitation, include time, date, price, one or more identifiers associated with one or more parties to a trade, method of trade, any and all combinations of the foregoing, and so on. It will be understood that a variety of trade data 540 are possible.

The data facility 534 may include a database, file system, or the like that is suitable for storing any and all data associated with contingent event certificates 606.

Pricing methods 654 may be used to set a price for a forward right 640 or obligation 648 to a future item 624. Pricing methods 654 may be based on the marketplace. For example, the price may be set initially in a Dutch auction, such as by progressively lowering the price from a high starting point until a participant is willing to accept the price. In another example, the price of forward rights 640 for a future item may be established using pricing methods 654 that are based on power rankings. For example, the price of a forward rights 640 to an NFL game may be based on the power rankings of NFL teams. In another example, pricing of a forward right 640 or obligation 648 may be based on a previous forward market.

Pricing methods 654 may include setting the price based upon an external input. A user 208 may provide the external input. A remote system may provide the external input. The external input may be a manual input, an automatic input, or the like. Without limitation, the producer 668 may include this user and/or this remote system. Thus, the producer 668 may provide an external input to the pricing method 654, which may receive the external input and set the price accordingly. For example and without limitation, the producer 668 may specify, suggest, limit, or otherwise affect the price. It will be understood that various pricing methods 654 are possible.

The user interface 330 may include an aspect that supports consumer-related activities and an aspect that supports producer-related activities. The user 208 may access the user interface 330 via the web, e-mail, phone, wireless device, television, referrals, any and all of the service providers (220, 222, 224, 230), and the like. In some embodiments, the user 208 may be public, private, individuals, groups, and the like. It will be understood that a variety of user interface 330 aspects and embodiments are possible.

The producer 668 may be a rights holder, a manufacturer and/or retailer, the user 208, the future item provider 204, any and all combinations of the foregoing, or the like.

Users 208 may include groups, individuals, and the like. Users 208 may be affiliated with one another via the social network 228. Users 208 may communicate with the host 660 via the social network 228, the application programming interface 342, and/or the user interface 330.

The social network 228 may communication with the host 660 via the application programming interface 342 or the like.

Referring now to FIG. 5A, the trading marketplace 502 may include a contingent event certificate 606 including forward rights 640 and/or forward obligations 648, and a future item 624 including attributes and/or contingencies 514, the future item 624 relating to one or more of sports 572, travel 574, music 578, games 580, consumer products 582, books 584, and/or service 588.

The trading marketplace 502 may enable a consumer 542 or producer 668 to participate, through a host 660, in the acquisition or generation of a future item 624 and to obtain or offer forward rights 640 and/or forward obligations 648 associated with the future item 624 and, In some embodiments, wherein the forward right 640 and/or forward obligation 648 is associated with aggregation of sufficient demand for the future item 624. Throughout this disclosure and elsewhere, the phrase “forward obligation” may be used interchangeably with the phrase “future obligation.”

Contingent event certificates 606 may be provided in a trading marketplace 502.

Contingent event certificates 606 may be provided in a forward market, such as an offering of a contingent event certificate 606 to a wide audience of potential consumers 542 or producers 668. During a forward market, the future item 624 may be pre-sold.

Contingent event certificates 606 may be offered in a primary market, such as a determined right to a future item. During a primary market, a future item 624 may be built, produced, delivered, and the like.

Contingent event certificates 606 may be offered in a secondary market. During a secondary market, contingent event certificates 606 may be re-sold, traded, and the like.

A contingent event certificate 606 may be offered for future items 624, such as those related to sports 572, travel 574, music 578, games 580, consumer products 582, books 584, services 588, and the like.

A contingent event certificate 606 may be offered for a “dream” product, service, event, offering, and the like. For example, a user may want to see U2 play with The Police and will create a contingent event certificate 606 proposal for this event. The user 208 may ask others to vote on the proposal so that demand for the event may be gauged. If the contingency that the two artists play together is resolved, the user 208 may be rewarded with a contingent event certificate 606, may have an opportunity to purchases contingent event certificates 606 before others or at a lower cost, and the like. In some embodiments, the user may reap no additional benefits.

There may be attributes or contingencies 514 associated with the future item 624. For example, an attribute or contingency 514 of a contingent event certificate 606 may be that it is offered for a specific team in a sports 572 future item 624. In another example, an attribute of a contingent event certificate 606 may be that it is offered for a specific kind of future item 624, such as an event ticket, a book, a digital download, and the like. In another example, a contingency or attribute 514 of the contingent event certificate 606 may be its expiration after a certain date. In another example, a contingency or attribute 514 may be the location of the future item 624 associated with the contingent event certificate 606. In another example, the contingency or attribute 514 may be how a contingency may be resolved, such as due to an aspect of demand aggregation, the weather, a team standing, and the like. It will be understood that a variety of future items 624 are possible.

The attribute or contingency 514 may relate to who produces a future item 624, what the future item 624 is, when the future item 624 occurs or becomes available, where the future item 624 occurs or becomes available, how the future item 624 is provided, a condition or characteristic of the future item 624, any and all combinations of the foregoing, or the like. Many attributes or contingencies 514 are described herein and elsewhere. It will be understood that a variety of attributes or contingencies 514 are possible.

The contingent event certificate 606 may associate forward rights 640 and/or forward obligations 648 with the future item 624. Forward rights 640, for example, may be the right of a contingent event certificate 606 holder to purchase or obtain a future item 624, such as a consumer product, a consumer service, an event ticket, and the like. Forward obligations 648 may be an obligation on behalf of a contingent event certificate 606 holder to purchase or obtain a future item 624, such as a consumer contingent event certificate, a consumer service, an event ticket, and the like. In some embodiments, the contingent event certificate 606 may include a forward right 640, a forward obligation 648, or both. In any event, forward rights 640 and forward obligations 648 associated with a future item 624 may be contingent on an occurrence or outcome, such as the aggregation of sufficient demand for the future item 624.

In some embodiments, forward rights 640 and forward obligations 648 associated with a future item 624 may not be contingent on an occurrence or outcome, such as for a determined right to a future item 624. For example, a retailer of an extremely popular gaming system may offer consumers 542 or producers 668 of the trading marketplace 502 the opportunity to reserve the second generation of the gaming system prior to its eagerly anticipated release. In this case, the contingent event certificate 606 offers the contingent event certificate holder the forward right 640 to purchase the gaming system once it is released without having to worry about the demand and supply issues that would certainly plague conventional consumers of the high-demand gaming system. The retailer may or may not additionally associate a future obligation 648 to purchase with the forward right 640. In this example, there may not be a contingency associated with the future item 624 other than the actual product launch, as the item may already be in development and there may already be plans to retail the item. In some embodiments, a future obligation 648 may be associated with a future item 624, such as a future purchase obligation, even if the value of the future item 624 is not yet known. For example, there may be a different value/price for a future item 624 offered to an early adopter, such as a participant in a pre-forward market, versus the price offered to a late adopter, such as a participant in a forward market. In such a scenario, as well as in others that can be readily appreciated by one skilled in the art, the lack of a value during the forward market may serve as an incentive for early adoption.

Forward rights 640 may be one-sided or two-sided. For example, a forward right 640 may be granted to a contingent event certificate holder to purchase the second generation of a gaming system from a retailer. The forward right 640 is one-sided, as only the contingent event certificate holder has rights and the retailer must provide the second generation gaming system for purchase to the contingent event certificate holder.

A forward right 640 may also be granted as a two-sided right. The two-sided right may be a combination of two forward rights 640 into a single instrument. Unlike a one-sided right that provides a right to one party and an obligation to another party, the two-sided right may provide both a right and an obligation to each of two parties. For example and without limitation, a retailer may grant to a consumer 542 a two-sided forward right 640. The two-sided forward right 640 may provide the consumer 542 with the right to purchase an item and the retailer with the obligation to sell the item; plus the two-sided forward right 640 may provide the retailer with the right to survey the consumer and the consumer with the obligation to answer the survey. Instantiation of one right/obligation pair may be contingent upon exercising the other right/obligation pair. Continuing the example, the retailer's right to ask survey the consumer may be contingent upon the consumer exercising his right to purchase the item. It will be understood that various embodiments and applications of two-sided forward rights are possible.

Forward rights 640 may be long or short. For example, an offeror of a contingent event certificate 606 may have access to the future item 624, such as by owning it, being a distributor or retailer, being the producer, and the like. Thus, the offeror may have a long position in the future item 624. In some embodiments, the offeror may have a short position in a future item 624, such as when he does not have access to the future item 624 and is simply taking advantage of the opportunity that a contingency 514 may not be met so that the contingent event certificate 606 will vest or mature and he will not have to fulfill the contingent event certificate 606 by providing the future item 624. In any event, the offeror may be obligated to provide the future item 624 regardless of whether the offeror had access to the future item 624 at the time of offering forward rights 640 to the future item 624.

Forward rights 640 and/or forward obligations 648 may be paid, earned, not paid, and the like. For example, consumers 542 or producers 668 may participate in a loyalty program with a retailer that may allow them to earn points towards a forward right 640 and/or obligation 648. In the example, consumers 542 or producers 668 may earn points by obtaining a credit or charge card with the retailer, making purchases from the retailer, making accessory purchases directly related to a future item 624, and the like.

Referring now to FIG. 6, an advertisement or promotion 602, further described in Harmon 3 and/or Cella and/or elsewhere, may include any form of advertisement or promotion 602. For example, in embodiments, credits from music downloads may be used for promotional programs such as a sponsor program. Rather than access rights depending on being at the front of the line or getting through on the phone at Ticketmaster, access may be earned, such as through a loyalty program. The advertisement or promotion 602 may alternatively or additionally be described in Cella and elsewhere. Thus, in another embodiment, knowing that a skier might arrive based on a weather contingency, a vendor could target advertising for a host of related products and services, even if the skier doesn't end up purchasing the package.

An alternative right/benefit 604, as further disclosed in Harmon 3 and elsewhere, may include a wide range of alternative benefits, such as when users accumulate credits that can be applied toward a purchase of a product or toward purchase of a ticket or entry to an event if it were to be certain. The alternative right/benefit 604 may result from, be provided by, and/or be associated with the contingent event certificate/rights marketplace 682.

The contingent aspect 608 of a contingent event certificate 606 may, without limitation, be described within or throughout any and all of the documents included herein. In any and all instances, the phrase contingent event certificate may refer to a contingent event certificate or right.

This contingency may be associated with a sports team 610, as described in Cella and elsewhere. For example, among many possibilities, options could be made exercisable based only on the presence of a buyer's designated team in the Super Bowl. A contingency may be associated with a player 621. For example, a fan could purchase a right for a ticket to a particular game if that player was to appear in the game. This contingency may be associated with a venue 614, as described in Harmon 6 and elsewhere. For example, contingent event certificates for various events may in the future be scheduled to take place at a designated venue 614. A contingency may be associated with a location 618, as described in Harmon 3 and elsewhere. For example, a band may or may not decide to perform in a given town (that is, rights may be for a specific music event in a given town). A contingency may be associated with weather 620. For example, vendors may offer the same item to different individuals, depending on different tastes for weather-related goods and services. A ski package could be contingent on the presence of snow, for example. In another example, a user may purchase a contingent event certificate for travel contingent upon weather wherein the contingency is if there is snow, the travel is to a ski resort and if there is rain or insufficient snow, travel is to a beach. A contingency may be associated with demand 622 for a future item, as described in Harmon 1, Cella, and elsewhere. For example, a toy manufacturer may create contingent event certificates 606 for several different lines of toys. Based on demand 622 as determined at least by the number of contingent event certificates 606 sold on a primary market, the toys may be released in time for the holidays. The toy manufacturer may decide to produce certain toys in different quantities (or not at all) based on the demonstrated demand levels. Alternatively, the toy manufacturer may issue a limited number of contingent event certificates 606 for the toys that would entitle and obligate a holder of the contingent event certificate 606 to purchase a first production run of the toy. In this way, the holder of a contingent event certificate 606 would be assured to be able to purchase the toy at a fixed price if the toy is produced. In addition, the toy manufacturer can size the first production run appropriately to ensure that every contingent event certificate 606 holder can purchase the toy.

The future item aspect 624 of a contingent event certificate 606 may, without limitation, be described within or throughout any and all of the documents included herein. The future item 624 may be associated with sports 628, as described in Harmon 6 and/or Harmon 1 and/or elsewhere. Contingent event certificates 606 may be for various events, such as sporting events. In some embodiments, sports fans may themselves be allowed to define a market. For example, a fan may want to see Manchester United play the Spanish National team in the new Miami stadium in 2007. Once this new market is created, a plurality of sports fans (that is, consumers) may purchase the initial allotment and/or trade the contingent event certificates 606. Alternatively or additionally, the future item 624 may be associated with particular contingent combinations associated with sports 628, as described throughout Cella and elsewhere. For example, the participant-event for which an options or futures contract for tickets and/or accommodations may be purchased may be team-game, team-round, or team-round-game.

The future item 624 may be associated with music 630, as described in Harmon 3 and elsewhere. For example, advanced music access rights may be created for any unique, recurring, or one-time event where the possibility of the event occurring is not assured. Concerts, festivals, operas and any other type of domestic or international music or entertainment events may be contingent events. The future item 624 may be associated with travel 632, as described in Cella and elsewhere. For example, a buyer could purchase an option to purchase a vacation package to a Caribbean island, contingent on the absence of any hurricanes in the Atlantic Ocean one week before the date of departure.

The future item 624 may be associated with an accommodation, as described in Cella and elsewhere. For example, a buyer could purchase an option of having a hotel room in a particular city contingent on a particular event occurring in that city, such as a concert, playoff game, political convention, and the like. In another example, a buyer could purchase the option of having a restaurant reservation at a 4-star restaurant contingent upon an event occurring near the restaurant, such as a sporting event, concert, convention, and the like. The future item 624 may be associated with transportation, as described in Cella and elsewhere. For example, a buyer may purchase the option of a flight to a city contingent upon an event occurring in the city, such as a sporting event, concert, convention, and the like. Transportation may include flights, chartered flights, chauffeured limousines, rental cars, trains, buses, yachts, and the like.

The future item 624 may be associated with a product launch 634, as described in Harmon 1 and elsewhere. For example, a product designer may have a concept for a new type of home appliance. The product designer may offer contingent event certificates 606 that both entitle and obligate the holder to purchase the home appliance. Through promotion of the appliance, demand 622 may be generated based on a description, virtual model, prototype, review, et cetera, of the home appliance. The promotion may include information about the offered contingent event certificates 606. The demand 622 resulting from both direct and indirect promotion of the appliance may be assessed by a count of contingent event certificates 606 sold on the pre-primary market. The product designer may use the demand measure to establish contingent agreements for production, distribution, sales, advertising, and support of the appliance. Production may commence once and only if demand 622 reaches a minimum level that may be selected to reduce or eliminate the risk of financial failure. While this example is for a home appliance, the product launch could be for any type of product or service. It will be appreciated that contingent event certificates 606 offered through a pre-primary market can be used to assess the viability of any and all new products or service creations.

Time may elapse between each of the following steps: offering the contingent event certificates 606, reaching the minimum level of demand 622, producing the future item 624, and shipping the future item 624 (if applicable).

The contingent event certificate 606 may mature more or less when the future item 624 becomes available or unavailable, as described in Cella and elsewhere. For example, the contingent event certificate 606 may mature more or less upon producing or shipping the future item 624; more or less upon canceling production or canceling shipment of the future item 624; or the like. At that time, a consumer 542 holding the contingent event certificate 606 may be compelled to purchase the future item 624.

When acquiring the contingent event certificate 606, the consumer 542 may provide information relating to his credit card or other payment method. When the contingent event certificate 606 matures due to availability of the future item 624, this information may be used to charge the consumer's credit card or exercise the other payment method for purchasing the future item 624. When the contingent event certificate 606 matures due to unavailability of the future item 624, this information may be used to issue a credit or refund to the consumer's credit card or other payment method. It will be understood that various systems and methods for receiving, storing, and later retrieving and using the information are possible.

The certificate 606 aspect of a contingent event certificate 606 may, without limitation, be described within or throughout any and all of the documents included herein. The certificate 606 may be associated with forward rights 640, as described in Cella and elsewhere. For example, disclosed herein is a system for allowing a remote user 208 to purchase, over a distributed computer network (e.g., the Internet), an option to purchase a ticket, goods or services, or other item that is based on a contingent event. The certificate 606 may be associated with a reward 642, as described in Harmon 2 and elsewhere. For example, in one embodiment, businesses can reward employees with contingent event certificates 606 if a set standard or goal is achieved. It will be appreciated that a certificate 606 may be tradable (or non-tradable) 605, refundable, purchasable, and so on. It will also be appreciated that a certificate may encompass rights, obligations, and/or the like 648. The rights and/or obligations that the certificate 606 encompasses may mature, vest, convert, expire, et cetera. For example and without limitation, the rights and/or obligations may vest as a reward 642 that occurs in response to an occurrence of a predetermined event. The certificate 606 may encompass associated access 644 to something, as described in Harmon 1 and elsewhere. For example, each contingent event certificate 606 may correspond to a particular seat within a venue 614. In the case of a personal seat license (PSL), a typical PSL grants the licensee the right to purchase season tickets for a particular seat in the venue 614 every season. A contingent access rights exchange provides a mechanism whereby individuals holding inventory in the form of PSLs may post offers to sell some or all of their holdings, such as subject to a contingency. In other embodiments, travel or ski packages (travel, hotel, lift tickets, et cetera) for spring skiing trips may be optioned.

Harmon 1 relates to a market for trading PSLs, individual event tickets, and contingent event certificates for various events, such as sporting events, concerts, and the like, which are scheduled to take place, or may in the future be scheduled to take place at a designated venue. Embodiments may include both a method of trading such products and an electronic exchange for facilitating such trades.

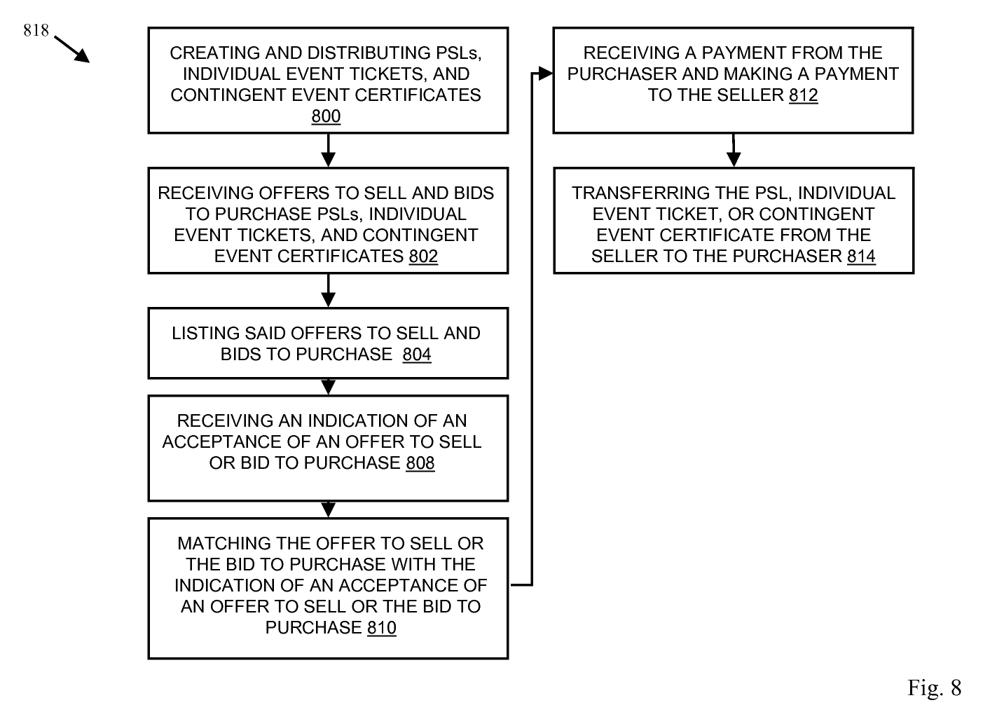

Referring now to FIG. 8, a method 818 is disclosed for trading PSLs, event tickets, and contingent event certificates. Step 800 calls for creating and distributing an inventory of PSLs, individual event tickets, and contingent event certificates. Contingent event certificates are a novel product. A contingent event certificate represents the right and obligation to purchase an event ticket at face value for an event that may (or may not) be scheduled in the future. In some embodiments, whoever is the holder of record of a contingent event certificate when the contingent event is scheduled and tickets for the event go on sale is automatically billed for the face value of the ticket. If the contingent event certificate holder has agreed to pay by credit card, the designated credit card account is automatically charged. In order to facilitate electronic trading of PSLs, event tickets, and contingent event certificates, it is preferred that the initial distribution of tickets and contingent event certificates is performed electronically, so that a database may be maintained of all tickets and contingent event certificates in the inventory, the current owner of each ticket or contingent event certificate, and an audit trail of all previous owners going back to the ticket's or contingent event ticket's creation. Also in the interest of facilitating electronic trading of PSLs, event tickets, and contingent event certificates and maintaining accurate ownership records of such products, it is further preferred that only tickets associated with PSLs are traded on the exchange.

Since each PSL, ticket, and contingent event certificate corresponds to a particular seat within a venue, it is possible to group PSLs, tickets, and contingent event certificates into zones or sections having similar viewing characteristics. A person using the present inventive method or electronic exchange to purchase a ticket may specify a zone in which he or she wishes to purchase a ticket. A ticket for any seat within the specified zone will satisfy a purchase request for a ticket within the specified zone.

Once the PSL, ticket, and contingent event certificate inventory have been distributed, step 802 involves receiving offers to sell and bids to purchase PSLs, event tickets, and contingent event certificates. In embodiments, transactions are settled in real time. Only the actual holders of inventory (PSLs, tickets, and contingent event certificates) can place offers for sale, while any member of the exchange can place bids to purchase. However, other trading rules are possible where a party not holding inventory may be allowed to offer PSLs, tickets, or contingent event certificates for sale as long as he or she makes good delivery of the sold products at a specified time and in a specified manner.

Step 804 calls for listing the received offers to sell and bids to purchase inventory. In order to limit confusion and increase the efficiency of the market, not every offer and bid need be displayed. For example, the current market rate for PSLs, tickets, or contingent event certificates may be quickly surmised from the best bid and best offer for a particular zone. The most recent transaction for a PSL, ticket or contingent ticket in a given zone may also give further guidance as to the current market price.

Step 808 involves receiving an indication either from a purchaser indicating that he accepts one of the listed offers to sell, or from a seller indicating that he accepts one of the listed bids to purchase. The party who posted the accepted bid or offer is matched to the party who indicated an acceptance of the bid or offer in step 810. A payment is received from the purchaser, and a payment is made to the seller in step 812. Finally, the inventory that is the subject of the transaction, be it a PSL, an individual event ticket (or tickets), or a contingent event certificate (or certificates), is transferred from the seller to the purchaser in step 814.

In addition to the method of trading PSLs, individual event tickets, and contingent event tickets just described, embodiments may include an exchange for trading PSLs, event tickets, and contingent event certificates according to the method just described. Without limitation, the exchange may include the contingent events rights exchange 232, trading marketplace 502, and/or contingent event certificate or rights market 682.

Buyers may post bids to purchase inventory on the exchange. Typically, such a posting would include a description of the inventory the buyer wishes to purchase and the amount the buyer is offering to pay. For example, a buyer may post a bid for four zone 18 tickets for an August 10 doubleheader, offering to pay $20.00 per ticket. The seller's offer to sell the tickets at $40.00 and the buyer's bid to purchase the tickets at $20.00 are listed on the exchange and are visible to all participants in the exchange, both buyers and seller. Thus, a market price is established somewhere between $20.00 and $40.00 per ticket for a set of four tickets in zone 18 for the August 10 doubleheader between Team A and Team B.

In addition to listing their inventory for sale at a specific price above the current market price, sellers may alternatively chose to accept a buyer's bid to purchase tickets at the buyer's bid price. For example, if a seller sees a buyer's $20.00 bid and decides that it is close enough to what he is willing to accept for the tickets, the seller may accept the offer. Of course, other sellers who may also have inventory equivalent to that being offered by the first seller (i.e., four tickets in zone 18 for the August 10 doubleheader between Team A and Team B), may undercut the first seller's original $40.00 offering price by either offering to sell their inventory at a lower price, or by accepting a buyer's lower bid price.

Similarly, buyers may place bids to purchase tickets at prices below those currently offered by the sellers, or buyers may accept sellers' listed offers. If a buyer sees a seller's $40.00 per ticket offer and decides that her or she is willing to pay that amount to attend the event, the buyer may accept the seller's offer. Of course, other buyers may also want to attend the August 10 doubleheader and beat the first buyer to the punch by either accepting the first seller's $40.00 per ticket offer, or by posting a bid for four zone 18 tickets at a price higher than the $20.00 per ticket offered by the first buyer.

Once an offer or bid is accepted the exchange matches the buyer with the seller. Preferably this function is opaque to the parties using the exchange. The buyer and seller deal only with the exchange, never directly with one another. The exchange receives a payment from the purchaser in at least the amount agreed upon in the transaction (an additional transaction servicing fee may also be required to support the exchange). Likewise, the exchange may make payment to the seller in an amount up to the price agreed upon the transaction. (Again, a transaction servicing fee may be required, and the seller's payment reduced accordingly.) To complete the transaction, the inventory being sold must be delivered from the seller to the exchange and from the exchange to the purchaser.

As will be described more fully below, an embodiment of an exchange may be completely electronic. PSLs, event tickets, and contingent event certificates along with ownership records, and the records of exchange participants, and provisions for making and receiving payment are all stored on a database. In this embodiment, the act of physically delivering the inventory from the seller to the exchange and from the exchange to the purchaser is not required. Nor are the steps on making and receiving payments. Instead, the ownership records of the inventory records are changed to reflect the new owner, and credit card accounts may be charged for payment and credited for sales.

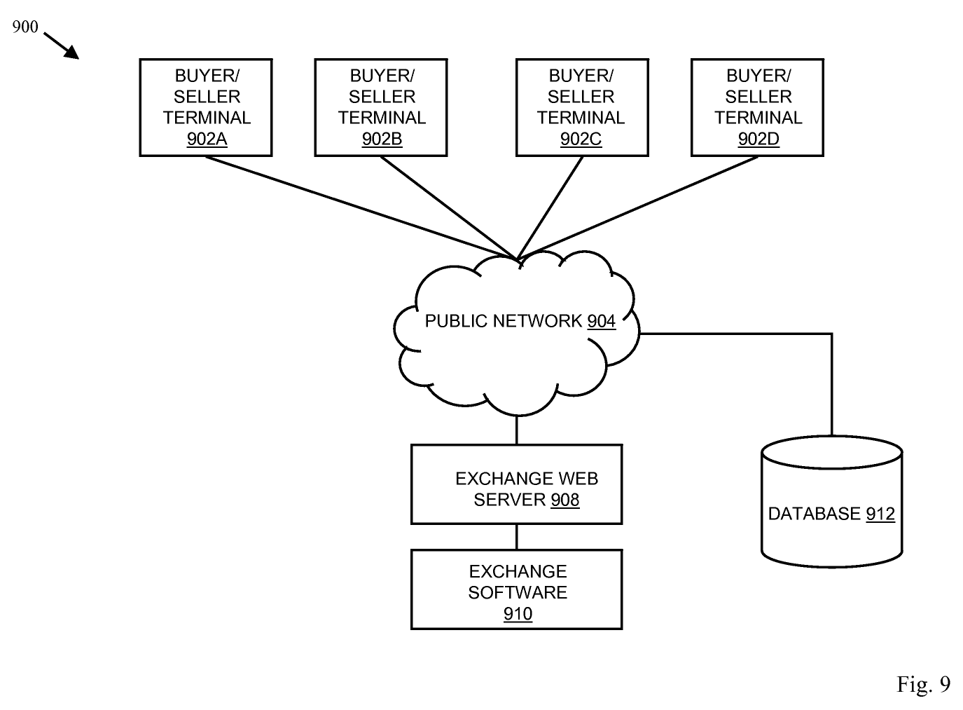

FIG. 9 shows a block diagram of a network-based exchange 900 for trading PSLs, individual event tickets, and contingent event certificates. The exchange 900 includes a number of user terminals 902a, 920b, 902c . . . 902n linked to a ticket exchange web server 908 via a public network 904 such as and without limitation the Internet. The web server 908, in addition to being connected to public network 904, is functionally connected to exchange software 910 for matching offers and bids with indications of accepting offers and bids, and a database 912, which maintain records of PSLs, tickets and contingent event certificates, who owns them, and how they are traded.

In some embodiments, only tickets associated with PSLs may be traded on the network-based exchange 900. In this embodiment, the tickets associated with the PSLs may exist wholly in the virtual exchange environment. When an individual purchases a PSL (preferably through the exchange after having registered with the exchange), a record is created in the database 912. If the PSL is not purchased through the exchange, a record of the PSL must be created and stored in the exchange database. When the licensee purchases his or her season tickets each season according to his or her rights under the PSL, the database is updated to reflect this additional inventory. Each individual ticket for each scheduled event is represented in the database, and a record of its current owner (initially the PSL licensee) is also stored.

Individuals who do not own PSLs, but who are interested in purchasing tickets on the exchange must first register with the exchange. A database record is created for each registered member of the exchange. As registered customers and inventory holders make purchases and sales, their records are updated to reflect their newly acquired or depleted inventory. Furthermore, a record of each transaction is recorded each time inventory changes hands. Thus, each PSL, event ticket, or contingent event certificate will have a complete audit history associated with it, so that each owner and each transaction can be identified at a later time. Like PSL owners, customers who have purchased inventory on the exchange may also trade their holdings. Thus, a “ticket” may change hands (virtually) several times before it is finally printed and used to gain access to an event.

Contingent event certificates may be treated in a similar manner, or they can be distributed entirely independently of PSLs. In a first alternative, contingent event certificates are created with the season ticket packages purchased by the PSL licensees each season. Thus, in the arrangement the PSL owner is the owner of record for all contingent event certificates associated with the licensed seat at the beginning of each season. For example, a PSL licensee having a license to purchase season tickets for a baseball team's home games would also obtain 11 contingent event certificates, three for the Divisional Playoff series games (assuming a best of 5 series), four for the League Championship series, and four for the World Series, assuming a best of 7 format for the league championship series and world series. These are the maximum number of possible post-season home games if the team enjoys home field advantage in each series and each series extends to the maximum number of games. Of course, the actual number of contingent events scheduled at the team's home venue may actually be much less than 11 depending on the team's performance.

Another alternative for initial distribution of contingent event certificates is to offer PSL licensees a right of first refusal to purchase contingent event certificates. If the PSL licensee does not exercise his or her right to purchase the corresponding contingent event certificates, they may be offered for sale to the highest bidders in an on-line auction conducted on the exchange 900.

Finally, contingent event certificates may be offered directly to all registered members of the exchange 900. According to this alternative, contingent event certificate are offered in an open auction. Bidding may be scheduled for a set period of time and the member offering the highest bid at the close of bidding is awarded the contingent event certificate for which he or she is bidding in exchange for the winning bid price.

A note should be made here regarding the payment mechanisms for contingent event certificates. Obviously, if the contingent event certificates are included in the season ticket packages of PSL licensees, the PSL licensee may be charged for the contingent event certificates when he pays for his season tickets. The same is true if the PSL licensees are offered a right of first refusal to purchase the contingent event certificates. In the open auction model, however, since members of the exchange may be required to submit a valid credit card number to join the exchange, the credit card account of the highest bidder may be automatically charged the bid amount immediately upon the close of bidding. The purchasing member's inventory record may then be updated to reflect the newly purchase contingent event certificate.

A similar automatic credit card transaction can be established to take place when contingent event certificates mature into actual event tickets, such as when a team becomes eligible for post-season play. Typically an announcement will be made as to when post-season event tickets (playoff or championship series games and the like) will go on sale. This date, or some other arbitrary date, can be established as the date on which contingent event certificates for a contingent event which is subsequently scheduled mature into actual event tickets for the newly scheduled event. Whoever is the holder of a contingent event certificate on the specified date is charged the face value of the newly scheduled event ticket. Likewise, the inventory record of the owner of the contingent event certificate will be updated to reflect that he or she then owns an actual event ticket rather than a contingent event certificate.

Referring again to FIGS. 5, 5A, and 6, the certificate 606 may be associated with a right and obligation 648, as described in Cella and elsewhere. For example, a contingent event certificate 606 may represent the right and obligation to purchase an event ticket at face value for an event that may (or may not) be scheduled in the future. The certificate 606 may be tradable 650, as described in Harmon 1 and elsewhere. The certificate 606 may be digital 652, as respectively described in Harmon 6, Harmon 1, and elsewhere.

Pricing 654 that is associated with a contingent event certificate 606 may, without limitation, be described within or throughout any and all of the documents included herein. At least one example of this is provided in Harmon 1 and elsewhere, where it is noted that the current market rate for contingent event certificates 606 may be quickly surmised from the best bid and best offer for a particular zone of a ballpark.

A contingent event certificate (or rights) market 682 may be associated with a platform 658, which may, without limitation, be described within or throughout any and all of the documents included herein. The platform 658 may be associated with a host 660. The platform 658 may be associated with fulfillment 662, which may be electronic (as described hereinabove with reference to a digital 652 certificate 606) or physical.

Participants 600 may include providers or suppliers 664, such as and without limitation producers 668, as generally described in Cella and elsewhere. For example, a merchant supplier may be the party that offers to produce a particular consumer product in the event a demand threshold is obtained through the sale of forward rights.

Participants 600 may include related/integrated markets 670, which may be described within or throughout any and all of the documents included herein. The markets 670 may include a secondary contingent event certificates or rights market 672. For example, in some embodiments, a neutral third party may centralize market-related data and provide a marketplace where access rights can be liquid. Embodiments may include an exchange for trading contingent event certificates 232. In some embodiments, the one market provider may serve as an application service provider (ASP) to another market. Thus, a user may see a seamless integration of markets at the level of the user interface, but on the back end, the ASP may be providing and/or controlling a portion of the market.

The contingent event certificates/rights market 682 may hold an inventory of items being traded. The items being traded may be intangible items such as contingent event certificates 606.

The related/integrated markets 670 may include a rights market 674, as described in Harmon 3 and elsewhere. For example, credits may convert to a ticket or “full forward” right that is liquid and tradable on the rights market 674. Since full rights can be traded, a market could be run well in advance of the anticipated future item.

The related/integrated markets 670 may include a rights resale market 678, as respectively described in Cella and elsewhere. For example, once a PSL, ticket, or contingent event certificate inventory has been distributed, embodiments may receive offers to sell and bids to purchase PSLs, event tickets and, contingent event certificates.

In embodiments, transactions are settled in real time. In some embodiments, the related/integrated markets 670 may hold the inventory of items being traded. The items being traded may be intangible items such as event tickets, or simply access rights.

The related/integrated markets 670 may be associated with a contingent event certificate/rights market 682, such as involving a method for trading contingent event certificates 606. For example, the rights market 682 may be for trading forward rights instruments, such as contingent event certificates 606, that carry with them future attributes such as forward obligations. It will be understood that a variety of related/integrated markets 670 are possible.

The platform 658 may be associated with a user interface 619 for communication with consumers.

A contingent event certificate 606 may be combined 688 with one or more other contingent event certificates 606s in a contingent event market platform. Combining 688 contingent event certificates 606s may facilitate providing access to a future item for a plurality of contingent event certificate 606 holders. A combination of contingent event certificates 606s may facilitate improving the chances that a holder of the combined contingent event certificates 606s will remain obligated to exercise one of the contingent event certificates 606s. Contingent event certificates 606s may be combined 688 such that a failure of one contingent event certificate 606 may be the contingency required for a second contingent event certificate 606 to mature.

Contingent event certificates 606s may be combined 688 such that the holder or holders of the combined contingent event certificates 606s may exchange the certificate at a reduced cost. This may be compared to purchasing a single ticket versus purchasing a “group rate” quantity of tickets. The single ticket may be more costly than one of the group rate tickets because the purchaser of the group rate ticket is obligated to purchase a minimum number of tickets. Contingent event certificates 606s may be combined 688 to form a group that may qualify for a group rate cost. To illustrate this, an exercise cost for a single mature (contingency met) contingent event certificate 606 may be $100, whereas a combination of contingent event certificates 606s may result in a cost to exercise each contingent event certificate 606 in the combination that may be $85. The contingencies for each contingent event certificate 606 in the combination may be the same, such that all of the combined contingent event certificates 606s mature together.

Contingent event certificates 606s may be combined to facilitate improving the chances that at least one of the combined contingent event certificates 606s will mature and be exercised. This may be beneficial to a holder of combined contingent event certificates 606s who wishes to improve the likelihood of attending an event, obtaining a consumer product, being offered a service, and the like. While the future item may be the same for each combined contingent event certificate 606, the contingencies may be different. A combination of contingent event certificates 606s may cover a plurality of contingencies such that if any of the contingencies is met, the holder may exercise the mature contingent event certificate 606. For example, a combination of contingent event certificates 606s may cover an event that is contingent upon weather conditions, such as an outdoor concert. The combination may include a contingent event certificate 606 that is contingent upon clear weather, another may be contingent on rain, and yet another may be contingent upon snow. The contingent event certificate 606 contingent on clear weather may include an open-air lawn seat. The contingent event certificate 606 contingent on rain may include a seat in a covered pavilion; and the contingent event certificate 606 contingent on snow may include an indoor seat in a heated building. This combination provides a variety of contingencies for one event.

The cost to exercise and/or the number of contingent event certificates 606s available for each of the contingencies may be different. For example and without limitation, the venue 614 may include X number of indoor seats each with an exercise price of $100, 4× pavilion seats each with an exercise price of $85, and 10× open air lawn seats each with an exercise price of $40.

A combination of contingent event certificates 606s may be associated such that the failure to mature of one of the contingent event certificates 606s in the combination becomes a contingency for another contingent event certificate 606 in the combination to mature. This allows a market maker of contingent event certificates 606s for a future item to manage the total number of contingent event certificates 606s to mature such that this number does not exceed the number of available seats. In our example the combination contingent event certificate 606 that is contingent on rain will not mature if the weather is clear, thereby only allowing the contingent event certificate 606 contingent on clear weather to mature. The holder of this combination contingent event certificate 606 may be obligated to purchase the open-air lawn seat.

An alternative combination of contingent event certificates 606s may facilitate a holder of the combination to attend one of two or more contingent events. As an example, a combination of contingent event certificates 606s for a Major League baseball playoff game may include a contingency based on the venue 614 in which the game is played. Continuing the example, a contingency for two contingent event certificates 606s may be that a team, such as the Mets, participates in the playoff game. The first contingent event certificate 606 in the combination may also include a contingency that the game be played in the Mets home stadium, whereas the second contingent event certificate 606 in the combination may include a contingency that the game be played in the opponent's home stadium. A similar combination may include a first contingent event certificate 606 of the combination on the Mets playing the playoff game at home and the second contingent event certificate 606 of the combination may include a contingency that another team (the Yankees) plays in the playoff game at home. This combination may allow a holder to exercise only one of the combined contingent event certificates 606s. The Yankees playoff game contingent event certificate 606 would not mature if the Mets playoff game contingent event certificate 606 matures. Many other such examples and combinations will be appreciated and all such examples are within the scope of the present disclosure.

An offering related to a contingent event certificate 606 may include disclosure of information 690 about the related offer only if the contingency matures. Withholding the information 690 about the related offer may facilitate increased flexibility of the provider of the related offer in fulfilling the related offer for a mature contingent event certificate 606. An example includes an offer for hotel accommodations related to a contingent event certificate 606. The related offering information 690 available prior to the contingent event certificate 606 maturing may be limited to a class of hotel, a geographic area, and the like. Upon maturing, the related offer provider may determine a specific hotel based at least in part on an aspect of an agreement to provide lodging the provider has made with one or more hotels in the class or geographic area.

A related offering may include a secondary contingency that must be met in addition to the contingent event certificate 606 contingency. As an example, the contingent event certificate 606 contingency may include a seat at a Mets home playoff game. The related offering may include a contingency that depends upon the holder of the mature contingent event certificate 606 providing information 690 such as personal information and/or demographics to the related offer provider to receive the related offering. It will be understood that a wide variety of information 690 is possible.

A contingent event certificate 606 may be combined 692 with other rights. The other rights may be associated with a future item. The other rights may be related in time with the future item. The other rights may facilitate the holder of the mature contingent event certificate 606 accessing a future item. In the example of an event, the rights may include one or more of parking privileges, transportation to the venue city, transportation to the venue, transportation to a hotel in the venue city, or transportation mode among two or more locations associated with the venue 614. The rights may include use of venue facilities, admittance to event-associated parties, social network events, meet-and-greet with the participants of the event, and so on. The rights may include goods and services such as items associated with the event. The contingent event certificate 606 may be combined with rights related to lodging. For example, a holder of a mature contingent event certificate 606 may, in addition to purchasing a seat at the contingent event, may also purchase a hotel room near the venue 614 at a predetermined price (such as a discounted price).

The contingent event certificate 606 may be combined 692 with other rights such as the right to sell the contingent event certificate 606 before or after maturing. The contingent event certificate 606 may be combined 692 with rights to purchase other contingent event certificates 606s at a predetermined price. For example, a holder of a contingent event certificate 606 for a next generation gaming system may gain the right, if the contingent event certificate 606 matures, to purchase a contingent event certificate 606 for a sequel to a video game compatible with the next generation gaming system at a predetermined price. In another example, a holder of a contingent event certificate 606 for a first-round NBA playoff game may, if the contingent event certificate 606 matures, gain the right to purchase a second-round NBA playoff game contingent event certificate 606 at a predetermined price. Many other such combinations 692 of a contingent certificate or right with another right will be appreciated and all such examples are within the scope of the present disclosure.

A contingent event certificate 606 may obligate the holder to make a purchase at a future time 694, perhaps when the contingent event certificate 606 matures. A contingent event certificate 606 may mature at a time 694 when the contingency associated with the contingent event certificate 606 is met such that it is no longer contingent. In effect, a contingent event certificate 606 becomes an event certificate when the contingency is no longer in question. In an example, a future item may include a seat at a second-round NBA playoff game. The contingency may include a specific team, such as the Boston Celtics, participating in the game. A contingent event certificate 606 for this contingent event may be sold or traded anytime up until the event. However, the contingent event certificate 606 remains contingent until it is known with absolute certainty that the Boston Celtics will participate in the second-round NBA playoff game. At some time 694, it may be determined that the Celtics have satisfied the requirements established by the NBA to participate in the game. Specifically this may include having a win-loss record that is better relative to at least some other teams. When the Celtics have met all the criteria as defined by NBA, the contingent event certificate 606 may mature and be known as an event certificate or ticket. However, the contingent event certificate 606 may expire when the Celtics are not able to participate in the second-round playoff game.

A contingent event certificate 606 may be contingent upon an aspect of a sporting event. For example, a contingency of a contingent event certificate 606 may be that a particular player joins a team, a particular team plays in a specific city, a team makes the Wild Card slot, and the like.

A contingent event certificate 606 may be contingent upon the timing 694 of an event. For example and without limitation, two contingent event certificates 606s may be issued as rain checks for a rained-out baseball game before the rain date has been set. Both may be contingent upon the timing 694 of the game on the rain date, with one certificate or right maturing if the rain date is set for a day game and the other maturing if the rain date is set for a night game. Similarly, the timing 694 may relate to whether the rain date is a weekday, weekend, holiday, and so forth. Many other such examples of timing 694 will be appreciated and all such examples are within the scope of the present disclosure.

A contingent event certificate 606 may be associated with an advertisement 602. The holder of the certificate or right may be entitled to view, receive, produce, transmit, et cetera, an advertisement 602 if and when a contingency becomes defined. For example and without limitation, two advertisers may each purchase a contingent right for a television-advertising slot. The first advertiser may be interested in advertising sunglasses when the forecast is for sunny weather. The second advertiser may be interested in advertising goulashes when the forecast is for rainy weather. The advertisers may purchase the contingent rights in advance of the forecast being known for the time of the slot. When the weather forecast becomes known, one of the rights may mature and the other may expire, depending upon forecast and the contingent right. Many other such examples related to advertising 602 will be appreciated and all such examples are within the scope of the present disclosure.

A future item 624 may alternatively be associated with a publication 601, which may without limitation advertise or otherwise promote the future item 624. The future item 624 may be associated with the publication 601 of one or more publications. The contingent event certificate 606 may be contingent upon a time associated with the publication 601, a release, an availability, and the like. For example, a contingent event certificate 606 may entitle a holder to purchase a copy of a first printing of a publication 601 upon its release. In this example, a holder of a contingent event certificate 606 may be obligated to purchase the first printing of a new book immediately upon release. In this way, the publisher may be motivated to make the first printing knowing that the holders of the contingent event certificate 606 for this future item 624 will be obligated to purchase the publication 601 at a predetermined price. The holder of the contingent event certificate 606 may be willing to acquire this contingent event certificate 606 so that they know they have the right (as well as the obligation) to purchase the first printing of the publication 601.

Music 630 and reunions of certain musical groups hold a great attraction for many people. A contingent event certificate 606 that could entitle a holder to a copy of the first distribution of a new recording of a reunited musical group may also be popular and generate interest in the reunion. Determining the likelihood that a reunion and recording would be economically viable may be difficult. The musical group and those who may be taking a risk related to the reunion and recording may use contingent event certificates 606s as a measure of the reward potential of a reunion and recording. Additionally, the musical group may receive some income from the sale of contingent event certificates 606s that may be used to pay for some of the recording-related costs before the recording is complete.

A contingent event certificate 606 provides a holder with certain rights that may be related to a future item 624 associated with the contingent event certificate 606. The rights may relate to a future purchase associated with the future item 624. The rights, being related to a future item 624, may not be exercisable until a contingency associated with the future item 624 is satisfied. If the contingency is not satisfied, the rights may expire.

The contingent event certificate 606 may represent an agreement between the holder of the contingent event certificate 606 and a provider of the future item 624. Therefore the future item provider may also have rights associated with the contingent event certificate 606. The future item provider may have the right to receive compensation from the holder of a mature contingent event certificate 606 in exchange for the ticket, seat, or other good or service to which the holder of the contingent event certificate 606 is entitled.

In addition to rights related to a future item, a holder of a contingent event certificate 606 may have other rights such as the right to sell or exchange the contingent event certificate 606 through a contingent event certificate or right market platform 658 as herein described.

A contingent event certificate 606 may facilitate a business rewarding one or more employees if a set standard or goal is achieved. A contingency for a contingent event certificate 606 may include achieving the set standard or goal. In this way a business can use a contingent event certificate 606 to provide a reward to an employee, contingent on the employee's or the business's achievement.

As an example, a business may provide contingent event certificates 606s to a work team. The contingent event certificate 606 may provide the work team a right to a future item contingent on the work team achieving a set standard or goal. The work team may be charged with producing a prototype of a new product. The future item may be a night out on the town that is contingent upon the prototype's being produced before a deadline. If the team produces the prototype by the deadline, the contingent event certificate 606 may mature such that the contingent event certificate 606 would entitle the holder to the night out on the town.

A contingent event certificate 606 may include a plurality of associated future items, such as access to a season of events. The plurality of associated future items may be contingent on an acceptance of an agreement related to the future items. The plurality of future items may be contingent on a plurality of contingencies. Examples of a contingent event certificate 606 including a plurality of associated future items includes a season of lawn care services, a sports team season ticket for all home games, a pass to all concerts in a concert tour, a pass to all opening nights at an opera house for a season, and the like. The plurality of future items may include certain terms that a holder of a contingent event certificate 606 must agree with before the holder may redeem a mature contingent event certificate 606. Such a term may include a ban on smoking at the event venue. In another example, the associated event may be a party on the lawn within a concert. For example, a user may purchase a contingent event certificate 606 for a block of lawn seats to a Jimmy Buffett concert with the contingency that the concert be located in Foxboro, Mass. If the concert is scheduled to be in Foxboro, Mass., the user may be obligated to purchase the block of lawn seats, but may also have the opportunity to hold a party on the lawn during the concert. In some embodiments, the opportunity to have a party may be sold as a separate contingent event certificate 606 or may be sold as part of the seats' contingent event certificate 606.

A contingent event certificate 606 that may include a plurality of associated future items may be split up by a holder of the contingent event certificate 606 into subsets of the associated future items such as individual future items. Such a split may facilitate the holder of the contingent event certificate 606 for a plurality of future items to sell or exchange one or more contingent event certificates 606s for the subset of future items. However, a contingent event certificate 606 for a plurality of future items may be restricted from being split thereby obligating the holder or holders to exchange the contingent event certificate 606 for the plurality of future items as a whole.

A contingent event certificate 606 may be tradable 605 such as through exchange or sale on a contingent event certificate or right platform 658, or by exchange with the event producer or event ticket provider for another event. However, a contingent event certificate 606 may be non-tradable 605.

As an example, a contingent event certificate 606 for a future event may occur at a time when a holder of the contingent event certificate 606 is traveling out of the country and cannot attend the event. The holder may wish to exchange the certificate for another event they can attend. However, the certificate may obligate the holder to make a purchase associated with the event, and therefore the event producer may not accept the contingent event certificate 606 in trade for another event ticket or contingent event certificate 606. Yet the holder of the contingent event certificate 606 may sell or exchange the contingent event certificate 606 through the contingent event certificate 606 platform, effectively transferring the purchase obligation to a new holder.

A contingent event certificate 606 may include security features 609 and may provide a secure form of agreement between the holder and the future item producer. To ensure an agreement between a holder of a contingent event certificate 606 and future item producer is secure, a contingent event certificate 606 platform facilitator may require a potential buyer or holder of a contingent event certificate 606 to provide critical information such as credit cards and the like to secure the holder's obligation to make a purchase if the contingent event certificate 606 matures.

The contingent event certificate or right platform 658, and the contingent event certificate 606 itself may be secure and protected from malicious intent of others. The contingent event certificate 606 may include a serial number that is associated with the holder of the contingent event certificate 606 such that only the holder of the contingent event certificate 606 may authorize sale, exchange, or redemption of the contingent event certificate 606.

Sports fans, music fans, NASCAR fans, and fans in general often collect and/or trade memorabilia. A contingent event certificate 606 may be associated with such memorabilia. A contingent event certificate 606 may be provided to a holder in a collectible 611 format such as a framed certificate. In this way, even an expired contingent event certificate 606 may be collectible 611.

A contingent event certificate 606 may include a collectible item. A contingent event certificate 606 for a collectible item may include a contingency associated with the collectible item. For example, a contingent event certificate 606 for a collectible item may entitle a holder of the contingent event certificate 606 to an autographed photograph of New England Patriots quarterback Tom Brady if the Patriots win the National Football League title game. In this example, the collectible item is the autographed photograph, and the contingency is the Patriots winning the title game.

Advertisers 613 may be associated with contingent event certificates 606s. Advertisers 613 may be associated with an event of a contingent event certificate 606. Advertisers 613 may be associated with a contingent event certificate or right platform 658. Advertisers 613 may be associated with the sale, exchange, and redemption of a contingent event certificate 606. Advertisers 613 may provide a producer of a contingent event certificate 606 with compensation to be associated with the contingent event certificate 606. For example, an advertiser of bicycling equipment may pay a producer of a contingent event certificate 606 for attendance to the Tour de France to allow the advertiser to promote bicycling equipment in association with the contingent event certificate 606. This may come in the form of an internet ad campaign, advertisements 602 on a website of the contingent event certificate or right platform 658, or print or other media indicating a sponsorship or promotion of the contingent event certificate 606.

Advertisers 613 may also provide promotions to holders of contingent event certificates 606s. An advertiser may, through coordination with a contingent event certificate or right platform 658 facilitator, gain access to a list of holders of contingent event certificates 606s and may offer a promotion to the holders that may be associated with the future item. For example, an advertiser of tennis equipment may promote a tennis racket with custom markings associated with a tennis event to holders of contingent event certificates 606s for the tennis event. Since the holders of the contingent event certificate 606 may already have a strong interest in the tennis event (and therefore may know about tennis), they may be more likely to respond positively to such an offer.

Producers 668 may be associated with contingent event certificates 606s. Producers 668 may include merchant suppliers who may have originally proposed the particular future item associated with the contingent event certificate 606. A producer 668 associated with a contingent event certificate 606 may include an entity, individual, or group who may hold rights related to the future item. Such an example includes an investor in the future item, a participant in the future item, an owner of a venue 614, an owner of a participating team 610, and the like. A publisher may be a producer 668 for a future item related to publishing such as a release of a new book. A consumer product company like Apple Computer or a consumer services company like AIG Insurance may be a producer 668 for an event related to the production of consumer products and consumer service offerings. In addition to sports participants, musicians, artists, manufacturers, distributors, retailers, service providers, and others may also be associated with a contingent event certificate 606. An artist may receive a base portion of sales of contingent event certificates 606s for an event that they are participating in. In addition the artist may receive other compensation based upon a contingency such as the number of contingent event certificates 606s sold or the average sale price of a contingent event certificate 606 in a predetermined period of time.

In some embodiments, a party not supplying a future item may propose or nominate the future item for sale. For example, a hobbyist without the means for producing a computing mouse may nevertheless design and propose an improved computing mouse. The future item may be associated with a contingent event certificate 606. A supplier 664 or the like may agree to supply or produce the future item if demand as measured by sales of the contingent event certificate 606 exceeds a threshold.

The party not supplying the future item, the supplier 664, or the like may promote the sale of the contingent event certificates 606. For example and without limitation, the party may be a hobbyist who promotes his improved mouse design to members of his social network, encouraging those members to purchase the contingent event certificates 606. In some embodiments, the party may use the user interface 619 to enter one or more promotional messages into social networking facility 616.

When sales of the contingent event certificates 606 exceed a threshold, the supplier 664 or the like may produce, sell, and/or ship the future item. At that time and/or at any and times thereafter the party may receive a royalty payment or the like. The royalty may or may not be tied to the number of future items that are produced, sold, and/or shipped.

The related/integrated markets 670 and/or the contingent event certificate/rights market 682 may enable and/or facilitate the payment of a royalty to the party. It will be understood that various embodiments of the markets 670 and 682 are possible, the markets 670 and 682 for enabling and/or facilitating the payment of a royalty to the party.

Suppliers 664 associated with a contingent event certificate 606 may include manufacturers. Suppliers 664 of product launches 634 may be associated with a contingent event certificate 606.

A manufacturer may accept an obligation to deliver a product by a predetermined date and may receive a contingent event certificate 606 that is contingent on fulfilling the obligation. In an example, a manufacturer may commit to producing 100,000 new games by October 15 to ensure they are available in retail outlets in time for holiday purchases. In exchange for this commitment, the manufacturer may receive a contingent event certificate 606 that may allow the holder to receive a portion of sales revenue for the new game. If the manufacturer meets the production commitment, the certificate may mature and the manufacturer may receive the portion of sales revenue. If the manufacturer does not meet the production commitment, the certificate may expire.

A consumer 542 may acquire a contingent event certificate 606 that entitles the consumer 542 to purchase a future item 624 if and only if a sufficient number of contingent event certificates 606 are sold. When that number of certificates 606 are sold, then a manufacturer, supplier, or the like may become obligated to deliver the future item to holders of the contingent event certificates 606. This obligation may include a ship-by date, a deliver-by date, a price, and so on.

A producer 668 that is associated with a contingent event certificate 606 may include a content producer such as and without limitation an entity, individual, or group that may produce content or hold rights related to the production of content. Numerous types of content will be appreciated including, without limitation, content that is audio, video, multimedia, interactive, web-based, text-based, document-based, digital, executable, interpretable, user-generated, and so on. For example and without limitation, In some embodiments, the producer 668 may encompass an individual who produces an online video. A user of a social network may suggest the production of an online video. In response to this, the producer 668 may associate himself with that request and may offer to produce the online video contingent upon a certain number of users committing to view the video and a commercial that would be distributed along with the video. This commitment may be embodied as a contingent event certificate 606. Alternatively, the producer 668 may produce the online video contingent upon a certain number of users committing to purchase a copy of the video.

A market for a contingent event certificate 606 may be related to or integrated with other markets such as financing markets 615. Related or integrated markets 670 may facilitate securing the underlying interest or security on which the contingent event certificate 606 value is initially established. If a contingent event certificate 606 is for a sporting event or a consumer product or service, a related financing market 615 may be established to purchase (or guarantee to purchase) a plurality of event tickets or, in other examples, to facilitate manufacture and distribution of the product or provision of the service.

Financing sources for such a related or integrated market include venture capital, traditional banking, third-party private lending, and any combination of these and other financing sources that may facilitate reducing risk to any of the combined financing sources. Venture capital may be a source of financing for establishing and maintaining the contingent event certificate 606 platform. Venture capital may also be a source of financing for continual financing event purchases to enable the establishment of the market. Traditional banking may also be included as a financing source in a related or integrated financing market. Traditional banks offer short-term and long-term interest rates to customers. Typically a short-term investment produces a slightly higher interest rate than a long-term investment. Financing associated with a contingent event certificate 606 may facilitate a traditional bank offering customers a short-term base interest rate and a variable rate based on the value of contingent event certificates 606s held by the bank.

A bank may offer its customers a contingent event certificate 606 for doing something such as signing up for on-line bill payment for example.

Finances to purchase or guarantee purchase of a plurality of one or more items associated with a future item 624 may be provided by a variety of financing vehicles. These financing vehicles may include debt instruments such as loans, convertible securities that may have one or more conversion terms, revenue sharing agreements, and other vehicles as may be used to provide an investor a way of providing financing.

A convertible security may include providing financing in exchange for one or more options by which the inventor providing the financing is to be reimbursed. A conversion option may include converting at least a portion of the security to an ownership in the event, the contingent event certificate 606 platform, or the like. In an example, a holder of a convertible security may exchange repayment for the current event for a repayment of a future event. This convertible security may allow a holder of the security to continue to defer repayment. An objective of such a conversion option may be to allow the contingent event certificate 606 platform to continue to make purchases and issue new contingent event certificates 606s with the potential of the holder of the convertible security to earn even greater return on their initial investment. The conversion option may facilitate converting at least a portion of current repayment to future repayment.

Financing vehicles may also be combined in contingent event certificate or right-related/integrated markets 682, 670. A combination of vehicles may facilitate reducing a financial risk associated with the market for contingent event certificates 606s. In an example, a debt instrument, providing repayment on a schedule at a fixed rate of interest may include a risk of default independent of the success of the contingent event certificate 606 offering. However, by combining a debt instrument with a revenue sharing agreement, a lender of a debt instrument may receive some portion of revenue of the contingent event certificate 606 offering, which may mitigate the default risk.

A project financing market 615 related to a contingent event certificate 606 may be future item-based. Aspects of the financing market 615 may be dependent at least in part on the type of future item 624. A future item 624 that may be cancelled, such as an outdoor concert, may impact a financing market differently than a future item 624 such as a sports championship. The differences between these two types of future items may be reflected in the level of risk, and therefore the required reimbursement terms, of a related financing market for the future item 624. In an example, a concert by a single performer, such as Britney Spears, may have a measurable risk of being cancelled. This risk may be factored into the terms an investor may require for investing in a contingent event certificate 606 offering for the event and the investor may expect higher interests, a greater portion of revenue, and/or revenue from other of the performer's events.

A group event, such as a sports championship, is unlikely to be cancelled. In such an event, a financing market 615 may have different terms such as lower interest rate but higher revenue sharing, as the chance of cancellation is nearly zero. Other events, such as product launches, tournaments, TV productions, theatre productions, movie premieres may have risks associated with the event but may be unlikely to be cancelled. A movie premiere may go on even if the star of the movie is not available to attend the premiere. While this risk may be factored in, and one or more contingent event certificates 606s may include this as a contingency, the financing market 615 may be impacted differently.

Financing markets 615 for season-based contingent event certificates 606s (contingent event certificates 606s for a plurality of associated events), may include financing to holders of mature contingent event certificates 606s. Perhaps due to the typically larger cost of a season ticket compared to a single event ticket, a financing market 615 may be established in which the holders may borrow money to purchase the season tickets when the contingent event certificate 606 matures. The financing market 615 may include paying the venue producer for the season ticket and receiving reimbursement from the holder of the mature contingent event certificate 606 through a debt instrument or the like.

In an example of a season-based contingent event certificate 606, a mature contingent event certificate 606 may entitle (and obligate) the holder to purchase a season subscription to lawn care services. In another example of a season-based contingent event certificate 606, a mature contingent event certificate 606 may entitle (and obligate) the holder to purchase a season ticket to an orchestra's performance season. A financing market 615 for a season-based contingent event certificate 606 may include a lender purchasing the season ticket and providing a ticket to the orchestra's individual performances when the holder has made sufficient payment to the lender. If the holder does not make sufficient payment to the lender, the lender may do as they see fit with the ticket.

A project financing market 615 may be associated with a contingent event certificate 606 and may be based at least in part on an aspect of a seat at an event. An aspect of the seat may include a seat license, a season ticket for the seat, or a seating block related to the seat. The seat may be a single seat or a plurality of seats such as a block of seats. A contingent event certificate 606 may include an obligation to license a seat associated with a venue 614 of the event.

A seat license may be financed through a secondary market that may include promoters, business entities, and others desiring a financial interest in the seat license. In an example, a contingent event certificate 606 may provide a holder with access to a seat that requires a license to use the seat and amenities such as parking passes, private entrance, lounge areas and the like. A seat license may also allow the licensee to have first right of refusal for a ticket for the licensed seat to all of the events held at the venue. A financing arrangement may include providing financing for the seat license in exchange for access to at least some portion of the events held at the venue. The holder of a contingent event certificate 606 that includes a seat license may agree to allow a financier of the seat license to have access to one-half of the tickets available to the holder.

A project financing market 615 associated with a contingent event certificate 606 may facilitate providing financing based at least in part on a venue 614 for an event. Venues 614 that may be associated with a project financing market 615 may include sports stadiums, golf courses, ski slopes, Olympic venues, race tracks, arenas, fields, concert halls, theatres, lecture halls, retail stores, retail outlets, bookstores, and the like. Owners, mortgage holders, investors, and the like of one or more of these venues 614 may participate in a project financing market 615 to facilitate selling out events held at the venue 614. Such entities may wish to provide financing to one or more contingent event certificate 606 offerings to increase the probability that the amount of revenue they receive associated with the venue 614 may include sources other than ticket sales.

Referring again to FIG. 6, a market for a contingent event certificate 606 may be associated with a secondary market 672 for a contingent event certificate 606. Participants 600 such as financial participants and market participants in a market for contingent event certificates 606s may access a secondary contingent event certificate or right market 670 through a user interface 619. The user interface 619 may allow a participant to post contingent event certificates 606s on the secondary market for purchase, exchange, trade, or auction through a contingent event certificate 606 offer screen.

The user interface 619 may also allow a financial participant to monitor postings on the secondary market by viewing a certificate of authenticity of the contingent event certificate 606. The user interface 619 may also allow a participant to place a bid for a contingent event certificate 606 and perform a transaction such as purchasing the contingent event certificate 606 on the secondary market.

The secondary contingent event certificate or rights market 672 may enable one or more participants 600 to buy, sell, or otherwise exchange contingent event certificates 606s at any and all times following an initial sale or exchange of the certificates 606s.

A secondary contingent event certificate or rights market 672 may include expired contingent event certificates 606s. A participant user interface to a secondary contingent event certificate or rights market 672 may include a listing of contingent event certificates 606s available, including the status of each contingent event certificate 606 (expired, contingent, mature). A secondary contingent event certificate or rights market 672 may be integrated with a contingent event certificate 606 market to facilitate status updates and trading or exchange of contingent event certificates 606.

A user interface 619 between participants 600 and a project financing market 615 may facilitate a participant 600 determining the financing alternatives associated with the contingent event certificate 606 such as those associated with the product launch, service offering, service provider, the venue 614, the seat, the event, financing sources, and financing vehicles. In an example, a contingent event certificate or right market participant 600 may use a user interface 619 to view a listing of available financing alternatives and the type of contingent event certificate 606 for which they are eligible.

A project financing market user interface 619 may allow a financial participant of a contingent event certificate 606 market to view financing offers, compare financing scenarios, and distribute requests for financing a contingent event certificate 606 offering.

A project financing market user interface 619 may facilitate a project financier reviewing and interacting with the current financing of an ongoing contingent event certificate 606 offering. The user interface may include controls to facilitate releasing quantities of contingent event certificates 606s to the marketplace.

Participants of a contingent event certificate 606 market may use a user interface 619 to facilitate viewing seat alternatives that may be associated with a mature contingent event certificate 606. The user interface 619 may allow a participant to view a seating chart of a venue 614 and select at least one seat, section, or area for purchase of a contingent event certificate 606. The user interface 619 may allow a participant to experience the view angles from a particular seat or block of seats. The user interface 619 may allow a user to select the seat through the contingent event certificate or right market website or through a venue provider's website and be offered a contingent event certificate 606 that best fits the selected seat.

Participants of a contingent event certificate 606 market may use a user interface 619 to facilitate viewing a consumer product prototype that may be associated with a contingent event certificate 606. The user interface 619 may allow a participant to review proposed specifications, see different views of the prototype, learn more about the advantages of the product, and the like. The user interface 619 may allow a user to select a prototype of a consumer product through the contingent event certificate or right market website or through a producer's website and be offered a contingent event certificate 606 that best fits the selected prototype.

A participant 600 of a contingent event certificate or right market 682 may use a user interface 619 to select and/or define an assignee to which a contingent event certificate 606 would be assigned if the contingent event certificate 606 matures. This aspect of a contingent event certificate 606 market user interface may facilitate affiliates or brokers 619 who may bid on one or more contingent event certificates 606s but assign them to a third party that has made an agreement with the broker or affiliate to purchase the mature contingent event certificate 606.

A participant user interface 619 of a contingent event certificate or right market 682 may facilitate access to related websites such as the venue website, the team or teams participating in the contingent event, a product retailer, a social networking website, a service provider website, and many others that may be related to the future item 624 or a sponsor of the future item.

A financial or market participant user interface 619 of a contingent event certificate or right market may facilitate a holder of a contingent event certificate 606 making a selection to post a contingent event certificate 606 to a rights resale market if the contingent event certificate 606 matures. The selection may be made by the participant as a condition of acceptance of the participant's bid. It may be made at the time a bid for the contingent event certificate 606 is accepted, or it may be made upon receipt of payment for the contingent event certificate 606.

An advertiser 613 may use a user interface 619 to access the contingent event certificate or right market platform 658. The advertiser 613 may use the user interface 619 to perform a transaction with the platform such as paying for placement of an advertisement 602. The advertiser user interface 619 may also facilitate the advertiser 613 accessing demographics of holders of contingent event certificates 606s. An advertiser 613 may also use the user interface 619 to enable the back end production of new future items that reach a pre-established threshold of demand. Advertisers 613 may also use the user interface 619 to author new proposals for future items 624, such as consumer products and services. In some embodiments, the proposal may only be distributed in a limited fashion, such as to the advertiser's 613 employees so that new future items 624 may be nominated by the advertiser 613 for production, distribution, and retail to a wide audience.

Advertisers 613 may also use a user interface 619 to a contingent event certificate or right market platform 658 to review contingent event certificate 606 sale and exchange performance-related statistics. The advertisers 613 may use demographic and contingent event certificate 606 performance information to provide targeted advertisements 602 to participants of the market.

Producers 668 may interact with a contingent event certificate or right market platform 658 through a user interface 619. The user interface 619 may facilitate an event producer's 668 releasing allocations of contingent event certificates 606s to be sold or exchanged through the market platform 658. In an example, a producer 668 may choose to manage releases of contingent event certificates 606s over time to maintain interest in the future item and to provide participants the opportunity to purchase a contingent event certificate 606.

The producers 668 may also use the user interface 619 of the contingent event certificate 606 market to identify rules associated with the contingent event certificates 606s. The producers 668 may use the user interface 619 to monitor contingent event certificate 606 activity such as transaction rates, fees, sale prices, and the like.

Producers 668 may also use the user interface 619 of the contingent event certificate 606 market to price future item proposals. For example, if a producer 668 nominates a new toy, and wants it produced by a backend toy producer, the producer 668 may need to “presell” a threshold number of the toy. However, the producer 668 may need to give the price for the toy to the offerees. As a single inventor, the producer 668 may not be able to price the toy, so the backend toy producer would have to look at the concept, estimate the retail value, and likely “approve” the proposal before it is released into the market or social network. Producers 668 may have a “review” and “approval” process for future item proposals before they are generally released into the market or social network.

Employees, loyalty club members, fan club members, season ticket holders, registered users, pre-selected users, pre-qualified users, or others closely associated with a producer 668 may be identified through the producer user interface 619 such that the platform 658 provides them an offer of a contingent event certificate 606 in advance of a public offering of the contingent event certificates 606s. In essence, this may be a private market prior to opening the contingent event certificate market 682 to a wider audience. For example, as a registered user of CBS Sportsline, users may have a window of time, such as for 48 hours, to purchase contingent event certificates 606 for the Final Four prior to the general public.

Producers 668 may use the user interface 619 to coordinate demand 622 associated with the contingent event certificate 606 offering and/or the future item 624. A producer 668 may identify a threshold, such as a threshold of contingent event certificate 606 offer transaction activity, and may use the user interface 619 to establish this threshold in the platform 658. The producer 668 may use the user interface 619 to receive an alert if the threshold is exceeded. The producer 668 may then use the user interface 619 to manage one or more aspects of the contingent event certificate 606 offering.

A participant 600 of a contingent event certificate or right market 682 may associate a contingent event certificate 606 with a social network facility 616, which may provide, comprise, encompass, or otherwise be associated with a social networking website. A user interface 619 for the social network site may allow a user to enter a link to a listing on the contingent event certificate or right platform 658 of the contingent event certificate 606 the user currently has to offer.

A contingent event certificate market platform 658 may be hosted on a computing facility, such as and without limitation a server. The host 660 may be a computer system that provides services to other computing systems and clients over a network, such as a local area network, wide area network, wireless network, intranet, the Internet, or the like. The server may be a computer system that operates continuously on the network and provides full-time access to the contingent event certificate market platform 658. The host 660 may provide a facility for an application server, database server, file server, client-server, or the like. The host 660 may provide hardware and/or software in support of the hosting of the contingent event certificate market platform 658. Host 660 hardware may include a central processing unit; input/output (I/O) facilities, such as keyboards, displays, disk drives, modems, network cards, or the like; memory, such as RAM, ROM, or the like; mass memory, such as optical discs, hard disks, or the like; or other such computer hardware. Host server software may include system software, program software, application software, business software, databases, or the like.

The host 660 may provide software-based services for users of the contingent event certificate market platform 658 that may provide personalized access capabilities, which may be adapted for consumers, event producers, manufacturers, distributors, retailers, service providers, advertisers, social network interfaces, related/integrated markets, or the like. Users may have customized access to host services of the contingent event certificate market platform 658 through a web portal, where access may be dependent upon the type of user, such as a username/password customer interface for contingent event certificate 606 transactions, a secure access for producers 668, customer service access for advertisers 613, or the like. The host 660 may provide access to data storage for users of the contingent event certificate market platform 658, such as user information, billing information, event information, contingent conditions, certificate tracking of ownership and price, or the like. The host 660 may also provide facilities for providing tickets or contingent event certificates 606 to users, system security, internationalization and technological interface to users, or the like.

The contingent event certificate market platform 658 may provide for a facility to fulfill user orders (fulfillment 662), and send the user a physical document in the form of a contingent event certificate 606, event ticket, receipt, voucher, product, or the like. The document may be printed and physically mailed to a user-specified shipping address, bought at a ticket window or box office, printed at a store by a store employee, printed at a kiosk by the user, or the like. The document may include a facility for identification and authentication of the document by ID number, barcode, magnetic stripe, password, biometrics, or the like. The document may have an element for securing against counterfeiting, such as special paper, treatments to the paper, intricate artwork, holograms, or the like. The contingent event certificate market platform 658 may allow for the transfer of ownership of the contingent event certificate 606. Transfer of ownership may be performed online, by phone, at a ticket window or box office, at a store, a kiosk, or the like. Transfer of ownership may result in a new contingent event certificate 606 identification number being generated, and a new document sent to the new owner. Fulfillment 662 of contingent event certificate 606 orders may also take other forms, such as a pass card, a discount pass, a club card, a season pass, or the like. The document may be able to add or subtract contingent event certificate 606 registrations, interface with a computational facility, be scanned for entrance to an event, or the like.

The contingent event certificate market platform 658 and/or host 660 may include a facility for storing data, such as and without limitation the data facility 534. Data may include user information, billing information, product information, service offering information, event information, contingent conditions, certificate tracking of ownership and price, or the like. Data may be stored local to the contingent event certificate market platform's 682 host 660, such as within the same physical memory space as applications software, operating software, or the like. Data may be stored remote from the contingent event certificate market platform's 682 host 660, such as in a separate memory, separate computer resource, content delivery networks, content distribution networks, or the like. Data stored in the contingent event certificate market platform 658 may be accessible by customers, social networks, advertisers 613, producers 668, related/integrated markets 670, or the like. Access to data within the contingent event certificate market platform 658 may require authentication, such as a username, password, security code, or the like. Data may also continually change to reflect changing event information, pricing, threshold demand levels, contingent changes, or the like.

Without limitation, the contingent event certificate market platform 658 and/or host 660 may maintain a more or less complete set of information relating to a contingent event certificate 606. This set of information may include a proposal for a product or service; a description of a product or service; an advertisement 602; a description of an author, originator, or the like of a product or service; a price; an image; a video; and so on. This set of information may be stored by the data facility in one or more data files, database tables, or the like. Herein and elsewhere, this set of information may be referred to as a container. It will be understood that a variety of embodiments of the container are possible.

The contingent event certificate market platform 658 may enable users of the platform 658 to transfer contingent event certificates 606 between themselves. Such transferring may or may not be associated with a transfer of money. For example, one user may gift a contingent event certificate 606 to another user. For another example, one user may lose a contingent event certificate 606 to another user as part of a wager. It will be understood that a variety of systems and methods are possible for transferring a contingent event certificate 606 from one user of the platform 658 to another.

The contingent event certificate market platform 658 may enable a user of the platform 658 to transfer a contingent event certificate 606 to a recipient that is not yet a user of the platform 658. In other words, the recipient may not ever have created an account on the platform 658; logged into or accessed the platform 658; or the like. In any case, the user of the platform 658 may begin transferring the contingent event certificate 606, causing the platform 658 to create a temporary account or the like for holding the certificate 606. The platform 658 may then notify the recipient that the certificate 606 is available for claim. Without limitation, this notifying may occur via e-mail, instant messenger, or the like. In any case, notifying the recipient may include transmitting a click-to-claim link or the like that allows the recipient to claim ownership of the certificate 606 with a single action or a series of actions. Such actions may include clicking a link, logging into a website, responding to a message, and so on. Upon claiming ownership of the certificate 606, the recipient may or may not become a user of the platform 658. It will be understood that a variety of systems and methods are possible for transferring a contingent event certificate 606 to a recipient that is not yet a user of the platform 658.

The contingent event certificate market platform 658 may provide security against risks associated with computer use. Techniques for reducing risks to computer security associated with the contingent event certificate market platform 658 may include providing backups, anti-virus software, firewalls, access control lists, authorization and authentication software, encryption, intrusion-detection systems, or the like. Backups may be a continuous or scheduled activity within the system, and may provide for the copying of data so that these additional copies may be restored if the originals are damaged or lost. Anti-virus software may include computer programs that attempt to identify, thwart, and eliminate computer viruses and other malicious software. Firewalls may help protect the contingent event certificate market platform 658 from intrusions by restricting network traffic, which may be based on a set of system administrator defined rules. Authorization may restrict access to the contingent event certificate market platform 658 to a group of users, such as customers, registered users, manufacturers, distributors, retailers, service providers, event producers, contingent event certificate market platform employees, or the like. Restrictions may be accomplished through the use of authentication systems. The contingent event certificate market platform 658 may employ encryption to protect messages, or intrusion-detection systems that scan the network for unauthorized users and activities.

The contingent event certificate market platform 658 may provide internationalization of user interfaces 619 such as language translation, currency conversion, location-based services, or the like. The contingent event certificate market platform 658 may provide for a user interface 619 that includes access to the system through a plurality of languages, language translations, translator services, or the like. The contingent event certificate market platform 658 may provide for a user interface 619 that includes access to currency conversion. Currency conversion services may be associated with the currency of the user. For instance, a user that has selected German as their user interface language may cause the contingent event certificate market platform 658 to choose the Euro as the default currency for the exchange, with alternate currencies made available as selected by the user.

The contingent event certificate market platform 658 may provide for location-based services, such as a service based on cell phone location, IP address, user self-entry, Internet service provider location, event location, or the like. An example of a location-based service may be a user placing a phone call from a cell phone in Italy for an event located in Italy. The contingent event certificate market platform 658 may set a priority for Italian as the user interface language because of the location of the user and the relevance of an event located in Italy. The contingent event certificate market platform 658 may also provide for alternative languages for the user to choose from, for example, in the instance of an English speaker visiting Italy. The contingent event certificate market platform 658 may also provide for a default currency based on a future item location, such as the peso being selected as the default currency based on the future item's bring produced, offered, or taking place in Mexico City.

The contingent event certificate market platform 658 may be accessed through the Internet from a plurality of sources, such as a computer, PDA, phone, mobile phone, cellular phone, GSM phone, network client device, or the like. The computer may be used to connect to the Internet; for example, using the computer's internet browser, the user may connect to the contingent event certificate market platform 658 though the user's internet service provider. The user may also be able to connect to the contingent event certificate market platform 658 through the browser of the user's mobile communications facility, such as through the user's PDA, mobile phone, cellular phone, GSM phone, or other network client device known to the art. For example, a user of a cell phone may use the Internet connectivity of the cell phone to connect to the contingent event certificate market platform 658 through the wireless provider's distributed communications facility and Internet gateway.

The contingent event certificate market platform 658 may be accessed through the telephone system, such as from a phone, a mobile phone, a cellular phone, a GSM phone or the like. A user may place orders for contingent event certificates 606, trade contingent event certificates 606, schedule events, arrange for advertisements 602, or the like. Wireless providers may offer customers special access promotions to contingent event certificates 606 and other products which customers access via cell phones. For example, a wireless provider may provide a discounted service that can only be accessed though their wireless service. Another example may be a wireless provider reserving special access to blocks of reserved tickets.

User interfaces 619 to the contingent event certificate market platform 658 may include and/or be associated with a social network facility 616 (the “social networks”). Social networks may be communities that in some part utilize the Internet as an element of their social organization.

Social networks may utilize a blended networking approach that may combine online activities with offline elements, such as face-to-face events. Examples of this blended approach may be MySpace, which associates its online activity to independent music and party gatherings, or Facebook, which associates with activity within the college community. Social networks on the Internet may also be focused on specialized activities such as art, tennis, football, soccer, golf, cars, dog owners, or the like. These networks may provide a virtual extension of a groups' activities such as sharing photos, video, stories, planning, group rates, or the like. Social networks may also provide specialized interfaces to outside activities that are associated with the social network's focus. An example of this may be a social network focused on football that interfaces with fan clubs, fantasy football leagues, online sports reviews, ticket suppliers, or the like. Social networks may also enable the distribution of user-generated content proposals. For example, a social network member may receive a user-generated content proposal from a member of her social network then forward it on to her social network with an associated comment, request, or the like.

The contingent event certificate market platform 658 may have an interface with social networks, which may be depicted as an association between the social network facility 616 and the platform 658. These social networks may have specialized interfaces with the contingent event certificate market platform or 682 be the result of social interaction within the social network. The interface between the contingent event certificate market platform 658 and the social network may include selection of existing buy and sell options, monitoring of personal buy and sell status, viewing of existing events, initiation of a contingent event certificate 606 for a new future item 624, the initiation of a contingent event certificate 606 for a future item 624 that has already received other contingent event certificates 606 but is not an actual future item yet, monitoring of the demand aggregation 322 for a future item, or the like. The interface may be implemented as an exchange between the social network's host servers and the contingent event certificate market 682 platform's 658 host 660 as a special interface between the two networks or a general interface such as with any other customer.

A future item being produced may be contingent upon the demand 622 that is aggregated for the future item through contingent event certificate 606 generation and the threshold for demand 622 set for the future item to be produced. An individual customer may participate directly in the contingent event certificate or rights market 682. Alternatively, an individual may participate in the market 682 through the interface or association between the social network facility 616 and the contingent event certificate market platform 658.

Individuals may have an interface to the contingent event certificate market platform 658 through social networks. For instance, the social network MySpace has online associations to independent music and party gatherings, and may provide an integrated interface to the contingent event certificate market platform 658. A MySpace member may initiate a contingent event certificate 606 for a new magazine with a targeted editor and targeted columnists, and monitor the demand aggregation 322 for the magazine. This demand aggregation 322 may generate interest from an editor or columnist who then may set a demand threshold for enabling the magazine to be produced. Alternatively or additionally, any and all parties may set the threshold in advance, prior to or during demand aggregation 322.

In some embodiments, a future item 624 for which demand 622 may be aggregated may be a digitally simulated performance. The digitally simulated performance may be a pre-recorded performance, an animated performance, a holographic performance, a spliced performance, a combination thereof, and the like.

For example and without limitation, a digitally simulated performance may be a video performance of a living performer singing with a deceased performer. The recording may be made by editing pre-existing images of a performance by a deceased performer to manipulate and modify the background of the pre-recorded performance. Manipulations may be done with any video editing technique, such as rotoscoping. Rotoscoping may allow an editor to trace around the deceased performer and digitally separate the background from the performer. Manipulating the background of the deceased performer may facilitate placing the deceased performer into a new environment or in front of a new background, such as one similar or identical to a living performer's environment. The pre-recorded, digitally simulated performance may include at least a portion of a recording of the living performer coordinating their performance with at least a portion of the recording of the deceased performer. The two recordings may be edited together to arrive at the pre-recorded digitally simulated performance. For example, a living performer may match a deceased performer's tempo, volume, pitch, energy, and the like in order to give the appearance that the two performers are singing together. During recording of the living performer's performance, the living performer may glance over at a position the deceased performer may occupy in the final digitally simulated performance in order to give the appearance that they were both present at the recording. To enhance the appearance that the living and deceased performer may be performing together, a body double may be included in the recording of some angles of the living performer's performance. In an example, the final digitally simulated performance may include the digitally manipulated video image of a deceased performer singing a song; the recording of a living performer singing the same song, wherein the living performer may appear to be singing with the deceased performer by matching certain qualities of a deceased performer's performance and by generally acting as if the deceased performer is present at their performance; and, optionally, a recording of certain camera angles with a body double. In some embodiments, such as for when the digitally simulated performance may be intended for a television audience of a program for which there may be a live studio audience, camera angles with a body double may be acquired during a live performance of the living performer with a body double and spliced in to a pre-recorded simulated performance. Other examples of digitally simulated performances may be an editing together of more than one performance by living performers, deceased performers, animated performers, any combination thereof, and the like.

In some embodiments, the digitally simulated performance may be a holographic performance. The holographic performer animations may be projected using any holographic projector, such as a video 3-dimensional projector system (e.g., the Musion Eyeliner System). The 3-dimensional projector system may enable freeform 3-dimensional holographic moving images to appear within a live event stage setting. Additional technology may be used to enhance the holographic effect, such as illusionary techniques (e.g., Peppers Ghost technology). In some embodiments, a plate glass and special lighting techniques may be used to make holographic objects seem to appear or disappear, or make one holographic object seem to “morph” into another. Holographic performer animations may be projected onto transparent film placed on a stage, creating the appearance that performers are actually present on the stage. In some embodiments, a holographic performance may be accompanied by a live performance. For example, the holographic performance and the live performance may be timed so that it appears that a live performer is performing with a holographic performer.

Demand 622 for a digitally simulated performance may be aggregated as described herein. A demand aggregation facility 202 may provide an interface, such as a web site or web page that may include screens that a user 208 or future item provider 204 may use to request a digitally simulated performance be produced in response to obtaining, from users 208, digitally simulated performance-related commitments (such as and without limitation pre-orders for digitally simulated performance-related downloads and/or items). A user 208 may access the demand aggregation facility 202 directly or may be brought to the demand aggregation facility 202 by linking to it from another website.

Once a contingent event certificate 606 is obtained, either by being purchased, earned, or at no cost, it may be sold or traded prior to the future item 624 being produced. The selling and trading of contingent event certificates 606 may be facilitated within the contingent event certificate market platform 658, such as with FanForwards, or within a secondary market place. FanForwards may be a way of buying and selling contingent event certificates 606 within the controlled environment of the contingent event certificate market platform 658.

Users may receive certain benefits as members of clubs of event performers and future item producers. A user may enroll in a club and purchase products associated with an event performer, future item, or future item producer, such as music downloads, tee-shirts, mugs, jewelry, accessories, books, or the like, from the club website. The user may earn points for each purchase, for carrying a retailer credit card, for serving on an opinion panel, for referring the producer to their friends, and the like. The club may offer contingent event certificate 606 promotions to users in possession of a certain number of points, or to the user with the greatest number of points, where the contingent event certificate 606 may be made available for purchase or given freely as a reward. In turn, the user in possession of the contingent event certificate 606 may sell the contingent event certificate 606 within a trading facility within the contingent event certificate market platform 658, in a secondary marketplace, within the club, or the like. For example, Best Buy may have a club where points are awarded for having a Best Buy consumer credit card, for purchasing electronic devices, for purchasing extended warranties, for using the Geek Squad service, and the like. Best Buy may offer a reward to those club members above a certain threshold number of points, such as advanced access to the new version of the iPod nano.

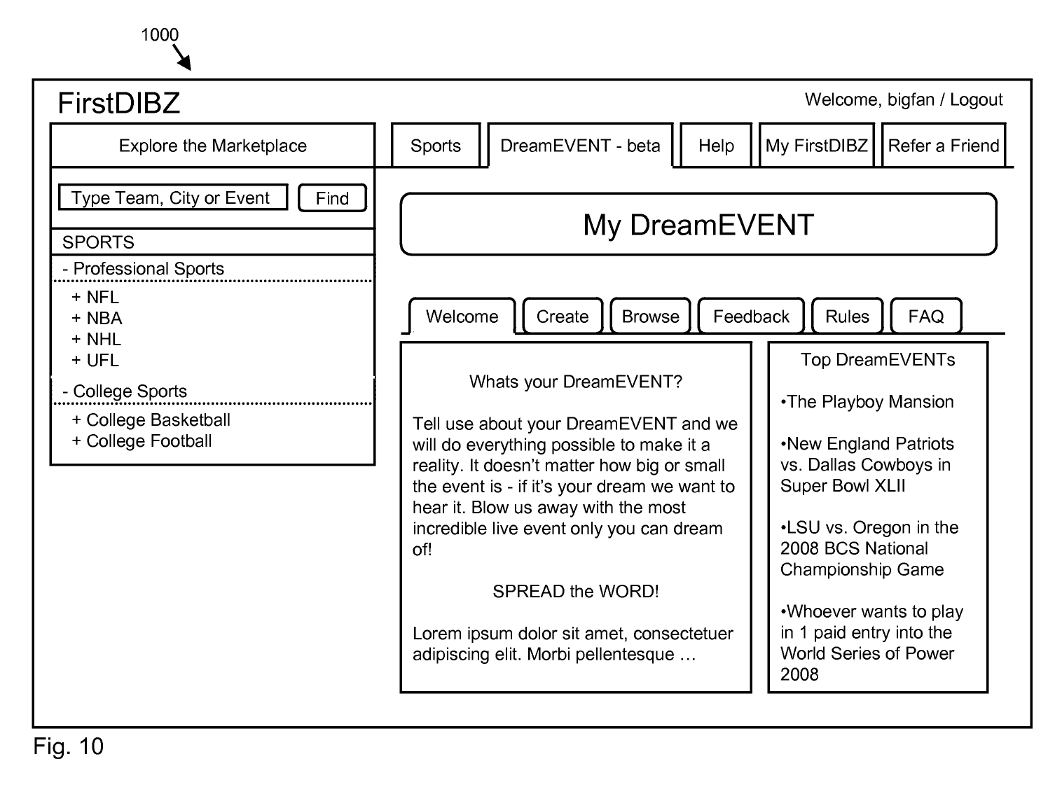

Referring now to FIG. 10, in some embodiments, a facility for measuring and tracking demand 622 may track demand for future items where the item is a user-proposed event, or DreamEvent. For example, a user may wish to see his favorite band, sports superstar, comedian, or celebrity at the user's favorite venue, or see his favorite sports team play for the championship, and the like. A user may access the demand aggregation facility 622 directly or may be brought to the demand aggregation facility 622 by linking to it from another website. The facility for measuring and tracking demand 622 may allow users to propose an event that they would like to see occur or be produced. In some embodiments, proposing an event may be free of charge. The proposed event may then be publicized for other users to vote on or otherwise indicate an interest in the proposed event. In some embodiments, voting on an event may be free of charge. The proposed event receiving the most total votes or where sufficient interest in the event is otherwise demonstrated may be a winning event. The user having proposed the event may receive at least one of a forward right, a forward right and/or forward obligation, or a contingent event certificate for the winning event. In some embodiments, a winning event may still not be produced, but if it does occur, the user may be able to apply his forward rights. Optionally, the winner may receive tickets to the actual event if the event is scheduled, occurs, or is otherwise produced. For example, if a user proposes the event “U2 in concert at Madison Square Garden in 2008” and the event receives enough votes to be a winning event, the user who proposed the event may receive forward rights to the event should it occur or be produced as proposed, or alternatively may receive tickets to the event upon occurrence.

A user who proposes an event may be referred to herein and elsewhere as a proposer.

Proposed events may be reviewed or searched by producers, venue operators, artists, entertainers, and the like in order to assess interest in an event.

Continuing to refer to FIG. 10, the facility for measuring and tracking demand 622 for a proposed live event may include a welcome screen 1000, an event proposition webpage 1100, a proposed event browsing webpage 1200, a search results browsing webpage 1300, individual proposed events webpages 1400, a rules webpage 1500, a Frequently Asked Questions webpage 1600, and the like. The welcome screen 1000 may provide an introduction to the demand aggregation facility 622, may show tabs related to various other components of the facility 622, may display the top proposed events, and the like.

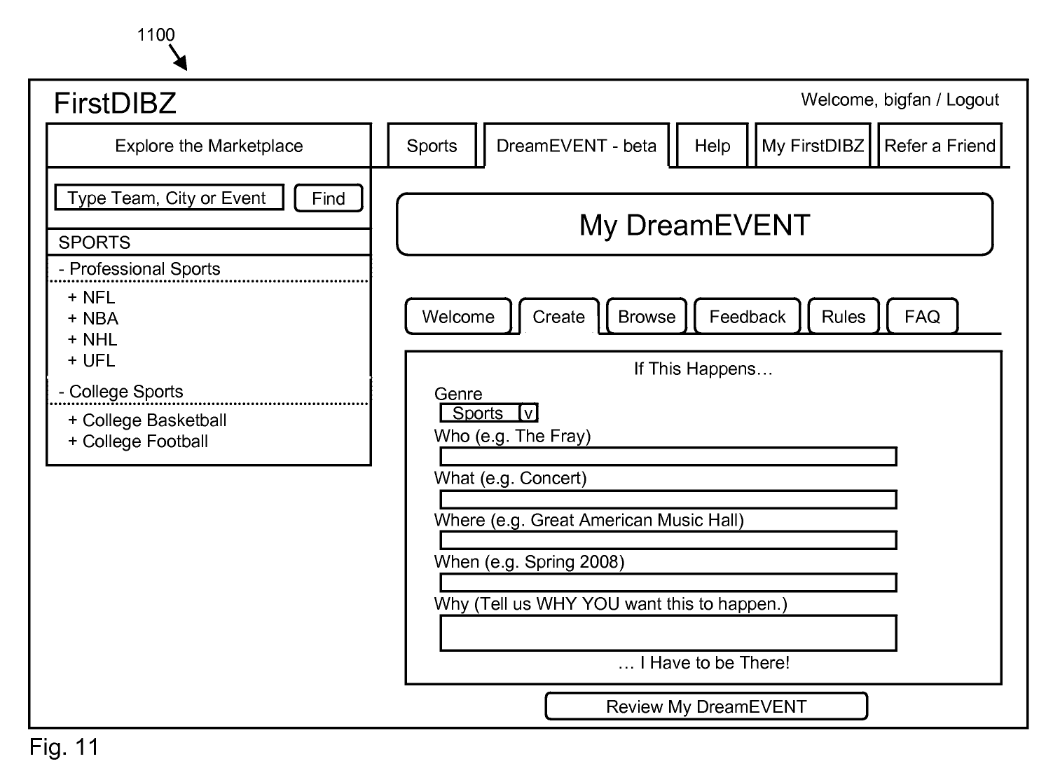

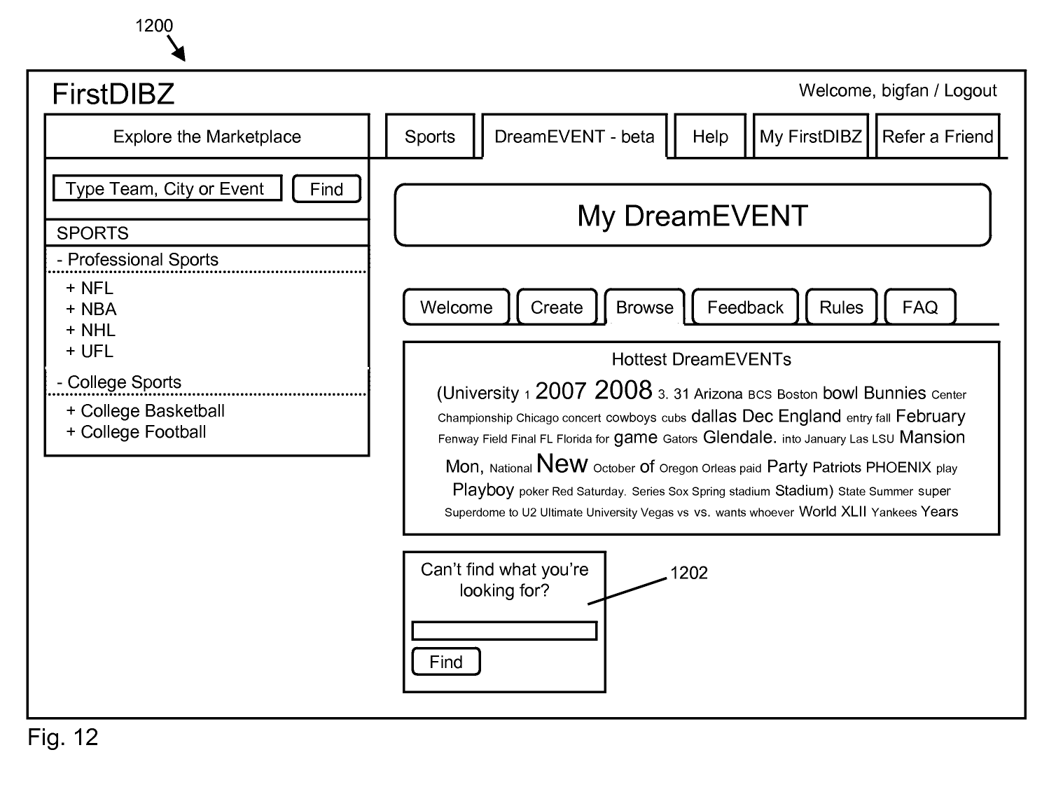

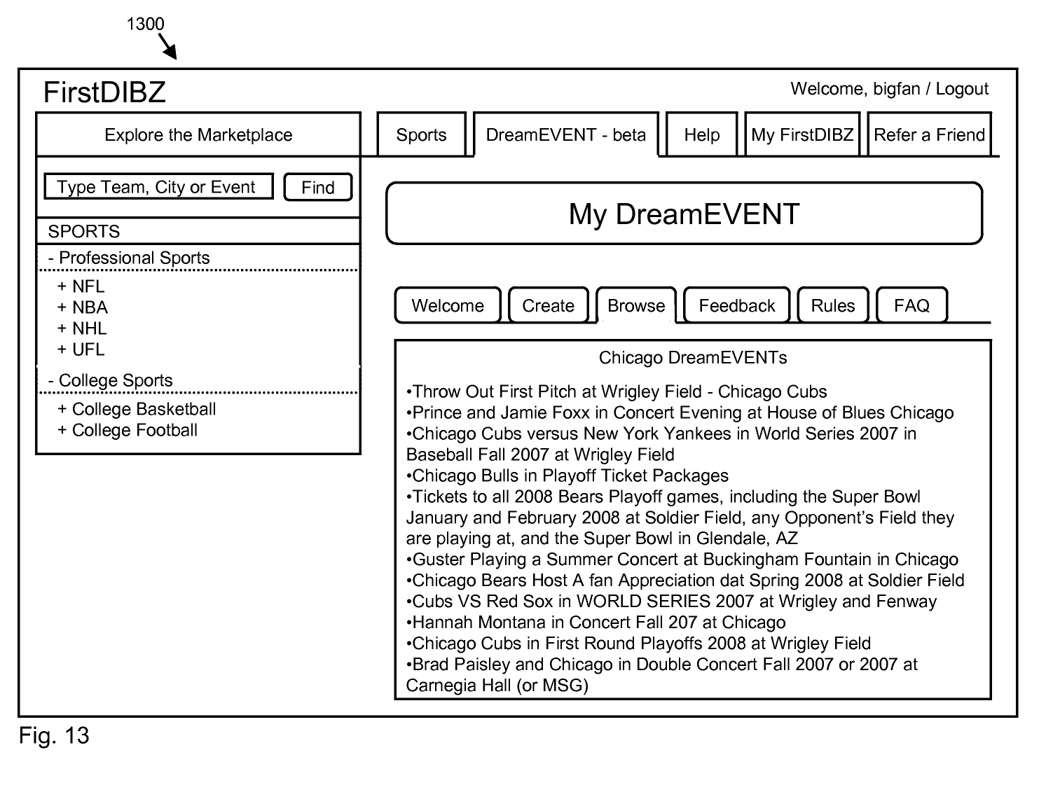

Referring to FIG. 11, a user may use an event proposition web page 1100 to specify the details of their proposed event. In some embodiments, the user may specify a genre, an individual, a group, a team, the kind of event, the location of the event, the time or timeframe of the event, reasoning behind the event proposed, and the like. If no specific date is specified, the proposed event may be assigned an expiration date. Once submitted, the proposed event may be indexed and sorted by any of the specified details. Other users may then browse the proposed events on a browse web page 1200, as in FIG. 12. In some embodiments, the event proposer may publicize the proposed event in order to generate more votes for the event. The event proposition page may include an “E-mail My Friends” button in order for users to disseminate information about the proposed event to other current users as well as non-users. Browsing may be done by alphabetical order of any of the details, by chronological date of the event, by popularity of the proposed events as indicated by views, votes, or the like, or by date proposed, and the like. In some embodiments, browsing may be done using a tag cloud where the cloud is populated with details of the proposed events and the font size and/or color correlates with frequency of the tag. For example, FIG. 12 depicts a tag cloud of “Hottest DreamEVENTs.” In some embodiments, a search box 1202 may be used to generate a set of results from a search string. For example, a user may specify that he wants to see all proposed events to take place in Chicago or for which Chicago is a keyword from the details indicated in the event proposition. Referring to FIG. 13, the results set from the search may be displayed in any format, such as a list of latest proposed events, a list of proposed events sorted by popularity, a list sorted by kind of event, an alphabetical list of any of the details in the proposed events, a tag cloud of the subset of results, and the like.

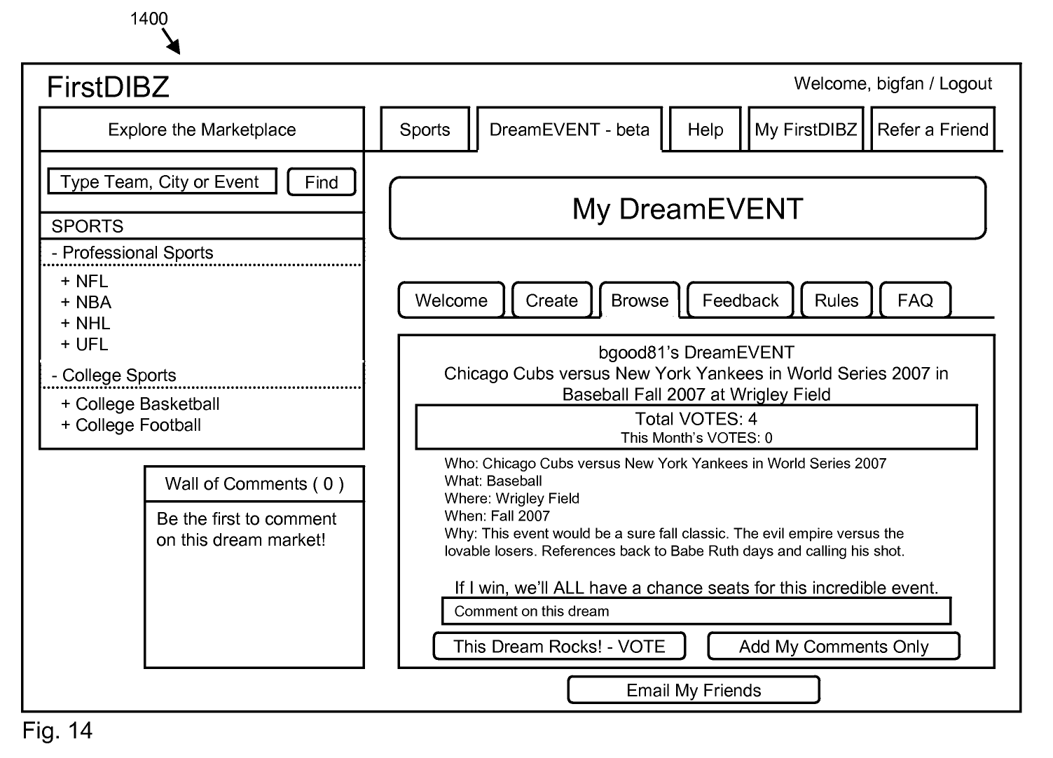

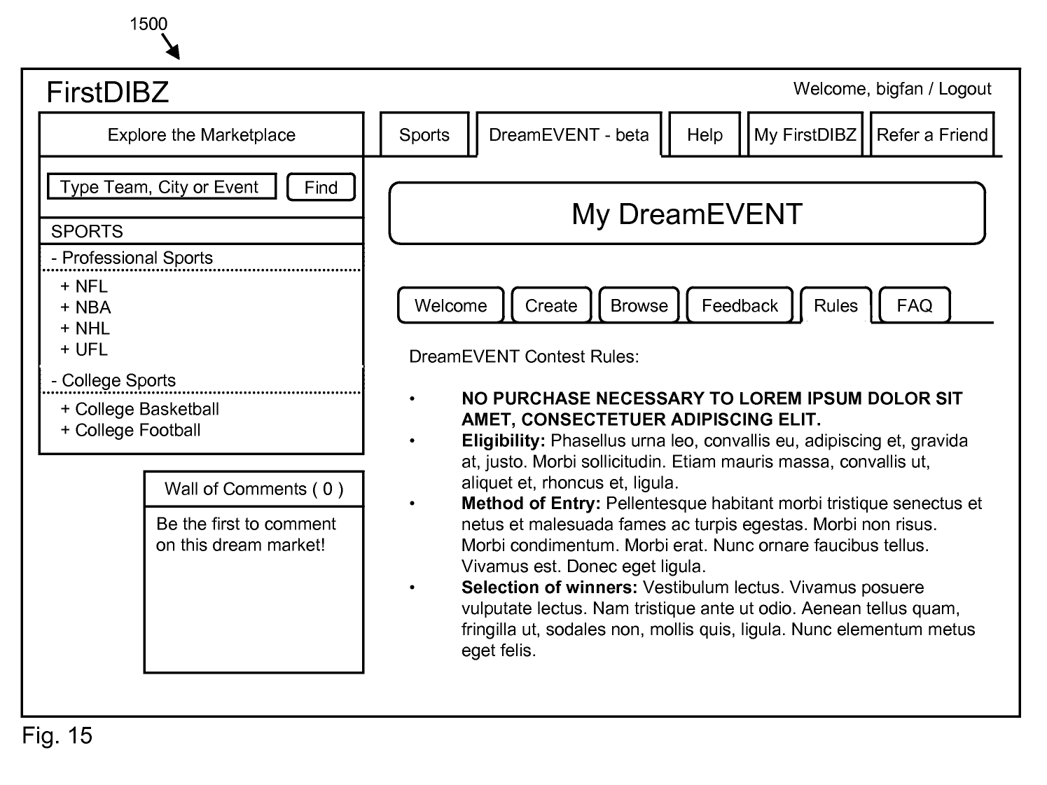

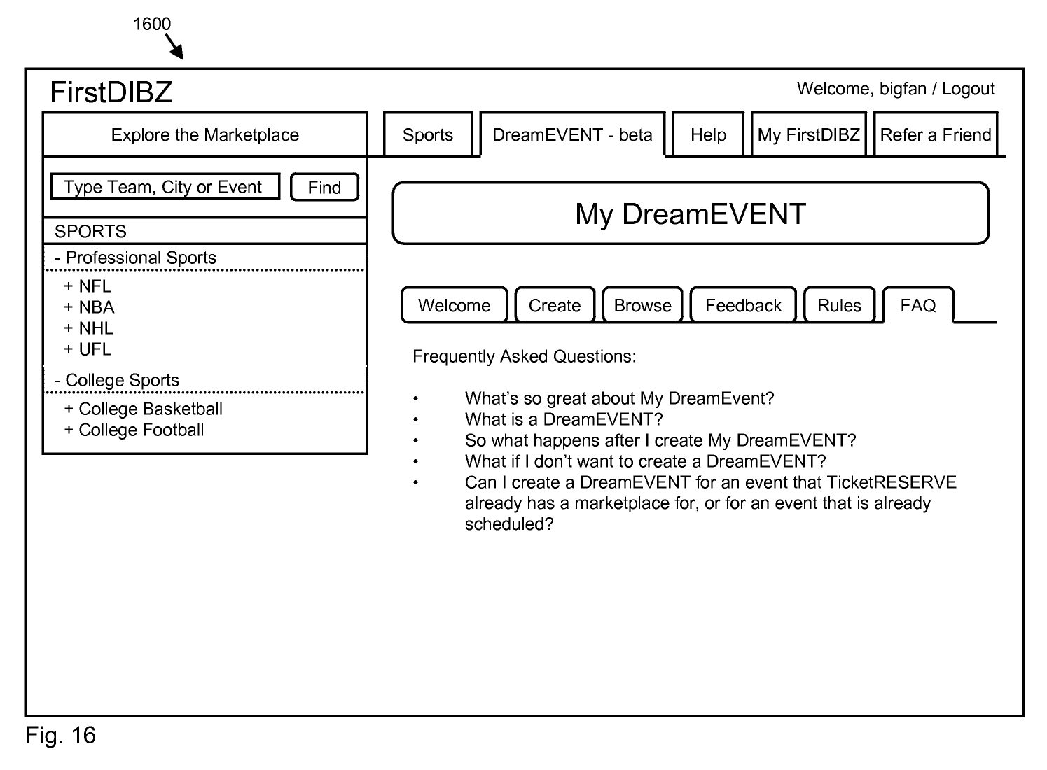

Referring now to FIG. 14, a user may review an individual event on a proposed events web page 1400. The user may identify the individual event by browsing all proposed events, searching for specific events, and so on. The page for the specific event may contain all of the details of the proposed event, the user proposing the event, the total number of votes for the event, the number of votes for the event during a specified time, a comments drafting window, a comments viewing window, a comments submission button, a voting button, an “E-mail My Friends” button, and the like. Referring now to FIG. 15, there may be rules governing eligibility, method of entry, selection of winners, participation, notification and acceptance, limitations of liability, construction, and the like. Rules may be accessible from a tab within the demand aggregation facility 622. Referring to FIG. 16, frequently asked questions may be addressed on a Frequently Asked Questions page of the demand aggregation facility 622.

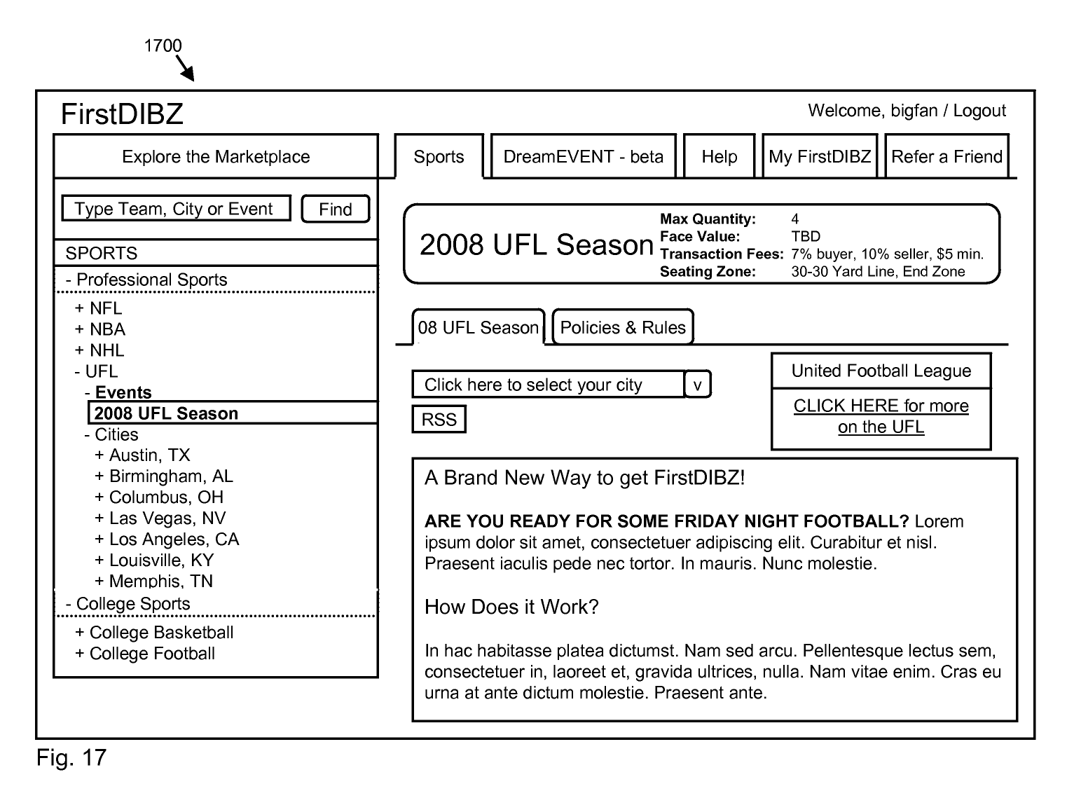

Referring to FIG. 17, an informational screen 1700 of a facility for measuring and tracking demand 622 may track demand for future items where the item is a future sports team and/or future season tickets to the future sports team. For example, a sports franchise selection market may allow users to secure forward rights for season tickets. The season tickets may be for a sports franchise in a city that the user helps choose. By purchasing a forward right for a desired city, the user guarantees himself a face-value season ticket if the city is granted a franchise. In some embodiments, the price paid for the forward right may be applied towards the face value of the season ticket. In some embodiments, the demand for a franchise in a particular city may be determined by the total number of forward rights secured for season tickets for that franchise, the number of forward rights for a particular seating area, a combination thereof, and the like. If a forward right is purchased for a city that does not end up with a franchise, the user may be refunded the price paid for all forward rights. If a forward right is purchased for a city that does end up with a franchise, the user may exercise the right to purchase a season ticket or may sell or trade the forward right on a contingent event rights market 682 or secondary rights market 670. Trading may continue until the market closes for all teams.

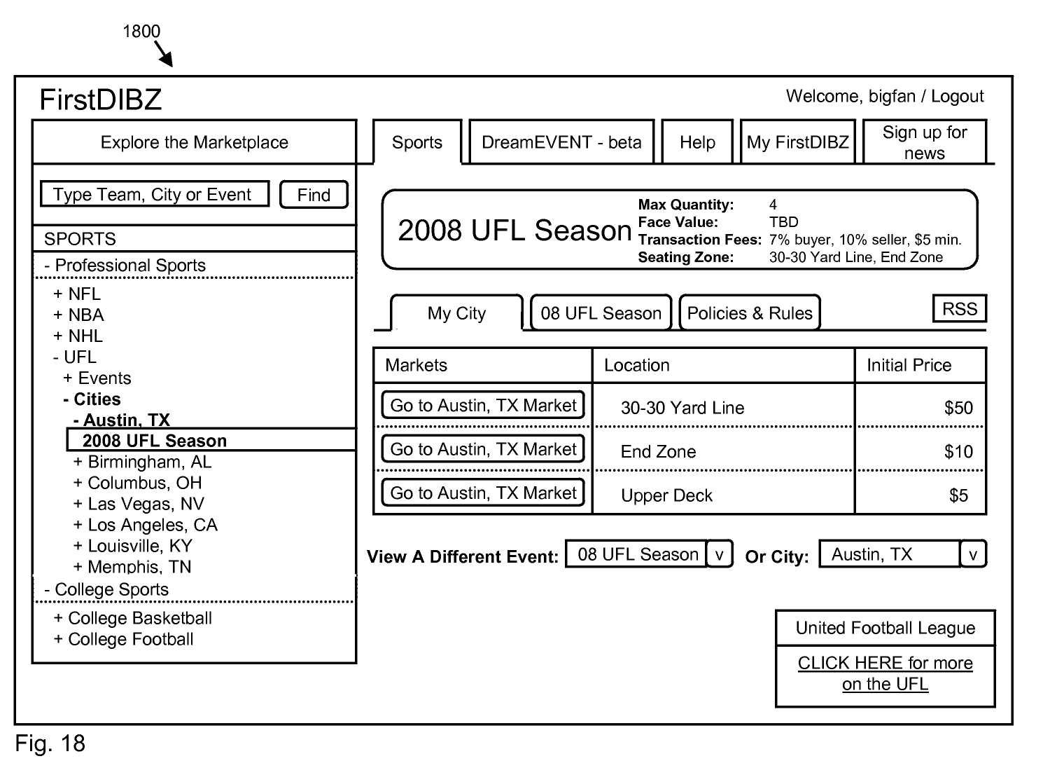

Referring to FIG. 18, a forward rights selection page 1800 may allow a user to purchase or otherwise secure forward rights for season tickets for a proposed franchise. For example, forward rights may be purchased for season tickets along the 30 Yard Line, End Zone, Upper Deck, 50 Yard Line, or the like for a particular franshise. In some embodiments, a user may be able to specify a particular zone of seats for the forward rights. In some embodiments, forward rights may carry forward obligations—if the franchise is granted to a city for which the user holds forward rights, these may be converted to a forward obligation to purchase season tickets for the franchise. Of course, the user may also choose to sell or trade the forward rights on the contingent event certificate exchange 682 or secondary rights market 670. At the close of trading, the user holding the forward right may be automatically charged the full purchase price of a season ticket. In some embodiments, the purchase price may be reduced by the value of the forward right.

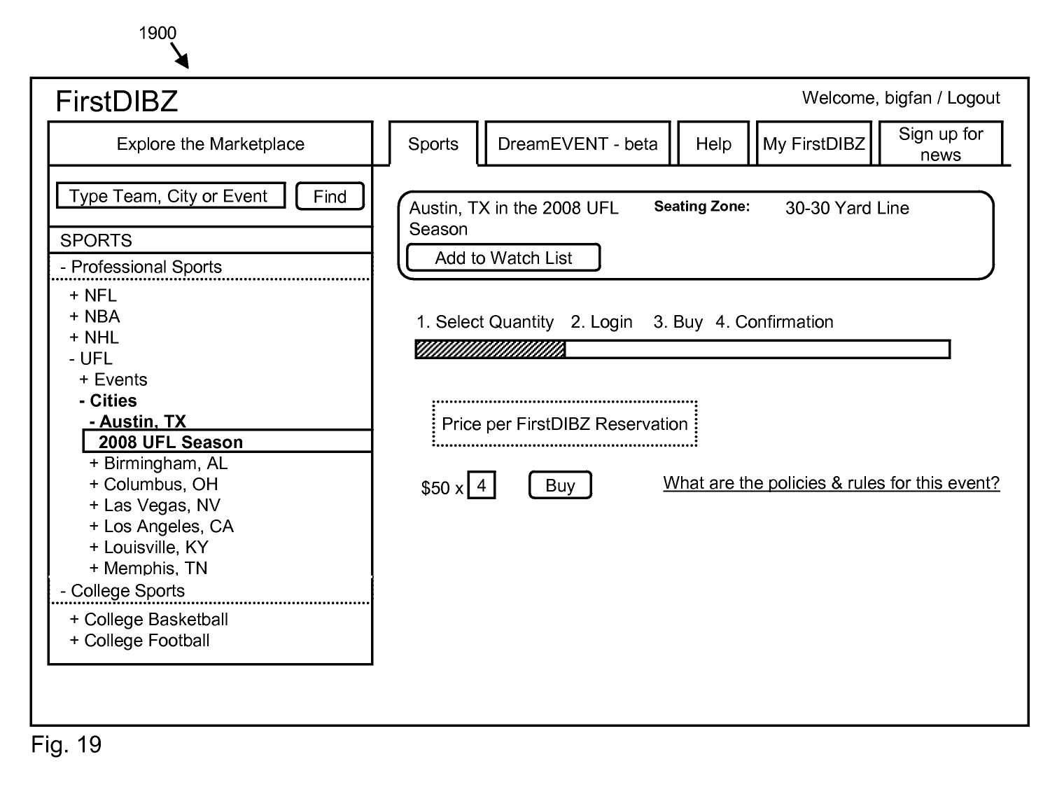

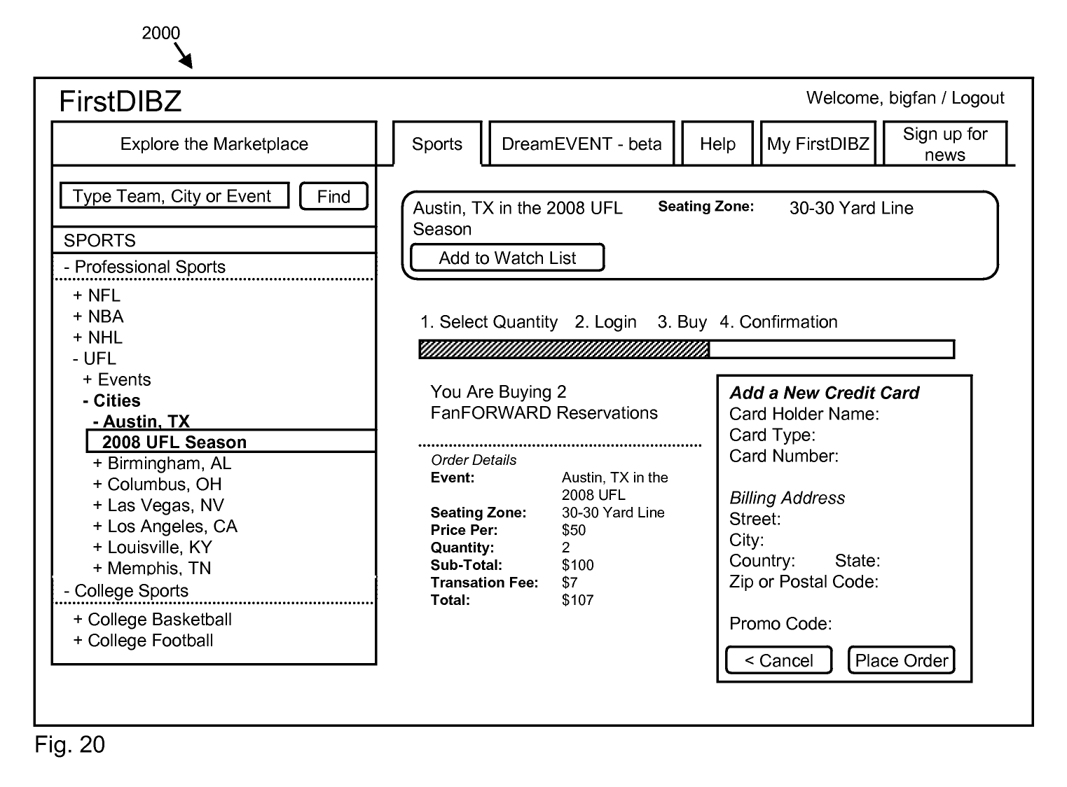

The price of a forward right may be pre-determined or may fluctuate with demand. The user may specify the number of forward rights to purchase at a particular venue location or price point at a purchase screen 1900, as shown in FIG. 19. Referring to FIG. 20, a bid to buy purchase confirmation screen 2000 may depict the details of a forward right transaction. If there is a charge to secure the forward right, the user may be prompted to provide payment information or simply to login if payment information already exists on file.

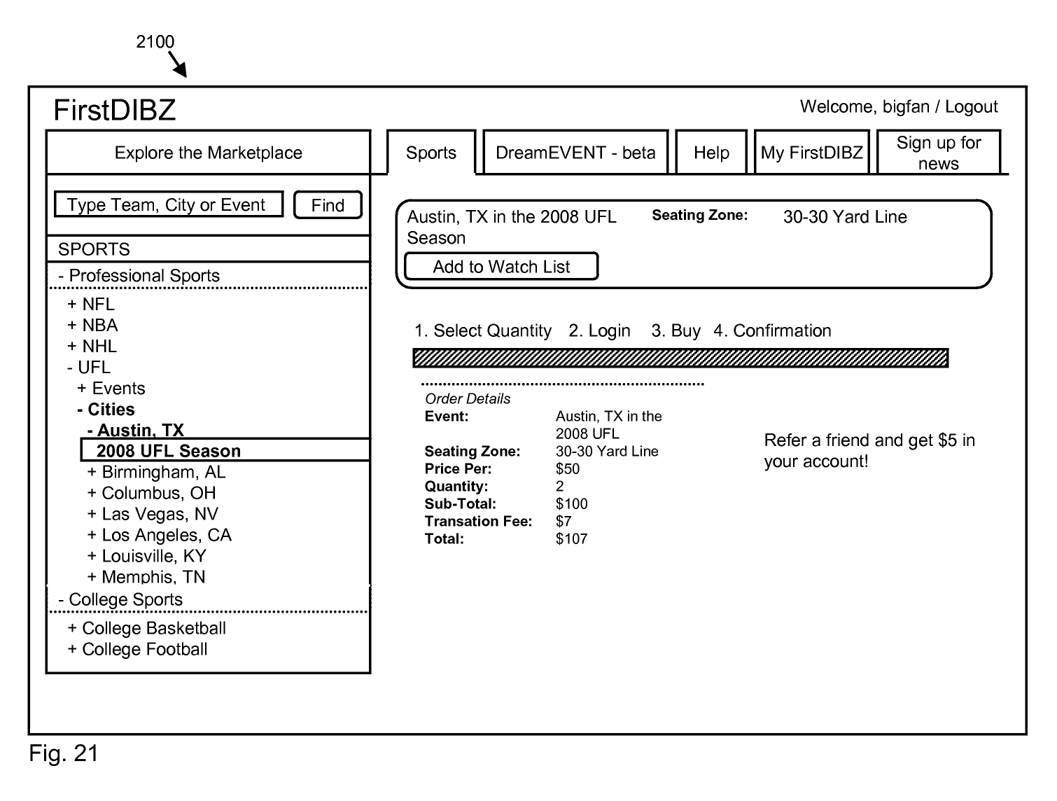

FIG. 21 depicts a bid-to-buy purchase completion screen 2100 of a demand aggregation facility 622. This screen presents information relating to a completed purchase, including any and all information confirming the purchase.

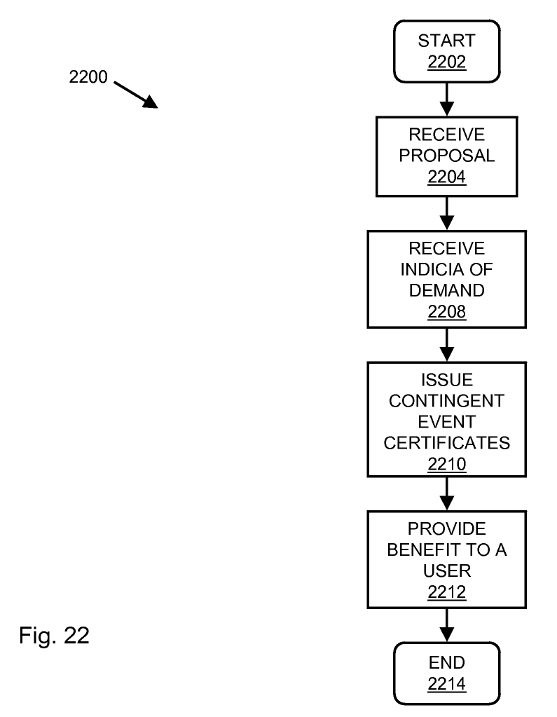

FIG. 22 depicts a flowchart of a method 2200 for issuing contingent event certificates. It will be understood that the method 2200 may be implemented in a computer program product or the like.

Processing may begin at block 2202 and continue to block 2204. Here a proposal for a future item may be received. For example and without limitation, a user may create a proposal via a web browser. The user may first visit a web page containing a form and a send button. The user may fill out the form and press the send button. Pressing the send button may cause the form's contents to be encoded and transmitted to a server. The proposal may be included in the encoded contents of the form. The server may be processing the method 2200 and may receive the proposal accordingly. It will be understood that various methods of receiving the encoded proposal are possible.

Without limitation, the future item may be a consumer product, a consumer service, content, an accommodation, an event, a sporting event, a music event, a theater event, a performance, a music release, a movie release, user generated new content, an opening of a hotel, a presentation by a particular person, a publication, and the like.

The proposal may be transmitted to a plurality of users, who may review the proposal. For example, the proposal may be embodied as a web page that is transmitted to web browsers of the plurality of users. It will be understood that a variety of embodiments of the proposal and its transmission are possible.

Some of the users may express interest in the proposal. For example, interested users may vote in favor of the future item's being produced; may issue buy orders for contingent event certificates, the contingent event certificates for the future item; or the like.

Each expression of interest may be encoded as an indication of interest. In some embodiments, each indication of interest may be an electronic message transmitted from a user's client machine to a server running the method 2200.

The processing of method 2200 may receive a plurality of indicia of demand for the future item, as shown by block 2208. Without limitation, receiving the plurality of indicia may include receiving data from a communications facility, which may be an internetwork, a computer network port, a computer network socket, a UNIX socket, a primary storage device, a secondary storage device, shared memory, a telephone, an e-mail, a marketplace, a text message, an offline social network, an online social network, a user interface, any and all combinations of the foregoing, or the like.

As may be shown by block 2210 of the method, a plurality of contingent event certificates for the future item may be issued. At least some of the contingent event certificates may be issued to the users who expressed interest in the proposal. Issuing the contingent event certificates may include selling the contingent event certificates such as and without limitation according to a Dutch auction, a power ranking, a fixed price, a variable price, a historical price, any and all of the foregoing, and so on. Regardless, the contingent event certificates may obligate a producer to produce the future item; may obligate owners or holders of the certificates to purchase the future item; and so on. It will be understood that a variety of systems and methods for issuing the contingent event certificates are possible.

A benefit may be provided to the user who created the proposal, as shown by block 2212. The benefit may include preferred access to the future item, first access to the future item, advance access to the future item, access to a secondary market for rights to the future item, a right to purchase the future item, a right to purchase the future item at a discount, a share of revenues attributable to the future item, a share of profits attributable to the future item, a right to receive an item related to the future item, and so on.

Finally, the method 2200 may conclude as shown by block 2214.

In some embodiments the methods and systems disclosed herein may be associated with an exchange, such as a contingent event rights exchange or a contingent event certificate exchange, in which contingent event certificates are offered, issued and/or exchanged. The contingent event certificate exchange may allow exchange of contingent event certificates, as well as exchanges of other related items, such as tickets, whether issued by an issuer or a service provider for an issuer, or exchanged in a secondary market, such as between purchasers.

The elements depicted in flow charts and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these, and all such implementations are within the scope of the present disclosure. Thus, while the foregoing drawings and description set forth functional aspects of the disclosed systems, no particular arrangement of software for implementing these functional aspects should be inferred from these descriptions unless explicitly stated or otherwise clear from the context.

Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods or processes described above, and steps thereof, may be realized in hardware, software, or any combination of these suitable for a particular application. The hardware may include a general-purpose computer and/or dedicated computing device. The processes may be realized in one or more microprocessors, microcontrollers, embedded microcontrollers, programmable digital signal processors or other programmable device, along with internal and/or external memory. The processes may also, or instead, be embodied in an application-specific integrated circuit, a programmable gate array, programmable array logic, or any other device or combination of devices that may be configured to process electronic signals. It will further be appreciated that one or more of the processes may be realized as computer executable code created using a structured programming language such as C, an object oriented programming language such as C++, or any other high-level or low-level programming language (including assembly languages, hardware description languages, and database programming languages and technologies) that may be stored, compiled, or interpreted to run on one of the above devices, as well as heterogeneous combinations of processors, processor architectures, or combinations of different hardware and software.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

While specific embodiments have been described in detail in the foregoing detailed description and illustrated in the accompanying drawings, those of ordinary skill in the art will appreciate a variety of modifications and improvements thereon. Accordingly, the spirit and scope of the invention is not to be limited by the particular arrangements disclosed, but is to be given the full breadth of the appended claims and any and all equivalents thereof as understood in the broadest sense allowable by law.

What is claimed is:

1. A method for issuing contingent event certificates, the method comprising:
receiving a proposal for a future item;
receiving a plurality of indicia of demand for the future item, the plurality of indicia in response to the proposal; and
issuing a plurality of contingent event certificates for the future item, wherein
at least some of the plurality of contingent event certificates are issued to users who provided at least some of the plurality of indicia.

2. The method for issuing contingent event certificates of claim 1, wherein the indicia of demand are votes for the future item.

3. The method for issuing contingent event certificates of claim 1, wherein the indicia of demand are buy orders for the contingent event certificates.

4. The method for issuing contingent event certificates of claim 1, wherein at least one of the contingent event certificates, when exercised, obligates a producer to produce the future item.

5. The method for issuing contingent event certificates of claim 1, wherein the future item is an item selected from the group consisting of a consumer product, a consumer service, content, an accommodation, an event, a sporting event, a music event, a theater event, a performance, a music release, a movie release, user-generated new content, an opening of a hotel, a presentation by a particular person, a publication, a toy, a game, a consumer electronics item, a work of art, and a book.

6. The method for issuing contingent event certificates of claim 1, further comprising providing a benefit to a user who created the proposal, the benefit provided when the indicia of demand satisfies a threshold condition.

7. The method for issuing contingent event certificates of claim 6, wherein the benefit is selected from the group consisting of preferred access to the future item, first access to the future item, advance access to the future item, access to a secondary market for rights to the future item, a right to purchase the future item, a right to purchase the future item at a discount, a share of revenues attributable to the future item, a share of profits attributable to the future item, and a right to receive an item related to the future item.

8. The method for issuing contingent event certificates of claim 1, wherein receiving involves receiving data from a communications facility selected from the group consisting of an internetwork, a computer network port, a computer network socket, a UNIX socket, a primary storage device, a secondary storage device, shared memory, a telephone, an e-mail, a marketplace, a text message, an offline social network, an online social network, and a user interface.

9. The method for issuing contingent event certificates of claim 1, wherein issuing the plurality of contingent event certificates involves selling the plurality of contingent event certificates.

10. The method for issuing contingent event certificates of claim 9, wherein selling involves at least one of a marketplace, a Dutch auction, a power ranking, a fixed price, a variable price, and a historical price.

11. A computer program product to be processed by a computer, the computer program product adding a capability to the computer, the capability for issuing contingent event certificates, the computer program product comprising:
code adapted to receive a proposal for a future item;
code adapted to receive a plurality of indicia of demand for the future item; and
code adapted to issue a plurality of contingent event certificates for the future item, wherein
at least some of the plurality of contingent event certificates are issued to users who provided at least some of the plurality of indicia, and wherein
the code is adapted to be processed by a computer.

12. The computer program product of claim 11, wherein the indicia of demand are votes for the future item.

13. The computer program product of claim 11, wherein the indicia of demand are buy orders for the contingent event certificates.

14. The computer program product of claim 11, wherein at least one of the contingent event certificates, when exercised, obligates a producer to produce the future item.

15. The computer program product of claim 11, wherein the future item is an item selected from the group consisting of a consumer product, a consumer service, content, an accommodation, an event, a sporting event, a music event, a theater event, a performance, a music release, a movie release, user-generated new content, an opening of a hotel, a presentation by a particular person, a publication, a toy, a game, a consumer electronics item, a work of art, and a book.

16. The computer program product of claim 11, further comprising code adapted to provide a benefit to a user who created the proposal, the benefit provided when the indicia of demand satisfies a threshold condition.

17. The computer program product of claim 16, wherein the benefit is selected from the group consisting of a contingent event certificate for the future item, preferred access to the future item, first access to the future item, advance access to the future item, access to a secondary market for rights to the future item, a right to purchase the future item, a right to purchase the future item at a discount, a share of revenues attributable to the future item, a share of profits attributable to the future item, and a right to receive an item related to the future item.

18. The computer program product of claim 11, wherein to receive is to receive data from a communications facility selected from the group consisting of an internetwork, a computer network port, a computer network socket, a UNIX socket, a primary storage device, a secondary storage device, shared memory, a telephone, an e-mail, a marketplace, a text message, an offline social network, an online social network, and a user interface.

19. The computer program product of claim 11, wherein to issue the plurality of contingent event certificates is to sell the plurality of contingent event certificates.

20. The computer program product of claim 19, wherein to sell invokes at least one of a marketplace, a Dutch auction, a power ranking, a fixed price, a variable price, and a historical price.
